(19) United States
(12) Patent Application Publication
(10) Pub. No.: US 2016/0009747 A1
(43) Pub. Date: Jan. 14, 2016

(54) PLATINUM METALLACYCLES COMPRISING N, P, OR AS RINGATOMS AND THEIR USE AS CATALYSTS IN 1,2-HYDROSILYLATION REACTIONS OF DIENES

(71) Applicant: PRESIDENT AND FELLOWS OF HARVARD COLLEGE, Cambridge, MA (US)

(72) Inventors: Sarah E. PARKER, Cambridge, MA (US); Tobias RITTER, Cambridge, MA (US)

(73) Assignee: President and Fellows of Harvard College, Cambridge, MA (US)

(21) Appl. No.: 14/772,644

(22) PCT Filed: Mar. 4, 2014
(86) PCT No.: PCT/US2014/020398

§ 371 Date: Sep. 3, 2015

Related U.S. Application Data
(60) Provisional application No. 61/772,218, filed on Mar. 4, 2013.

(51) Int. Cl. C07F 15/00; B01J 31/24

(52) U.S. Cl. CPC C07F 15/0086; B01J 31/2414; B01J 2231/323; B01J 2531/828

(57) ABSTRACT

Described herein are platinum complexes of Formula (I) for hydrosilylation of 1,3-dienes. Methods of using the platinum complexes for selective 1,2-hydrosilylation of 1,3-dienes are also provided.

### RELATED APPLICATIONS

The present application claims priority under 35 U.S.C. §119(e) to U.S. provisional patent application, U.S. Ser. No. 61/772,218, filed Mar. 4, 2013, which is incorporated herein by reference.

### GOVERNMENT SUPPORT

This invention was made with U.S. Government support under grant number FA9550-10-1-0170-DOD35CAP awarded by the Air Force Office of Scientific Research (AFOSR). The U.S. Government has certain rights in the invention.

### FIELD OF THE INVENTION

This invention relates to platinum complexes useful as transition metal catalysts in selective 1,2-hydrosilylation of 1,3-dienes.

### BACKGROUND OF THE INVENTION

Hydrosilylation, also called catalytic hydrosilation, refers to addition of Si—H across a carbon-carbon double bond under the catalysis of a transition metal complex. The catalytic transformation represents an important method for preparing organosilicon compounds used in a wide variety of applications from electrical insulation and circuitry to dental re-construction and aerospace engineering (Troegel et al., Recent advances and actual challenges in late transition metal catalyzed hydrosilylation of olefins from an industrial point of view, Coord. Chem. Rev. 2011, 255, p 1440-1559; Brook, M., Silicon in Organic, Organometallic, and Polymer Chemistry. John Wiley & Sons, Inc. 2000, Ch. 10.).

Hydrosilylation of 1,3-dienes can yield two types of products: a 1,2-addition product and a 1,4-addition product (Scheme 1). Selective 1,2-hydrosilylation of butadiene yields an α-olefin-substituted organosilane which may be used to couple olefin-derived polymers to sol-gel materials. Accordingly, there is a need for developing catalysts for the selective 1,2-hydrosilylation of 1,3-dienes (Brondani et al., Polyfunctional carbosilanes and organosilicon compounds. Synthesis via Grignard reactions. Tetrahedron Lett. 1993, 34, p 2111-2114; Kricheldorf, H. R.; Silicon in Polymer Synthesis, Springer, 1996, Ch 7.).

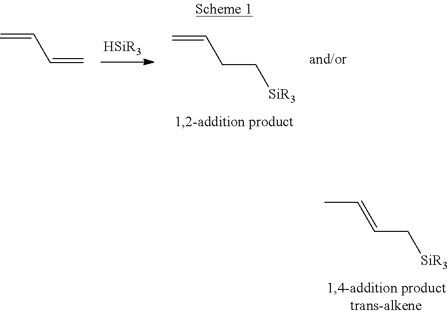

Despite the prevalence of transition metal-catalyzed olefin hydrosilylation methods,¹ no selective method for 1,2-hydrosilylation of 1,3-dienes has been reported.² Conjugated dienes represent a significant selectivity challenge because various coordination and insertion modes are accessible to a conjugated π-system at a transition metal catalyst. The prevalence of 1,4-selective additions may result from the likelihood of transition metals to form π-allyl intermediates upon migratory insertion of dienes into MX bonds (M is the transition metal).^{2,3} Products of 1,2-selective hydrosilylation, specifically 3-butenylsilanes derived from butadiene, would be valuable as superior coupling reagents to link silicate-based materials to olefin polymers in hybrid materials synthesis.^{1c,4} Known catalysts cannot generate 3-butenylsilanes from an inexpensive and readily-available feedstock, such as butadiene.⁵

Butenylsilanes, such as the product of 1,2-hydrosilylation of butadiene, can act as coupling reagents to covalently link the surface of silicate-based sol-gel materials with hydrophobic olefin polymers.⁴ Coupling reagents contain a silicon group with hydrolyzable ligands and an α-olefin from which olefin polymerization can be initiated.^{4b} Although vinyltriethoxysilane and hexenyltriethoxysilane are currently used as coupling reagents, vinyl silanes are less active than α-olefins for initiating olefin polymerization^{4c} and hexenylsilanes are produced from an expensive feedstock.⁶

Selective 1,4-additions to dienes can be achieved with known catalysts by utilizing the thermodynamic favorability of metal-allyl intermediates (products of 1,4- or 2,1-migratory insertion) over their σ-alkyl isomers (products of 1,2-migratory insertion).^{3a-g,l,m} In contrast, 1,2-selective addition to conjugated dienes is rare. General methods for 1,2-addition are limited to two examples of diene hydro- and diboration reactions, and the factors leading to 1,2-selectivity in these cases are not understood.⁷ Few isolated examples of 1,2-hydrosilylation for specific substrates or as part of product mixtures have been reported, but 1,2-selectivity is substrate-dependent and does not extend to butadiene in any reported case.^{1d,8}

### SUMMARY OF THE INVENTION

The present invention provides platinum complexes of Formulae (I)-(III), salts thereof, compositions thereof, and kits thereof to selectively catalyze 1,2-hydrosilylation of 1,3-dienes. The platinum complexes described herein are typically platinum (II)-phosphine complexes having alkyl, halogen, and/or silyl ligands. In certain embodiments, the platinum complexes act as pre-catalysts and further activation provides active platinum complexes. In certain embodiments, the platinum complexes are active catalysts for selective 1,2-hydrosilylation of 1,3-dienes. The present invention also provides methods of using the platinum complexes to selectively catalyze the 1,2-hydrosilylation of 1,3-dienes. The platinum complexes described herein and compositions are particularly useful in preparing α-olefin substituted organosilanes (e.g., (3-alken-1-yl)silanes (e.g., (3-buten-1-yl)silanes)). Alpha-olefin substituted organosilanes are important materials in the synthesis of 1) surface modification agents for silicon-based materials, 2) monomers for poly(organosiloxane) material synthesis, 3) monomers for olefin polymerization, 4) reagents used in cross-coupling reactions with transition metals, and 5) di- and tri-organosilanes (Brook, M., Silicon in Organic, Organometallic, and Polymer Chemistry. John Wiley & Sons, Inc. 2000, Ch. 10.). Alpha-olefin substituted organosilanes are also useful in making aerogels, nanoparticles, and engineered nanocomposite polymers.

In one aspect, the present invention provides a platinum complex of Formula (I):

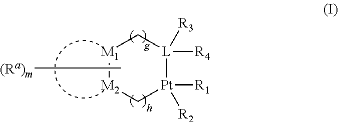

or salts thereof, wherein R₁, R₂, R₃, R₄, L, M₁, M₂, R^{a}, g, h, and m are as defined herein.

In another aspect, the present invention provides a platinum complex of Formula (I-a):

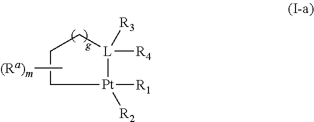

or salts thereof, wherein R₁, R₂, R₃, R₄, L, R^{a}, g, and m are as defined herein.

In another aspect, the present invention provides a platinum complex of Formula (I-b):

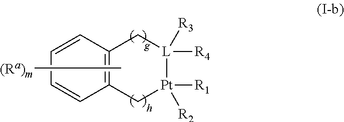

or salts thereof, wherein R₁, R₂, R₃, R₄, L, R^{a}, g, h, and m are as defined herein.

In another aspect, the present invention provides a platinum complex of Formula (I-c):

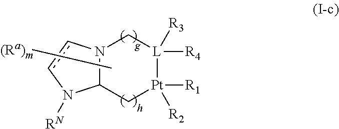

or salts thereof, wherein R₁, R₂, R₃, R₄, L, R^{a}, R^{N}, g, and m are as defined herein.

In another aspect, the present invention provides a platinum complex of Formula (II):

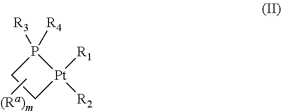

or salts thereof, wherein R₁, R₂, R₃, R₄, R^{a}, and m are as defined herein.

In another aspect, the present invention provides a platinum complex of Formula (III):

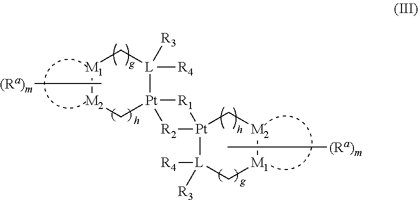

or salt thereof, wherein R₁, R₂, R₃, R₄, L, M₁, M₂, R^{a}, g, h, and m are as defined herein.

In another aspect, the present invention provides a platinum complex of Formula (III-a):

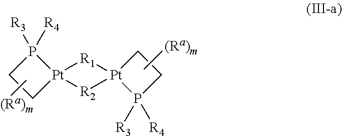

or salt thereof, wherein R₁, R₂, R₃, R₄, R^{a}, and m are as defined herein.

In another aspect, the present invention provides a platinum complex of Formula (IV):

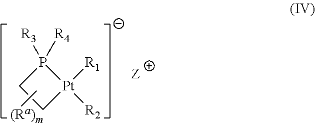

wherein R₁, R₂, R₃, R₄, R^{a}, Z, and m are as defined herein.

In certain embodiments, the salts of platinum complex of Formulae (I)-(III) are active catalysts for 1,2-selective hydrosilylation of 1,3-dienes. In certain embodiments, platinum complexe of Formulae (I)-(III) act as a precatalyst and further activation provides active catalysts for 1,2-selective hydrosilylation of 1,3-dienes. In certain embodiments, activation of precatalyst is carried out in the presence of an activating reagent. Exemplary activating reagents include, but are not limited to Grignard reagent (e.g. MeMgCl, EtMgCl, MeMgBr), alkyl lithium (e.g. methyl lithium, ethyl lithium), alkyl potassium (e.g. benzylpotassium), and alkyl zinc (e.g. diethylzinc). The activated platinum complexes can be isolated or used in situ for the selective hydrosilylation.

In another aspect, the present invention provides compositions comprising a platinum complex of Formula (I), (II), or (III), or a salt thereof, and an organic solvent. In certain embodiments, the platinum complex of Formula (I), (II), or (III) is present in the amount of about 0.01 mol % to about 10 mol % relative to the 1,3-diene.

The platinum complexes described herein can be prepared by treating a solution of (PhCN)₂PtCl₂ with a solution of P(tBu)₃. In certain embodiments, the synthetic method includes a base such as collidine. The base can help to remove any acid generated from the hydrosilylation process, maintaining a neutral reaction media to keep the unreacted phosphine ligand unprotonated. In certain embodiments, the method further comprises activating a platinum complex of Formula (I), (II), or (III). In certain embodiments, the activation of the platinum complex is carried out in the presence of a Grignard reagent, alkyl lithium, alkyl zinc, or alkyl potassium. In certain embodiments, the active platinum complexes are of Formula (IV).

In another aspect, the present invention provides methods of selective 1,2-hyrosilylation of a 1,3-diene. The selective hydrosilylation comprises reacting the platinum complexes described herein or salts thereof with a 1,3-diene at temperatures from about 23° C. to about 100° C., with the catalyst loadings below 0.5 mol %. In certain embodiments, the hydrosilylation reaction is carried out without a solvent. In certain embodiments, the platinum complexes described herein undergo activation before contacting the 1,3-diene. In certain embodiments, the activation is carried out in the presence of a Grignard reagent. In certain embodiments, the activation is carried out in the presence of alkyl lithium (e.g. methyl lithium, ethyl lithium). In certain embodiments, the activation is carried out in the presence of alkyl potassium (e.g. benzylpotassium). In certain embodiments, the activation is carried out in the presence of alkyl zinc (e.g. diethylzinc). In certain embodiments, the activation is carried out in the presence of an organic solvent. In certain embodiments, the activation is carried out in the presence of an organic solvent and the subsequent hydrosilyation is conducted without any solvent. The inventive methods are useful to prepare alpha-olefin substituted organosilanes. Alpha-olefin substituted organosilanes are important materials in the synthesis of 1) surface modification agents for silicon-based materials, 2) monomers for poly(organosiloxane) material synthesis, 3) monomers for olefin polymerization, 4) reagents used in cross-coupling reactions with transition metals, and 5) di- and tri-organosilanes (Brook, M., Silicon in Organic, Organometallic, and Polymer Chemistry. John Wiley & Sons, Inc. 2000, Ch. 10.).

In another aspect, the present invention provides kits comprising one or more platinum complexes of Formulae (I)-(III), salts thereof, or compositions thereof, and a container. The kits may be useful for catalyzing selective 1,2-hydrosilylation of 1,3-dienes. In certain embodiments, the kits described herein further include informational material. The informational material can be descriptive, instructional, marketing or other material that relates to the methods described herein and/or the use of the complex for the methods described herein. In certain embodiments, the informational material includes instructions for preparing, and/or applying, and/or activating the platinum complex of Formulae (I)-(III), salts thereof, or compositions thereof. The components of the kits may be stored under inert conditions such as nitrogen or argon. The components of the kits may be provided in any form, e.g., liquid, dried, or lyophilized form.

The details of certain embodiments of the invention are set forth herein. Other features, objects, and advantages of the invention will be apparent from the Detailed Description, the Figures, the Examples, and the Claims.

### DEFINITIONS

### Chemical Definitions

Definitions of specific functional groups and chemical terms are described in more detail below. The chemical elements are identified in accordance with the Periodic Table of the Elements, CAS version, Handbook of Chemistry and Physics, 75^{th} Ed., inside cover, and specific functional groups are generally defined as described therein. Additionally, general principles of organic chemistry, as well as specific functional moieties and reactivity, are described in Thomas Sorrell, Organic Chemistry, University Science Books, Sausalito, 1999; Smith and March, March's Advanced Organic Chemistry, 5^{th} Edition, John Wiley & Sons, Inc., New York, 2001; Larock, Comprehensive Organic Transformations, VCH Publishers, Inc., New York, 1989; and Carruthers, Some Modern Methods of Organic Synthesis, 3^{rd} Edition, Cambridge University Press, Cambridge, 1987.

Compounds described herein can comprise one or more asymmetric centers, and thus can exist in various isomeric forms, e.g., enantiomers and/or diastereomers. For example, the compounds described herein can be in the form of an individual enantiomer, diastereomer or geometric isomer, or can be in the form of a mixture of stereoisomers, including racemic mixtures and mixtures enriched in one or more stereoisomer. Isomers can be isolated from mixtures by methods known to those skilled in the art, including chiral high pressure liquid chromatography (HPLC) and the formation and crystallization of chiral salts; or preferred isomers can be prepared by asymmetric syntheses. See, for example, Jacques et al., Enantiomers, Racemates and Resolutions (Wiley Interscience, New York, 1981); Wilen et al., Tetrahedron 33:2725 (1977); Eliel, Stereochemistry of Carbon Compounds (McGraw Hill, N Y, 1962); and Wilen, Tables of Resolving Agents and Optical Resolutions p. 268 (E. L. Eliel, Ed., Univ. of Notre Dame Press, Notre Dame, Ind. 1972). The invention additionally encompasses compounds described herein as individual isomers substantially free of other isomers, and alternatively, as mixtures of various isomers.

When a range of values is listed, it is intended to encompass each value and sub range within the range. For example “C₁₋₆” is intended to encompass C₁, C₂, C₃, C₄, C₅, C₆, C₁₋₆, C₁₋₅, C₁₋₄, C₁₋₃, C₁₋₂, C₂₋₆, C₂₋₅, C₂₋₄, C₂₋₃, C₃₋₆, C₃₋₅, C₃₋₄, C₄₋₆, C₄₋₅, and C₅₋₆.

“Alkyl” refers to a radical of a straightchain or branched saturated hydrocarbon group having from 1 to 20 carbon atoms (“C₁₋₂₀ alkyl”). In some embodiments, an alkyl group has 1 to 10 carbon atoms (“C₁₋₁₀ alkyl”). In some embodiments, an alkyl group has 1 to 9 carbon atoms (“C₁₋₉ alkyl”). In some embodiments, an alkyl group has 1 to 8 carbon atoms (“C₁₋₈ alkyl”). In some embodiments, an alkyl group has 1 to 7 carbon atoms (“C₁₋₇ alkyl”). In some embodiments, an alkyl group has 1 to 6 carbon atoms (“C₁₋₆ alkyl”). In some embodiments, an alkyl group has 1 to 5 carbon atoms (“C₁₋₅ alkyl”). In some embodiments, an alkyl group has 1 to 4 carbon atoms (“C₁₋₄ alkyl”). In some embodiments, an alkyl group has 1 to 3 carbon atoms (“C₁₋₃ alkyl”). In some embodiments, an alkyl group has 1 to 2 carbon atoms (“C₁₋₂ alkyl”). In some embodiments, an alkyl group has 1 carbon atom (“C₁ alkyl”). In some embodiments, an alkyl group has 2 to 6 carbon atoms (“C₂ alkyl”). Examples of C₁₋₆ alkyl groups include methyl (C₁), ethyl (C₂), n-propyl (C₃), isopropyl (C₃), n-butyl (C₄), tert-butyl (C₄), sec-butyl (C₄), iso-butyl (C₄), n-pentyl (C₅), 3-pentanyl (C₅), amyl (C₅), neopentyl (C₅), 3-methyl-2-butanyl (C₅), tertiary amyl (C₅), and n-hexyl (C₆). Additional examples of alkyl groups include n-heptyl (C₇), n-octyl (C₈), and the like. Unless otherwise specified, each instance of an alkyl group is independently optionally substituted, i.e., unsubstituted (an “unsubstituted alkyl”) or substituted (a “substituted alkyl”) with one or more substituents. In certain embodiments, the alkyl group is unsubstituted C₁₋₁₀ alkyl (e.g., CH₃). In certain embodiments, the alkyl group is substituted C₁₋₁₀ alkyl.

“Heterocyclyl” or “heterocyclic” refers to a radical of a 3 to 10-membered non-aromatic ring system having ring carbon atoms and 1 to 4 ring heteroatoms, wherein each heteroatom is independently selected from nitrogen, oxygen, sulfur, boron, phosphorus, and silicon (“3-10 membered heterocyclyl”). In certain embodiments, the heteroatom is independently selected from nitrogen, sulfur, and oxygen. In heterocyclyl groups that contain one or more nitrogen atoms, the point of attachment can be a carbon or nitrogen atom, as valency permits. A heterocyclyl group can either be monocyclic (“monocyclic heterocyclyl”) or a fused, bridged or spiro ring system such as a bicyclic system (“bicyclic heterocyclyl”), and can be saturated or partially unsaturated. Heterocyclyl bicyclic ring systems can include one or more heteroatoms in one or both rings. “Heterocyclyl” also includes ring systems wherein the heterocyclic ring, as defined above, is fused with one or more carbocyclyl groups wherein the point of attachment is either on the carbocyclyl or heterocyclic ring, or ring systems wherein the heterocyclic ring, as defined above, is fused with one or more aryl or heteroaryl groups, wherein the point of attachment is on the heterocyclic ring, and in such instances, the number of ring members continue to designate the number of ring members in the heterocyclic ring system. Unless otherwise specified, each instance of heterocyclyl is independently optionally substituted, i.e., unsubstituted (an “unsubstituted heterocyclyl”) or substituted (a “substituted heterocyclyl”) with one or more substituents. In certain embodiments, the heterocyclyl group is unsubstituted 3-10 membered heterocyclyl. In certain embodiments, the heterocyclyl group is substituted 3-10 membered heterocyclyl.

In some embodiments, a heterocyclyl group is a 5-10 membered nonaromatic ring system having ring carbon atoms and 1-4 ring heteroatoms, wherein each heteroatom is independently selected from nitrogen, oxygen, sulfur, boron, phosphorus, and silicon (“5-10 membered heterocyclyl”). In some embodiments, a heterocyclyl group is a 5-8 membered nonaromatic ring system having ring carbon atoms and 1-4 ring heteroatoms, wherein each heteroatom is independently selected from nitrogen, oxygen, and sulfur (“5-8 membered heterocyclyl”). In some embodiments, a heterocyclyl group is a 5-6 membered nonaromatic ring system having ring carbon atoms and 1-4 ring heteroatoms, wherein each heteroatom is independently selected from nitrogen, oxygen, and sulfur (“5-6 membered heterocyclyl”). In some embodiments, the 5-6 membered heterocyclyl has 1-3 ring heteroatoms selected from nitrogen, oxygen, and sulfur. In some embodiments, the 5-6 membered heterocyclyl has 1-2 ring heteroatoms selected from nitrogen, oxygen, and sulfur. In some embodiments, the 5-6 membered heterocyclyl has one ring heteroatom selected from nitrogen, oxygen, and sulfur.

Exemplary 3-membered heterocyclyl groups containing one heteroatom include, without limitation, azirdinyl, oxiranyl, and thiiranyl. Exemplary 4-membered heterocyclyl groups containing one heteroatom include, without limitation, azetidinyl, oxetanyl, and thietanyl. Exemplary 5-membered heterocyclyl groups containing one heteroatom include, without limitation, tetrahydrofuranyl, dihydrofuranyl, tetrahydrothiophenyl, dihydrothiophenyl, pyrrolidinyl, dihydropyrrolyl, and pyrrolyl-2,5-dione. Exemplary 5-heterocyclyl groups containing two heteroatoms include, without limitation, dioxolanyl, oxasulfuranyl, disulfuranyl, and oxazolidin-2-one. Exemplary 5-membered heterocyclyl groups containing three heteroatoms include, without limitation, triazolinyl, oxadiazolinyl, and thiadiazolinyl. Exemplary 6-membered heterocyclyl groups containing one heteroatom include, without limitation, piperidinyl, tetrahydropyranyl, dihydropyridinyl, and thianyl. Exemplary 6-membered heterocyclyl groups containing two heteroatoms include, without limitation, piperazinyl, morpholinyl, dithianyl, and dioxanyl. Exemplary 6 heterocyclyl groups containing three heteroatoms include, without limitation, triazinanyl. Exemplary 7-membered heterocyclyl groups containing one heteroatom include, without limitation, azepanyl, oxepanyl, and thiepanyl. Exemplary 8-membered heterocyclyl groups containing one heteroatom include, without limitation, azocanyl, oxecanyl, and thiocanyl. Exemplary 5-membered heterocyclyl groups fused to a C₆ aryl ring (also referred to herein as a 5,6-bicyclic heterocyclic ring) include, without limitation, indolinyl, isoindolinyl, dihydrobenzofuranyl, dihydrobenzothienyl, benzoxazolinonyl, and the like. Exemplary 6-membered heterocyclyl groups fused to an aryl ring (also referred to herein as a 6,6-bicyclic heterocyclic ring) include, without limitation, tetrahydroquinolinyl, tetrahydroisoquinolinyl, and the like.

“Aryl” refers to a radical of a monocyclic or polycyclic (e.g., bicyclic or tricyclic) 4n+2 aromatic ring system (e.g., having 6, 10, or 14 it electrons shared in a cyclic array) having 6-14 ring carbon atoms and zero heteroatoms in the aromatic ring system (“C₆₋₁₄ aryl”). In some embodiments, an aryl group has six ring carbon atoms (“C₆ aryl”; e.g., phenyl). In some embodiments, an aryl group has ten ring carbon atoms (“C₁₀ aryl”; e.g., naphthyl such as 1-naphthyl and 2-naphthyl). In some embodiments, an aryl group has fourteen ring carbon atoms (“C₁₄ aryl”; e.g., anthracyl). “Aryl” also includes ring systems wherein the aryl ring, as defined above, is fused with one or more carbocyclyl or heterocyclyl groups wherein the radical or point of attachment is on the aryl ring, and in such instances, the number of carbon atoms continue to designate the number of carbon atoms in the aryl ring system. Unless otherwise specified, each instance of an aryl group is independently optionally substituted, i.e., unsubstituted (an “unsubstituted aryl”) or substituted (a “substituted aryl”) with one or more substituents. In certain embodiments, the aryl group is unsubstituted C₆₋₁₄ aryl. In certain embodiments, the aryl group is substituted C₆₋₁₄ aryl.

“Heteroaryl” refers to a radical of a 5-10 membered monocyclic or bicyclic 4n+2 aromatic ring system (e.g., having 6 or 10 π electrons shared in a cyclic array) having ring carbon atoms and 1-4 ring heteroatoms provided in the aromatic ring system, wherein each heteroatom is independently selected from nitrogen, oxygen, and sulfur (“5-10 membered heteroaryl”). In heteroaryl groups that contain one or more nitrogen atoms, the point of attachment can be a carbon or nitrogen atom, as valency permits. Heteroaryl bicyclic ring systems can include one or more heteroatoms in one or both rings. “Heteroaryl” includes ring systems wherein the heteroaryl ring, as defined above, is fused with one or more carbocyclyl or heterocyclyl groups wherein the point of attachment is on the heteroaryl ring, and in such instances, the number of ring members continue to designate the number of ring members in the heteroaryl ring system. “Heteroaryl” also includes ring systems wherein the heteroaryl ring, as defined above, is fused with one or more aryl groups wherein the point of attachment is either on the aryl or heteroaryl ring, and in such instances, the number of ring members designates the number of ring members in the fused (aryl/heteroaryl) ring system. Bicyclic heteroaryl groups wherein one ring does not contain a heteroatom (e.g., indolyl, quinolinyl, carbazolyl, and the like) the point of attachment can be on either ring, i.e., either the ring bearing a heteroatom (e.g., 2-indolyl) or the ring that does not contain a heteroatom (e.g., 5 indolyl).

In some embodiments, a heteroaryl group is a 5-10 membered aromatic ring system having ring carbon atoms and 1-4 ring heteroatoms provided in the aromatic ring system, wherein each heteroatom is independently selected from nitrogen, oxygen, and sulfur (“5-10 membered heteroaryl”). In some embodiments, a heteroaryl group is a 5-8 membered aromatic ring system having ring carbon atoms and 1-4 ring heteroatoms provided in the aromatic ring system, wherein each heteroatom is independently selected from nitrogen, oxygen, and sulfur (“5-8 membered heteroaryl”). In some embodiments, a heteroaryl group is a 5-6 membered aromatic ring system having ring carbon atoms and 1-4 ring heteroatoms provided in the aromatic ring system, wherein each heteroatom is independently selected from nitrogen, oxygen, and sulfur (“5-6 membered heteroaryl”). In some embodiments, the 5-6 membered heteroaryl has 1-3 ring heteroatoms selected from nitrogen, oxygen, and sulfur. In some embodiments, the 5-6 membered heteroaryl has 1-2 ring heteroatoms selected from nitrogen, oxygen, and sulfur. In some embodiments, the 5-6 membered heteroaryl has 1 ring heteroatom selected from nitrogen, oxygen, and sulfur. Unless otherwise specified, each instance of a heteroaryl group is independently optionally substituted, i.e., unsubstituted (an “unsubstituted heteroaryl”) or substituted (a “substituted heteroaryl”) with one or more substituents. In certain embodiments, the heteroaryl group is unsubstituted 5-14 membered heteroaryl. In certain embodiments, the heteroaryl group is substituted 5-14 membered heteroaryl.

Exemplary 5-membered heteroaryl groups containing one heteroatom include, without limitation, pyrrolyl, furanyl and thiophenyl. Exemplary 5-membered heteroaryl groups containing two heteroatoms include, without limitation, imidazolyl, pyrazolyl, oxazolyl, isoxazolyl, thiazolyl, and isothiazolyl. Exemplary 5-membered heteroaryl groups containing three heteroatoms include, without limitation, triazolyl, oxadiazolyl, and thiadiazolyl. Exemplary 5-membered heteroaryl groups containing four heteroatoms include, without limitation, tetrazolyl. Exemplary 6-membered heteroaryl groups containing one heteroatom include, without limitation, pyridinyl. Exemplary 6-membered heteroaryl groups containing two heteroatoms include, without limitation, pyridazinyl, pyrimidinyl, and pyrazinyl. Exemplary 6-membered heteroaryl groups containing three or four heteroatoms include, without limitation, triazinyl and tetrazinyl, respectively. Exemplary 7-membered heteroaryl groups containing one heteroatom include, without limitation, azepinyl, oxepinyl, and thiepinyl. Exemplary 5,6-bicyclic heteroaryl groups include, without limitation, indolyl, isoindolyl, indazolyl, benzotriazolyl, benzothiophenyl, isobenzothiophenyl, benzofuranyl, benzoisofuranyl, benzimidazolyl, benzoxazolyl, benzisoxazolyl, benzoxadiazolyl, benzthiazolyl, benzisothiazolyl, benzthiadiazolyl, indolizinyl, and purinyl. Exemplary 6,6 heteroaryl groups include, without limitation, naphthyridinyl, pteridinyl, quinolinyl, isoquinolinyl, cinnolinyl, quinoxalinyl, phthalazinyl, and quinazolinyl.

“Partially unsaturated” refers to a group that includes at least one double or triple bond. A “partially unsaturated” ring system is further intended to encompass rings having multiple sites of unsaturation, but is not intended to include aromatic groups (e.g., aryl or heteroaryl groups) as herein defined. Likewise, “saturated” refers to a group that does not contain a double or triple bond, i.e., contains all single bonds.

Alkyl, alkenyl, alkynyl, carbocyclyl, heterocyclyl, aryl, and heteroaryl groups, as defined herein, which are divalent bridging groups are further referred to using the suffix ene, e.g., alkylene, alkenylene, alkynylene, carbocyclylene, heterocyclylene, arylene, and heteroarylene.

As used herein, the term “optionally substituted” refers to a substituted or unsubstituted moiety.

Alkyl, alkenyl, alkynyl, carbocyclyl, heterocyclyl, aryl, and heteroaryl groups, as defined herein, are optionally substituted (e.g., “substituted” or “unsubstituted” alkyl, “substituted” or “unsubstituted” alkenyl, “substituted” or “unsubstituted” alkynyl, “substituted” or “unsubstituted” carbocyclyl, “substituted” or “unsubstituted” heterocyclyl, “substituted” or “unsubstituted” aryl or “substituted” or “unsubstituted” heteroaryl group). In general, the term “substituted”, whether preceded by the term “optionally” or not, means that at least one hydrogen present on a group (e.g., a carbon or nitrogen atom) is replaced with a permissible substituent, e.g., a substituent which upon substitution results in a stable compound, e.g., a compound which does not spontaneously undergo transformation such as by rearrangement, cyclization, elimination, or other reaction. Unless otherwise indicated, a “substituted” group has a substituent at one or more substitutable positions of the group, and when more than one position in any given structure is substituted, the substituent is either the same or different at each position. The term “substituted” is contemplated to include substitution with all permissible substituents of organic compounds, any of the substituents described herein that results in the formation of a stable compound. The present invention contemplates any and all such combinations in order to arrive at a stable compound. For purposes of this invention, heteroatoms such as nitrogen may have hydrogen substituents and/or any suitable substituent as described herein which satisfy the valencies of the heteroatoms and results in the formation of a stable moiety.

Exemplary carbon atom substituents include, but are not limited to, halogen, —CN, —NO₂, —N₃, —SO₂H, —SO₃H, —OH, —OR^{aa}, —ON(R^{bb})₂, —N(R^{bb})₂, —N(R^{bb})₃⁺X⁻, —N(OR^{cc})R^{bb}, —SH, —SR^{aa}, —SSR^{cc}, —C(═O)R^{aa}, —CO₂H, —CHO, —C(OR″)₂, —CO₂R^{aa}, —OC(═O)R^{aa}, —OCO₂R^{aa}, —C(═O)N(R^{bb})₂, —OC(═O)N(R^{bb})₂, —NR^{bb}C(═O)R^{aa}, —NR^{bb}CO₂R^{aa}, —NR^{bb}C(═O)N(R^{bb})₂, —C(═NR^{bb})R^{aa}, —C(═NR^{bb})OR^{aa}, —OC(═NR^{bb})R^{aa}, —OC(═NR^{bb})OR^{aa}, —C(═NR^{bb})N(R^{bb})₂, —OC(═NR^{bb})N(R^{bb})₂, —NR^{bb}C(═NR^{bb})N(R^{bb})₂, —C(═O)NR^{bb}SO₂R^{aa}, —NR^{bb}SO₂R^{aa}, —SO₂N(R^{bb})₂, —SO₂R^{aa}, —SO₂OR^{aa}, —OSO₂R^{aa}, —S(═O)R^{aa}, —OS(═O)R^{aa}, —Si(R^{aa})₃, —OSi(R^{aa})₃ —C(═S)N(R^{bb})₂, —C(═O)SR^{aa}, —C(═S)SR^{aa}, —SC(═S)SR^{aa}, —SC(═O)SR^{aa}, —OC(═O)SR^{aa}, —SC(═O)OR^{aa}, —SC(═O)R^{aa}, —P(═O)₂R^{aa}, —OP(═O)₂R^{aa}, —P(═O)(R^{aa})₂, —OP(═O)(R^{aa})₂, —OP(═O)(OR″)₂, —P(═O)₂N(R^{bb})₂, —OP(═O)₂N(R^{bb})₂, —P(═O)(NR^{bb})₂, —OP(═O)(NR^{bb})₂, —NR^{bb}P(═O)(OR″)₂, —NR^{bb}P(═O)(NR^{bb})₂, —P(R^{cc})₂, —P(R^{cc})₃, —OP(R^{cc})₂, —OP(R^{cc})₃, —B(R^{aa})₂, —B(OR^{cc})₂, —BR^{aa}(OR^{cc}), C₁₋₁₀ alkyl, C₁₋₁₀ perhaloalkyl, C₂₋₁₀ alkenyl, C₂₋₁₀ alkynyl, C₃₋₁₀ carbocyclyl, 3-14 membered heterocyclyl, C₆₋₁₄ aryl, and 5-14 membered heteroaryl, wherein each alkyl, alkenyl, alkynyl, carbocyclyl, heterocyclyl, aryl, and heteroaryl is independently substituted with 0, 1, 2, 3, 4, or 5 R^{dd} groups;

or two geminal hydrogens on a carbon atom are replaced with the group ═O, ═S, ═NN(R^{bb})₂, ═NNR^{bb}C(═O)R^{aa}, ═NNR^{bb}C(═O) OR^{aa}, ═NNR^{bb}S(═O)₂R^{aa}, ═NR^{bb}, or ═NOR^{cc};

each instance of R^{aa} is, independently, selected from C₁₋₁₀ alkyl, C₁₋₁₀ perhaloalkyl, C₂₋₁₀ alkenyl, C₂₋₁₀ alkynyl, C₃₋₁₀ carbocyclyl, 3-14 membered heterocyclyl, C₆₋₁₄ aryl, and 5-14 membered heteroaryl, or two R^{aa} groups are joined to form a 3-14 membered heterocyclyl or 5-14 membered heteroaryl ring, wherein each alkyl, alkenyl, alkynyl, carbocyclyl, heterocyclyl, aryl, and heteroaryl is independently substituted with 0, 1, 2, 3, 4, or 5 R^{dd} groups;

each instance of R^{bb} is, independently, selected from hydrogen, —OH, —OR^{aa}, —N(R^{cc})₂, —CN, —C(═O)R^{aa}, —C(═O)N(R^{cc})₂, —CO₂R^{aa}, —SO₂R^{aa}, —C(═NR^{cc})OR^{aa}, —C(NR^{cc})N(R^{cc})₂, —SO₂N(R^{cc})₂, —SO₂R^{cc}, —SO₂OR^{cc}, —SOR^{aa}, —C(═S)N(R^{cc})₂, —C(═O)SR^{cc}, —C(═S)SR^{cc}, —P(O)₂R^{aa}, P(═O)(R^{aa})₂, —P(═O)₂N(R^{cc})₂, —P(═O)(NR^{cc})₂, C₁₋₁₀ alkyl, C₁₋₁₀ perhaloalkyl, C₂₋₁₀ alkenyl, C₂₋₁₀ alkynyl, C₃₋₁₀ carbocyclyl, 3-14 membered heterocyclyl, C₆₋₁₄ aryl, and 5-14 membered heteroaryl, or two R^{bb} groups are joined to form a 3-14 membered heterocyclyl or 5-14 membered heteroaryl ring, wherein each alkyl, alkenyl, alkynyl, carbocyclyl, heterocyclyl, aryl, and heteroaryl is independently substituted with 0, 1, 2, 3, 4, or 5 R^{dd} groups;

each instance of R^{cc} is, independently, selected from hydrogen, C₁₋₁₀ alkyl, C₁₋₁₀ perhaloalkyl, C₂₋₁₀ alkenyl, C₂₋₁₀ alkynyl, C₃₋₁₀ carbocyclyl, 3-14 membered heterocyclyl, C₆₋₁₄ aryl, and 5-14 membered heteroaryl, or two R^{cc} groups are joined to form a 3-14 membered heterocyclyl or 5-14 membered heteroaryl ring, wherein each alkyl, alkenyl, alkynyl, carbocyclyl, heterocyclyl, aryl, and heteroaryl is independently substituted with 0, 1, 2, 3, 4, or 5 R^{dd} groups;

each instance of R^{dd} is, independently, selected from halogen, —CN, —NO₂, —N₃, —SO₂H, —SO₃H, —OH, —OR′, —ON(R^{ff})₂, —N(R^{ff})₂, —N(R^{ff})₃⁺X⁻, —N(OR^{ee})R^{ff}, —SH, —SR^{ee}, —SSR^{ee}, —C(═O)R^{ee}, —CO₂H, —CO₂R^{ee}, —OC(═O)R^{ee}, —OCO₂R^{ee}, —C(═O)N(R^{ff})₂, —OC(═O)N(R^{ff})₂, —NR^{ff}C(═O)R^{ee}, —NR^{ff}CO₂R^{ee}, —NR^{ff}C(═O)N(R^{ff})₂, —C(═NR^{ff})OR^{ee}, —OC(═NR^{ff})R^{ee}, —OC(═NR^{ff})OR^{ee}, —C(═NR^{ff})N(R^{ff})₂, —OC(═NR^{ff})N(R^{ff})₂, —NR^{ff}C(═NR^{ff})N(R^{ff})₂, —NR^{ff}SO₂R^{ee}, —SO₂N(R^{ff})₂, —SO₂R^{ee}, —SO₂OR^{ee}, —OSO₂R^{ee}, —S(═O)R^{ee}, —Si(R^{ee})₃, —OSi(R^{ee})₃, —C(═S)N(R^{ff})₂, —C(═O)SR^{ee}, —C(═S)SR″, —SC(═S)SR″, —P(═O)₂R^{ee}, —P(═O)(R^{ee})₂, —OP(═O)(R^{ee})₂, —OP(═O)(OR^{ee})₂, C₁₋₆ alkyl, C₁₋₆ perhaloalkyl, C₂₋₆ alkenyl, C₂₋₆ alkynyl, C₃₋₁₀ carbocyclyl, 3-10 membered heterocyclyl, C₆₋₁₀ aryl, 5-10 membered heteroaryl, wherein each alkyl, alkenyl, alkynyl, carbocyclyl, heterocyclyl, aryl, and heteroaryl is independently substituted with 0, 1, 2, 3, 4, or 5 R^{gg} groups, or two geminal R^{dd} substituents can be joined to form ═O or ═S;

each instance of R^{ee} is, independently, selected from C₁₋₆ alkyl, C₁₋₆ perhaloalkyl, C₂₋₆ alkenyl, C₂₋₆ alkynyl, C₃₋₁₀ carbocyclyl, C₆₋₁₀ aryl, 3-10 membered heterocyclyl, and 3-10 membered heteroaryl, wherein each alkyl, alkenyl, alkynyl, carbocyclyl, heterocyclyl, aryl, and heteroaryl is independently substituted with 0, 1, 2, 3, 4, or 5 R^{gg} groups;

each instance of R^{ff} is, independently, selected from hydrogen, C₁₋₆ alkyl, C₁₋₆ perhaloalkyl, C₂₋₆ alkenyl, C₂₋₆ alkynyl, C₃₋₁₀ carbocyclyl, 3-10 membered heterocyclyl, C₆₋₁₀ aryl and 5-10 membered heteroaryl, or two R^{ff} groups are joined to form a 3-14 membered heterocyclyl or 5-14 membered heteroaryl ring, wherein each alkyl, alkenyl, alkynyl, carbocyclyl, heterocyclyl, aryl, and heteroaryl is independently substituted with 0, 1, 2, 3, 4, or 5 R^{gg} groups; and

each instance of R^{gg} is, independently, halogen, —CN, —NO₂, —N₃, —SO₂H, —SO₃H, —OH, —OC₁₋₆ alkyl, —ON(C₁₋₆ alkyl)₂, —N(C₁₋₆ alkyl)₂, —N(C₁₋₆ alkyl)₃⁺X⁻, —NH(C₁₋₆ alkyl)₂⁺X⁻, —NH₂(C₁₋₆ alkyl)⁺X⁻, —NH₃⁺X⁻, —N(OC₁₋₆ alkyl)(C₁₋₆ alkyl), —N(OH)(C₁₋₆ alkyl), —NH(OH), —SH, —SC₁₋₆ alkyl, —SS(C₁₋₆ alkyl), —C(═O)(C₁₋₆ alkyl), —CO₂H, —CO₂(C₁₋₆ alkyl), —OC(═O)(C₁₋₆ alkyl), —OCO₂(C₁₋₆ alkyl), —C(═O)NH₂, —C(═O)N(C₁₋₆ alkyl)₂, —OC(═O)NH(C₁₋₆ alkyl), —NHC(═O)(C₁₋₆ alkyl), —N(C₁₋₆ alkyl)C(═O)(C₁₋₆ alkyl), —NHCO₂(C₁₋₆ alkyl), —NHC(═O)N(C₁₋₆ alkyl)₂, —NHC(═O)NH(C₁₋₆ alkyl), —NHC(═O)NH₂, —C(═NH)O(C₁₋₆ alkyl), —OC(═NH)(C₁₋₆ alkyl), —OC(═NH)OC₁₋₆ alkyl, —C(═NH)N(C₁₋₆ alkyl)₂, —C(═NH)NH(C₁₋₆ alkyl), —C(═NH)NH₂, —OC(═NH)N(C₁₋₆ alkyl)₂, —OC(NH)NH(C₁₋₆ alkyl), —OC(NH)NH₂, —NHC(NH)N(C₁₋₆ alkyl)₂, —NHC(═NH)NH₂, —NHSO₂(C₁₋₆ alkyl), —SO₂N(C₁₋₆ alkyl)₂, —SO₂NH(C₁₋₆ alkyl), —SO₂NH₂, —SO₂C₁₋₆ alkyl, —SO₂OC₁₋₆ alkyl, —OSO₂C₁₋₆ alkyl, —SOC₁₋₆ alkyl, —Si(C₁₋₆ alkyl)₃, —OSi(C₁₋₆ alkyl)₃ —C(═S)N(C₁₋₆ alkyl)₂, C(═S)NH(C₁₋₆ alkyl), C(═S)NH₂, —C(═O)S(C₁₋₆ alkyl), —C(═S)SC₁₋₆ alkyl, —SC(═S)SC₁₋₆ alkyl, —P(═O)₂(C₁₋₆ alkyl), —P(═O)(C₁₋₆ alkyl)₂, —OP(═O)(C₁₋₆ alkyl)₂, —OP(═O)(OC₁₋₆ alkyl)₂, C₁₋₆ alkyl, C₁₋₆ perhaloalkyl, C₂₋₆ alkenyl, C₂₋₆ alkynyl, C₃₋₁₀ carbocyclyl, C₆₋₁₀ aryl, 3-10 membered heterocyclyl, 5-10 membered heteroaryl; or two geminal R^{gg} substituents can be joined to form ═O or ═S; wherein X⁻ is a counterion.

“Halo” or “halogen” refers to fluorine (fluoro, —F), chlorine (chloro, —Cl), bromine (bromo, —Br), or iodine (iodo, —I). As used herein, halogen can be either a terminal halogen or a bridging halogen. A terminal halogen occurs when a halogen atom acts as one ligand for one platinum center. A bridging halogen arises when one halogen atom acts as a ligand for two metal (e.g., platinum) centers. An exemplary bridging halogen in the platinum complexes of the invention is shown in the following formula:

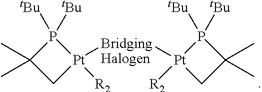

As used herein, a “counterion” is a positively charged moiety optionally associated with other ligands as valence permits to maintain electronic neutrality. The counterion can be an organic cation or an inorganic cation. In one embodiment, the counterion is an inorganic cation. Non-limiting examples of inorganic cations include alkali metal cations, alkaline earth metal cations, transition metal cations, and inorganic ammonium cations (NH₄⁺). In another embodiment, the counterion is an organic cation, for example, an organic ammonium cation, an organic phosphonium cation, an organic sulfonium cation, or a mixture thereof. In certain embodiments, the counterion is associated with at least one ligands. The ligands can be negatively charged or neutral. In certain embodiments, the counterion is an alkaline earth metal cation with one halogen such as MgCl⁺, MgBr⁺, or MgI⁺. In certain embodiments, the counterion is a transition metal cation. In certain embodiments, the counterion is NH₄⁺.

“Acyl” as used herein refers to a moiety selected from the group consisting of —C(═O)R^{aa}, —CHO, —CO₂R^{aa}, —C(═O)N(R^{bb})₂, —C(NR^{bb})R^{aa}, —C(═NR^{bb})OR^{aa}, —C(═NR_{bb})N(R_{bb})₂, —C(═O)NR_{bb}SO₂Rₐₐ, —C(═S)N(R_{bb})₂, —C(═O)SRₐₐ, and —C(═S)SRₐₐ, wherein R^{aa} and R^{bb} are as defined herein.

Nitrogen atoms can be substituted or unsubstituted as valency permits, and include primary, secondary, tertiary, and quarternary nitrogen atoms. Exemplary nitrogen atom substituents include, but are not limited to, hydrogen, —OH, —OR^{aa}, —N(R^{cc})₂, —CN, —C(═O)R^{aa}, —C(═O)N(R^{cc})₂, —CO₂R^{aa}, —SO₂R^{aa}, —C(═NR^{bb})R^{aa}, —C(═NR^{cc})OR^{aa}, —C(═NR^{cc})N(R^{cc})₂, —SO₂N(R^{cc})₂, —SO₂R^{cc}, —SO₂OR^{cc}, —SOR^{aa}, —C(═S)N(R^{cc})₂, —C(═O)SR^{cc}, C(═S)SR^{cc}, —P(═O)₂R^{aa}, —P(═O)(R^{aa})₂, —P(═O)₂N(R^{cc})₂, —P(═O)(NR^{cc})₂, C₁₋₁₀ alkyl, C₁₋₁₀ perhaloalkyl, C₂₋₁₀ alkenyl, C₂₋₁₀ alkynyl, C₃₋₁₀ carbocyclyl, 3-14 membered heterocyclyl, C₆₋₄ aryl, and 5-14 membered heteroaryl, or two R^{cc} groups attached to a nitrogen atom are joined to form a 3-14 membered heterocyclyl or 5-14 membered heteroaryl ring, wherein each alkyl, alkenyl, alkynyl, carbocyclyl, heterocyclyl, aryl, and heteroaryl is independently substituted with 0, 1, 2, 3, 4, or 5 R^{dd} groups, and wherein R^{aa}, R^{bb}, R^{cc}, and R^{dd} are as defined above.

In certain embodiments, the substituent present on a nitrogen atom is a nitrogen protecting group (also referred to as an amino protecting group). Nitrogen protecting groups include, but are not limited to, —OH, —OR^{aa}, —N(R^{cc})₂, —C(═O)R^{aa}, —C(═O)N(R^{cc})₂, —CO₂R^{aa}, —SO₂R^{aa}, —C(═NR^{cc})R^{aa}, —C(═NR^{cc})OR^{aa}, —C(═NR^{cc})N(R^{cc})₂, —SO₂N(R^{cc})₂, —SO₂R^{cc}, SO₂OR^{cc}, —SOR^{aa}, —C(═S)N(R^{cc})₂, —C(═O)SR^{cc}, —C(═S)SR^{cc}, C₁₋₁₀ alkyl (e.g., aralkyl, heteroaralkyl), C₂₋₁₀ alkenyl, C₂₋₁₀ alkynyl, C₃₋₁₀ carbocyclyl, 3-14 membered heterocyclyl, C₆₋₄ aryl, and 5-14 membered heteroaryl groups, wherein each alkyl, alkenyl, alkynyl, carbocyclyl, heterocyclyl, aralkyl, aryl, and heteroaryl is independently substituted with 0, 1, 2, 3, 4, or 5 R^{dd} groups, and wherein R^{aa}, R^{bb}, R^{cc} and R^{dd} are as defined herein. Nitrogen protecting groups are well known in the art and include those described in Protecting Groups in Organic Synthesis, T. W. Greene and P. G. M. Wuts, 3^{rd} edition, John Wiley & Sons, 1999, incorporated herein by reference.

For example, nitrogen protecting groups such as amide groups (e.g., —C(═O)R^{aa}) include, but are not limited to, formamide, acetamide, chloroacetamide, trichloroacetamide, trifluoroacetamide, phenylacetamide, 3-phenylpropanamide, picolinamide, 3-pyridylcarboxamide, N-benzoylphenylalanyl derivative, benzamide, p-phenylbenzamide, o-nitophenylacetamide, o-nitrophenoxyacetamide, acetoacetamide, (N′-dithiobenzyloxyacylamino)acetamide, 3-(p-hydroxyphenyl)propanamide, 3-(o-nitrophenyl)propanamide, 2-methyl-2-(o-nitrophenoxy)propanamide, 2-methyl-2-(o-phenylazophenoxy)propanamide, 4-chlorobutanamide, 3-methyl-3-nitrobutanamide, o-nitrocinnamide, N-acetylmethionine derivative, o-nitrobenzamide, and o-(benzoyloxymethyl)benzamide.

Nitrogen protecting groups such as carbamate groups (e.g., —C(═O)OR^{aa}) include, but are not limited to, methyl carbamate, ethyl carbamante, 9-fluorenylmethyl carbamate (Fmoc), 9-(2-sulfo)fluorenylmethyl carbamate, 9-(2,7-dibromo)fluoroenylmethyl carbamate, 2,7-di-t-butyl-[9-(10,10-dioxo-10,10,10,10-tetrahydrothioxanthyl)]methyl carbamate (DBD-Tmoc), 4-methoxyphenacyl carbamate (Phenoc), 2,2,2-trichloroethyl carbamate (Troc), 2-trimethylsilylethyl carbamate (Teoc), 2-phenylethyl carbamate (hZ), 1-(1-adamantyl)-1-methylethyl carbamate (Adpoc), 1,1-dimethyl-2-haloethyl carbamate, 1,1-dimethyl-2,2-dibromoethyl carbamate (DB-t-BOC), 1,1-dimethyl-2,2,2-trichloroethyl carbamate (TCBOC), 1-methyl-1-(4-biphenylyl)ethyl carbamate (Bpoc), 1-(3,5-di-t-butylphenyl)-1-methylethyl carbamate (t-Bumeoc), 2-(2′- and 4′-pyridyl)ethyl carbamate (Pyoc), 2-(N,N-dicyclohexylcarboxamido)ethyl carbamate, t-butyl carbamate (BOC or Boc), 1-adamantyl carbamate (Adoc), vinyl carbamate (Voc), allyl carbamate (Alloc), 1-isopropylallyl carbamate (Ipaoc), cinnamyl carbamate (Coc), 4-nitrocinnamyl carbamate (Noc), 8-quinolyl carbamate, N-hydroxypiperidinyl carbamate, alkyldithio carbamate, benzyl carbamate (Cbz), p-methoxybenzyl carbamate (Moz), p-nitobenzyl carbamate, p-bromobenzyl carbamate, p-chlorobenzyl carbamate, 2,4-dichlorobenzyl carbamate, 4-methylsulfinylbenzyl carbamate (Msz), 9-anthrylmethyl carbamate, diphenylmethyl carbamate, 2-methylthioethyl carbamate, 2-methylsulfonylethyl carbamate, 2-(p-toluenesulfonyl)ethyl carbamate, [2-(1,3-dithianyl)]methyl carbamate (Dmoc), 4-methylthiophenyl carbamate (Mtpc), 2,4-dimethylthiophenyl carbamate (Bmpc), 2-phosphonioethyl carbamate (Peoc), 2-triphenylphosphonioisopropyl carbamate (Ppoc), 1,1-dimethyl-2-cyanoethyl carbamate, m-chloro-p-acyloxybenzyl carbamate, p-(dihydroxyboryl)benzyl carbamate, 5-benzisoxazolylmethyl carbamate, 2-(trifluoromethyl)-6-chromonylmethyl carbamate (Tcroc), m-nitrophenyl carbamate, 3,5-dimethoxybenzyl carbamate, o-nitrobenzyl carbamate, 3,4-dimethoxy-6-nitrobenzyl carbamate, phenyl(o-nitrophenyl)methyl carbamate, t-amyl carbamate, S-benzyl thiocarbamate, p-cyanobenzyl carbamate, cyclobutyl carbamate, cyclohexyl carbamate, cyclopentyl carbamate, cyclopropylmethyl carbamate, p-decyloxybenzyl carbamate, 2,2-dimethoxyacylvinyl carbamate, o-(N,N-dimethylcarboxamido)benzyl carbamate, 1,1-dimethyl-3-(N,N-dimethylcarboxamido)propyl carbamate, 1,1-dimethylpropynyl carbamate, di(2-pyridyl)methyl carbamate, 2-furanylmethyl carbamate, 2-iodoethyl carbamate, isoborynl carbamate, isobutyl carbamate, isonicotinyl carbamate, p-(p′-methoxyphenylazo)benzyl carbamate, 1-methylcyclobutyl carbamate, 1-methylcyclohexyl carbamate, 1-methyl-1-cyclopropylmethyl carbamate, 1-methyl-1-(3,5-dimethoxyphenyl)ethyl carbamate, 1-methyl-1-(p-phenylazophenyl)ethyl carbamate, 1-methyl-1-phenylethyl carbamate, 1-methyl-1-(4-pyridyl)ethyl carbamate, phenyl carbamate, p-(phenylazo)benzyl carbamate, 2,4,6-tri-t-butylphenyl carbamate, 4-(trimethylammonium)benzyl carbamate, and 2,4,6-trimethylbenzyl carbamate.

Nitrogen protecting groups such as sulfonamide groups (e.g., —S(═O)₂R^{aa}) include, but are not limited to, p-toluenesulfonamide (Ts), benzenesulfonamide, 2,3,6,-trimethyl-4-methoxybenzenesulfonamide (Mtr), 2,4,6-trimethoxybenzenesulfonamide (Mtb), 2,6-dimethyl-4-methoxybenzenesulfonamide (Pme), 2,3,5,6-tetramethyl-4-methoxybenzenesulfonamide (Mte), 4-methoxybenzenesulfonamide (Mbs), 2,4,6-trimethylbenzenesulfonamide (Mts), 2,6-dimethoxy-4-methylbenzenesulfonamide (iMds), 2,2,5,7,8-pentamethylchroman-6-sulfonamide (Pmc), methanesulfonamide (Ms), β-trimethylsilylethanesulfonamide (SES), 9-anthracenesulfonamide, 4-(4′,8′-dimethoxynaphthylmethyl)benzenesulfonamide (DNMBS), benzylsulfonamide, trifluoromethylsulfonamide, and phenacylsulfonamide.

Other nitrogen protecting groups include, but are not limited to, phenothiazinyl-(10)-acyl derivative, N′-p-toluenesulfonylaminoacyl derivative, N′-phenylaminothioacyl derivative, N-benzoylphenylalanyl derivative, N-acetylmethionine derivative, 4,5-diphenyl-3-oxazolin-2-one, N-phthalimide, N-dithiasuccinimide (Dts), N-2,3-diphenylmaleimide, N-2,5-dimethylpyrrole, N-1,1,4,4-tetramethyldisilylazacyclopentane adduct (STABASE), 5-substituted 1,3-dimethyl-1,3,5-triazacyclohexan-2-one, 5-substituted 1,3-dibenzyl-1,3,5-triazacyclohexan-2-one, 1-substituted 3,5-dinitro-4-pyridone, N-methylamine, N-allylamine, N-[2-(trimethylsilyl)ethoxy]methylamine (SEM), N-3-acetoxypropylamine, N-(1-isopropyl-4-nitro-2-oxo-3-pyroolin-3-yl)amine, quaternary ammonium salts, N-benzylamine, N-di(4-methoxyphenyl)methylamine, N-5-dibenzosuberylamine, N-triphenylmethylamine (Tr), N-[(4-methoxyphenyl)diphenylmethyl]amine (MMTr), N-9-phenylfluorenylamine (PhF), N-2,7-dichloro-9-fluorenylmethyleneamine, N-ferrocenylmethylamino (Fcm), N-2-picolylamino N′-oxide, N-1,1-dimethylthiomethyleneamine, N-benzylideneamine, N-p-methoxybenzylideneamine, N-diphenylmethyleneamine, N-[(2-pyridyl)mesityl]methyleneamine, N—(N′,N′-dimethylaminomethylene)amine, N,N′-isopropylidenediamine, N-p-nitrobenzylideneamine, N-salicylideneamine, N-5-chlorosalicylideneamine, N-(5-chloro-2-hydroxyphenyl)phenylmethyleneamine, N-cyclohexylideneamine, N-(5,5-dimethyl-3-oxo-1-cyclohexenyl)amine, N-borane derivative, N-diphenylborinic acid derivative, N-[phenyl(pentaacylchromium- or tungsten)acyl]amine, N-copper chelate, N-zinc chelate, N-nitroamine, N-nitrosoamine, amine N-oxide, diphenylphosphinamide (Dpp), dimethylthiophosphinamide (Mpt), diphenylthiophosphinamide (Ppt), dialkyl phosphoramidates, dibenzyl phosphoramidate, diphenyl phosphoramidate, benzenesulfenamide, o-nitrobenzenesulfenamide (Nps), 2,4-dinitrobenzenesulfenamide, pentachlorobenzenesulfenamide, 2-nitro-4-methoxybenzenesulfenamide, triphenylmethylsulfenamide, and 3-nitropyridinesulfenamide (Npys).

In certain embodiments, the substituent present on an oxygen atom is an oxygen protecting group (also referred to as a hydroxyl protecting group). Oxygen protecting groups include, but are not limited to, —R^{aa}, —N(R^{bb})₂, —C(═O)SR^{aa}, —C(═O)R^{aa}, —CO₂R^{aa}, —C(═O)N(R^{bb})₂, —C(═NR^{bb})R^{aa}, —C(═NR^{bb})OR^{aa}, —C(═NR^{bb})N(R^{bb})₂, —S(═O)R^{aa}, —SO₂R^{aa}, Si(R^{aa})₃, —P(R^{cc})₂, —P(R^{cc})₃, —P(═O)₂R^{aa}, —P(═O)(R^{aa})₂, —P(═O)(OR^{cc})₂, —P(═O)₂N(R^{bb})₂, and —P(═O)(NR^{bb})₂, wherein R^{aa}, R^{bb}, and R^{cc} are as defined herein. Oxygen protecting groups are well known in the art and include those described in Protecting Groups in Organic Synthesis, T. W. Greene and P. G. M. Wuts, 3^{rd} edition, John Wiley & Sons, 1999, incorporated herein by reference.

Exemplary oxygen protecting groups include, but are not limited to, methyl, methoxylmethyl (MOM), methylthiomethyl (MTM), t-butylthiomethyl, (phenyldimethylsilyl)methoxymethyl (SMOM), benzyloxymethyl (BOM), p-methoxybenzyloxymethyl (PMBM), (4-methoxyphenoxy)methyl (p-AOM), guaiacolmethyl (GUM), t-butoxymethyl, 4-pentenyloxymethyl (POM), siloxymethyl, 2-methoxyethoxymethyl (MEM), 2,2,2-trichloroethoxymethyl, bis(2-chloroethoxy)methyl, 2-(trimethylsilyl)ethoxymethyl (SEMOR), tetrahydropyranyl (THP), 3-bromotetrahydropyranyl, tetrahydrothiopyranyl, 1-methoxycyclohexyl, 4-methoxytetrahydropyranyl (MTHP), 4-methoxytetrahydrothiopyranyl, 4-methoxytetrahydrothiopyranyl S,S-dioxide, 1-[(2-chloro-4-methyl)phenyl]-4-methoxypiperidin-4-yl (CTMP), 1,4-dioxan-2-yl, tetrahydrofuranyl, tetrahydrothiofuranyl, 2,3,3a,4,5,6,7,7a-octahydro-7,8,8-trimethyl-4,7-methanobenzofuran-2-yl, 1-ethoxyethyl, 1-(2-chloroethoxy)ethyl, 1-methyl-1-methoxyethyl, 1-methyl-1-benzyloxyethyl, 1-methyl-1-benzyloxy-2-fluoroethyl, 2,2,2-trichloroethyl, 2-trimethylsilylethyl, 2-(phenylselenyl)ethyl, t-butyl, allyl, p-chlorophenyl, p-methoxyphenyl, 2,4-dinitrophenyl, benzyl (Bn), p-methoxybenzyl, 3,4-dimethoxybenzyl, o-nitrobenzyl, p-nitrobenzyl, p-halobenzyl, 2,6-dichlorobenzyl, p-cyanobenzyl, p-phenylbenzyl, 2-picolyl, 4-picolyl, 3-methyl-2-picolyl N-oxido, diphenylmethyl, p,p′-dinitrobenzhydryl, 5-dibenzosuberyl, triphenylmethyl, a-naphthyldiphenylmethyl, p-methoxyphenyldiphenylmethyl, di(p-methoxyphenyl)phenylmethyl, tri(p-methoxyphenyl)methyl, 4-(4′-bromophenacyloxyphenyl)diphenylmethyl, 4,4′,4″-tris(4,5-dichlorophthalimidophenyl)methyl, 4,4′,4″-tris(levulinoyloxyphenyl)methyl, 4,4′,4″-tris(benzoyloxyphenyl)methyl, 3-(imidazol-1-yl)bis(4′,4″-dimethoxyphenyl)methyl, 1,1-bis(4-methoxyphenyl)-1′-pyrenylmethyl, 9-anthryl, 9-(9-phenyl)xanthenyl, 9-(9-phenyl-10-oxo)anthryl, 1,3-benzodisulfuran-2-yl, benzisothiazolyl S,S-dioxido, trimethylsilyl (TMS), triethylsilyl (TES), triisopropylsilyl (TIPS), dimethylisopropylsilyl (IPDMS), diethylisopropylsilyl (DEIPS), dimethylthexylsilyl, t-butyldimethylsilyl (TBDMS), t-butyldiphenylsilyl (TBDPS), tribenzylsilyl, tri-p-xylylsilyl, triphenylsilyl, diphenylmethylsilyl (DPMS), t-butylmethoxyphenylsilyl (TBMPS), formate, benzoylformate, acetate, chloroacetate, dichloroacetate, trichloroacetate, trifluoroacetate, methoxyacetate, triphenylmethoxyacetate, phenoxyacetate, p-chlorophenoxyacetate, 3-phenylpropionate, 4-oxopentanoate (levulinate), 4,4-(ethylenedithio)pentanoate (levulinoyldithioacetal), pivaloate, adamantoate, crotonate, 4-methoxycrotonate, benzoate, p-phenylbenzoate, 2,4,6-trimethylbenzoate (mesitoate), alkyl methyl carbonate, 9-fluorenylmethyl carbonate (Fmoc), alkyl ethyl carbonate, t-butyl carbonate (BOC or Boc), alkyl 2,2,2-trichloroethyl carbonate (Troc), 2-(trimethylsilyl)ethyl carbonate (TMSEC), 2-(phenylsulfonyl) ethyl carbonate (Psec), 2-(triphenylphosphonio) ethyl carbonate (Peoc), alkyl isobutyl carbonate, alkyl vinyl carbonate alkyl allyl carbonate, alkyl p-nitrophenyl carbonate, alkyl benzyl carbonate, alkyl p-methoxybenzyl carbonate, alkyl 3,4-dimethoxybenzyl carbonate, alkyl o-nitrobenzyl carbonate, alkyl p-nitrobenzyl carbonate, alkyl S-benzyl thiocarbonate, 4-ethoxy-1-napththyl carbonate, methyl dithiocarbonate, 2-iodobenzoate, 4-azidobutyrate, 4-nitro-4-methylpentanoate, o-(dibromomethyl)benzoate, 2-formylbenzenesulfonate, 2-(methylthiomethoxy)ethyl, 4-(methylthiomethoxy)butyrate, 2-(methylthiomethoxymethyl)benzoate, 2,6-dichloro-4-methylphenoxyacetate, 2,6-dichloro-4-(1,1,3,3-tetramethylbutyl)phenoxyacetate, 2,4-bis(1,1-dimethylpropyl)phenoxyacetate, chlorodiphenylacetate, isobutyrate, monosuccinoate, (E)-2-methyl-2-butenoate, o-(methoxyacyl)benzoate, α-naphthoate, nitrate, alkyl N,N,N′,N′-tetramethylphosphorodiamidate, alkyl N-phenylcarbamate, borate, dimethylphosphinothioyl, alkyl 2,4-dinitrophenylsulfenate, sulfate, methanesulfonate (mesylate), benzylsulfonate, and tosylate (Ts).

These and other exemplary substituents are described in more detail in the Detailed Description, Figures, Examples, and Claims. The invention is not intended to be limited in any manner by the above exemplary listing of substituents.

### Other Definitions

The following definitions are more general terms used throughout the present application.

The term “catalysis,” “catalyze,” or “catalytic” refers to the increase in rate of a chemical reaction due to the participation of a substance called a “catalyst.” In certain embodiments, the amount and nature of a catalyst remains essentially unchanged during a reaction. In certain embodiments, a catalyst is regenerated, or the nature of a catalyst is essentially restored after a reaction. A catalyst may participate in multiple chemical transformations. The effect of a catalyst may vary due to the presence of other substances known as inhibitors or poisons (which reduce the catalytic activity) or promoters (which increase the activity). Catalyzed reactions have a lower activation energy (rate-limiting free energy of activation) than the corresponding uncatalyzed reaction, resulting in a higher reaction rate at the same temperature. Catalysts may affect the reaction environment favorably, bind to the reagents to polarize bonds, form specific intermediates that are not typically produced by an uncatalyzed reaction, or cause dissociation of reagents to reactive forms.

The term “catalytic amount” is recognized in the art and means a substoichiometric amount of a reagent relative to a reactant. As used herein, a catalytic amount means from about 0.0001 to about 90 mole percent reagent relative to a reactant. In certain embodiments, a catalytic amount means from about 0.001 to about 50 mole percent. In certain embodiments, a catalytic amount means from about 0.01 to about 10 mole percent. In certain embodiments, a catalytic amount means from about 0.01 to about 5 mole percent reagent to reactant. In certain embodiments, a catalytic amount means from about 0.01 to about 4 mole percent reagent to reactant. In certain embodiments, a catalytic amount means from about 0.01 to about 3 mole percent reagent to reactant. In certain embodiments, a catalytic amount means from about 0.01 to about 2 mole percent reagent to reactant. In certain embodiments, a catalytic amount means from about 0.01 to about 1 mole percent reagent to reactant. In certain embodiments, a catalytic amount means from about 0.05 to about 1 mole percent reagent to reactant. In certain embodiments, a catalytic amount means from about 0.05 to about 0.5 mole percent reagent to reactant. In certain embodiments, a catalytic amount means from about 0.1 to about 0.5 mole percent reagent to reactant. In certain embodiments, a catalytic amount means from about 0.1 to about 0.4 mole percent reagent to reactant. In certain embodiments, a catalytic amount means from about 0.1 to about 0.3 mole percent reagent to reactant. In certain embodiments, a catalytic amount means from about 0.2 to about 0.3 mole percent reagent to reactant.

The term “aprotic solvent” means a non-nucleophilic solvent having a boiling point range above ambient temperature, preferably from about 25° C. to about 190° C. at atmospheric pressure. In certain embodiments, the aprotic solvent has a boiling point from about 80° C. to about 160° C. at atmospheric pressure. In certain embodiments, the aprotic solvent has a boiling point from about 80° C. to about 150° C. at atmospheric pressure. Examples of aprotic solvents include, but are not limited to, methylene chloride, acetonitrile, toluene, DMF, diglyme, THF, and DMSO.

The term “oxidation state of a metal” refers to an indicator of the degree of oxidation of a metal atom in a chemical compound. The oxidation state is the hypothetical charge that the metal atom would have if all ligands are assigned closed shell electronic structures. Metal atoms capable of having an oxidation state of +1 include, but are not limited to, Li, Na, K, Rb, Cs, Cu, Ag, Au, Hg, and Ti. Metal atoms capable of having an oxidation state of +2 include, but are not limited to, Be, Mg, Ca, Sr, Ba, Ra, Ti, V, Nb, Cr, Mo, Mn, Re, Eu, Yb, Sm, Ru, Os, Co, Rh, Ir, Ni, Pd, Pt, W, and Fe. Metal atoms capable of having an oxidation state of +3 include, but are not limited to, Al, Ga, In, Sc, Y, La, Ti, V, Nb, Ta, Cr, Mo, W, Mn, Fe, Os, Co, Rh, Ru, Ir, Ce, Pr, Nd, Pm, Sm, Eu, Gd, Tb, Dy, Ho, Er, Tm Yb, Lu, Ac, U, Lu, Ac, Th, Pa, U, Np, Pu, Am, and Cm. Metal atoms capable of having an oxidation state of +4 include, but are not limited to, Ti, Zr, Hf, V, Nb, Ta, Mn, Zr, Mo, Ru, Rh, Pd, Sn, Hf, W, Re, Os, Ir, Pt, Pb, Ce, Pr, Th, U, Pr, Th, Pa, U, Np, and Pu. Metal atoms capable of having an oxidation state of +5 include, but are not limited to, V, Nb, Mo, Ta, W, Pa, U, and Np. Metal atoms capable of having an oxidation state of +6 include, but are not limited to, Mn, Mo, Ru, W, Re, Os, Ir, and U.

The term “1,3-diene” or “conjugated diene” refers to any molecule that has two carbon-carbon double bonds separated by a single bond. 1,3-Dienes may include all other types of organic substituents than the double bonds. Exemplary 1,3-dienes are of any of the following formulae:

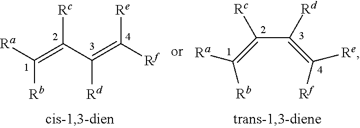

wherein each of R^{a}, R^{b}, R^{c}, R^{d}, R^{e}, and R^{f} is independently any organic substituent.

The term “1,2-hydrosilylation” of a 1,3-diene refers to the addition of Si—H to the double bond at the 1,2-position of the 1,3-diene (Scheme 2):

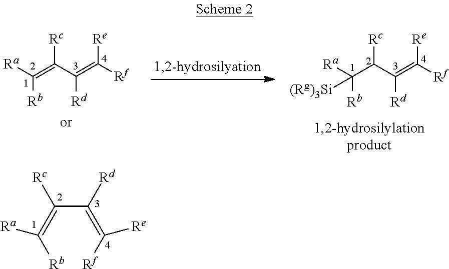

wherein each of R^{a}, R^{b}, R^{c}, R^{d}, R^{e}, R^{f}, and R^{g} is independently any organic substituent.

The term “1,4-hydrosilylation” of a 1,3-diene refers to the addition of Si—H to the carbon atoms at the 1,4-position of the 1,3-diene (Scheme 3):

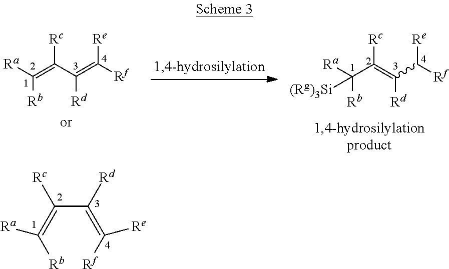

wherein each of R^{a}, R^{b}, R^{c}, R^{d}, R^{e}, R^{f}, and R^{g} is independently any organic substituent; and “ [symbol] ” means —CHR^{f}R^{e} is either cis or trans to —CR^{a}R^{b}Si(R)₃.

The term “organosilane” refers to an organic compound containing at least one carbon-silicon bond. Exemplary organosilanes include, but are not limited to, silanol, siloxide, siloxane, silyl ether, silyl halide, silyl hydride, and silene. Silanol refers to compounds with at least one Si—OH bond. Silanols tend to dehydrate to give siloxanes. Siloxides (or silanoates) are the deprotonated derivatives of silanols. Silyl ethers refer to compounds having the connectivity of Si—O—C. Silyl halides refer to compounds with Si-halogen moiety. Silyl halides include silyl floride, silyl chloride, silyl bromide, and silyl iodide. Silyl hydrides refer to compounds having at least one Si—H bonds. Sometimes, the presence of the silyl hydride is not mentioned in the name of the compound, for example, triethylsilane (Et₃SiH) and phenylsilane (PhSiH₃). Accordingly, the silyl hydride used herein is defined by the presence of Si—H moiety. Silenes, also known as alkylidenesilanes, refer to compounds having Si═C bonds.

A “Grignard reagent” refers to chemical reagents which are prepared by the reaction of magnesium metal with an organic halide. Gignard reagents refer to any of a class of reagents with the general formula R^{x}MgX, in which R is an organic radical, including but not limited to where R^{x} is an alkyl or aryl, and X is a halogen. Grignard reagents are used as a source of nucleophillic carbon. While not limiting the scope of the present invention, the reagent is commonly used but not limited to reacting with acyl, epoxide, alcohols, heterocyclic, carboyxllic acids, esters, ethers, and other electrophillic atoms.

An “alkyl lithium” refers to a compound having the formula R^{al}—Li, wherein R^{al} is an optionally substituted alkyl group. R^{al} can be branched or unbranced, or substituted or unsubstituted. Examples of alkyl lithium reagents include, but are not limited to, methyl lithium, ethyl lithium, n-propyl lithium, n-butyl lithium, s-butyl lithium, and t-butyl lithium.

An “alkyl potassium” refers to a compound having the formula R^{al}—K, wherein R^{al} is an optionally substituted alkyl group. R^{al} can be branched or unbranced, or substituted or unsubstituted. Examples of alkyl potassium include, but are not limited to, benzyl potassium and tri-phenyl methyl potassium.

An “alkyl zinc” refers to a compound having the R^{al}—Zn moiety, wherein R^{al} is an optionally substituted alkyl group. R^{al} can be branched or unbranced, or substituted or unsubstituted. Examples of alkyl zinc include, but are not limited to, di-ethyl zinc and di-methyl zinc.

The term “complex” or “coordination complex” refers to an association of at least one atom or ion (which is referred to as a “central atom,” “central ion,” or “acceptor,” and is usually a metallic cation) and a surrounding array of bound ligands or donors). Ligands are generally bound to a central atom or central ion by a coordinate covalent bond (e.g., ligands may donate electrons from a lone electron pair into an empty orbital of the central atom or central ion) and are referred to as being “coordinated” to the central atom or central ion. There are also organic ligands such as alkenes whose π-bonds can coordinate to empty orbitals of an acceptor. A complex may include one or more donors, which can be the same or different. A complex may also include one or more acceptors, which can be the same or different.

The term “ligand” refers to an ion or molecule that binds to a central atom or ion (e.g., a central metal atom or ion) to form a coordination complex. Ligands are usually electron donors, and the central atom or ion is an electron acceptor. The bonding between the central atom or ion and the ligand typically involves formal donation of one or more of the ligand's electron pairs. The nature of such bonding can range from covalent to ionic, and the bond order can range from one to three. One central atom or ion may bind to one or more ligands of the same or different type. A ligand may be capable of binding a central atom or ion through multiple sites, usually because the ligand includes lone pairs on more than one atom of the ligand. Ligands in a complex may affect the reactivity (e.g., ligand substitution rates and redox) of the central atom or ion. Exemplary ligands include electrically-neutral ligands (e.g., CH₃CN, amides (e.g., N,N-dimethylformamide (DMF), N,N-dimethylacetamide (DMA), or N-methyl-2-pyrrolidone (NMP)), dimethyl sulfoxide (DMSO), amines (e.g., ammonia; ethylenediamine (en); pyridine (py); 2,2′-bipyridine (bipy); and 1,10-phenanthroline (phen)), phosphines (e.g., PPh₃), ethers (e.g., tetrahydrofuran (THF), 2-methly-tetrahydrofuran, tetrahydropyran, dioxane, diethyl ether, methyl t-butyl ether (MTBE), dimethoxyethane (DME), and diglyme), ketones (e.g., acetone and butanone), chlorohydrocarbons (e.g., dichloromethane (DCM), chloroform, carbon tetrachloride, and 1,2-dichloroethane (DCE)), esters (e.g., propylene carbonate and ethyl acetate), CO, N₂, water, and alkenes) and anionic ligands (coordinating anionic counterions, e.g., halide (F⁻, Cl⁻, Br⁻, or I⁻), hydride, alkyls, NO₃⁻, NO₂⁻, CH₃COO⁻, HCOO⁻, S₂⁻, SCN⁻, N₃⁻, OH⁻, ONO⁻, NCS⁻, CN⁻, CO₃²⁻, SO₄²⁻, or C₂O₄²⁻).

The term “turnover number” or “TON” refers to the number of moles of a first compound (e.g., a 1,3-diene) that a mole of a catalyst or precatalyst (e.g., a platinum complex of Formula (I)) can convert to a second compound (e.g., a 1,2-hydrosilylated product from the 1,3-diene) before the catalyst is inactivated, wherein the first and second compounds are different.

The term “turnover frequency” or “TOF” refers to the turnover number per unit time (e.g., turnover number per hour).

### BRIEF DESCRIPTION OF THE DRAWINGS

FIG. 1 is a ¹H NMR spectrum of platinum complex 1

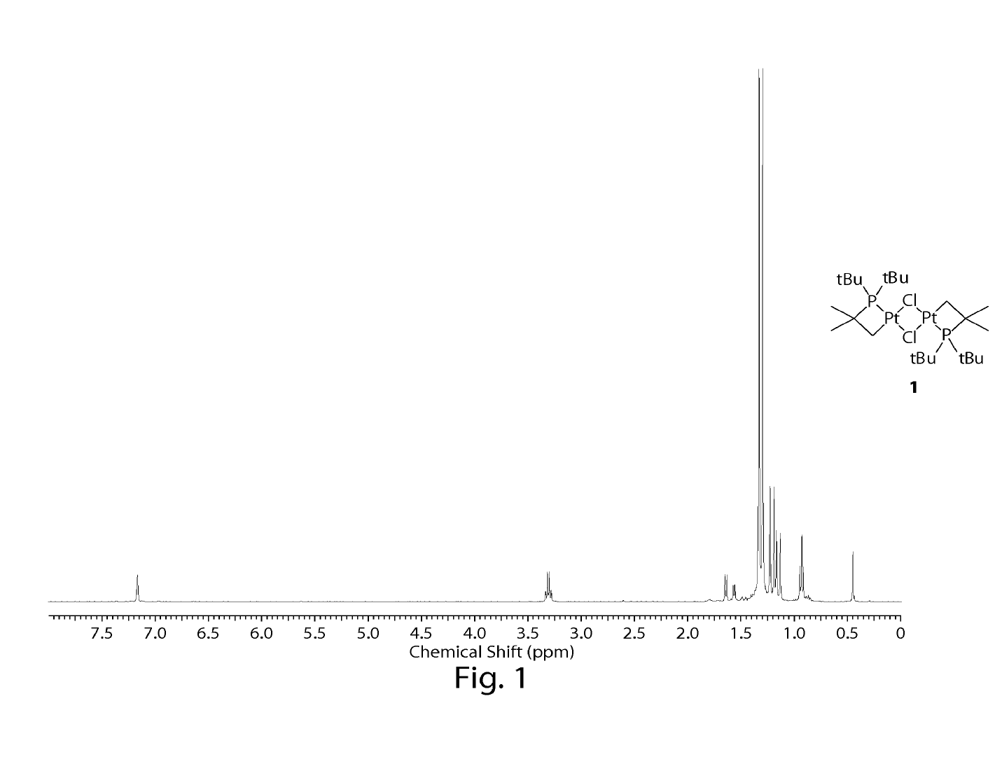

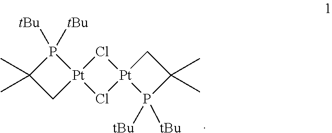

FIG. 2 is a ³¹P NMR spectrum of platinum complex 1.

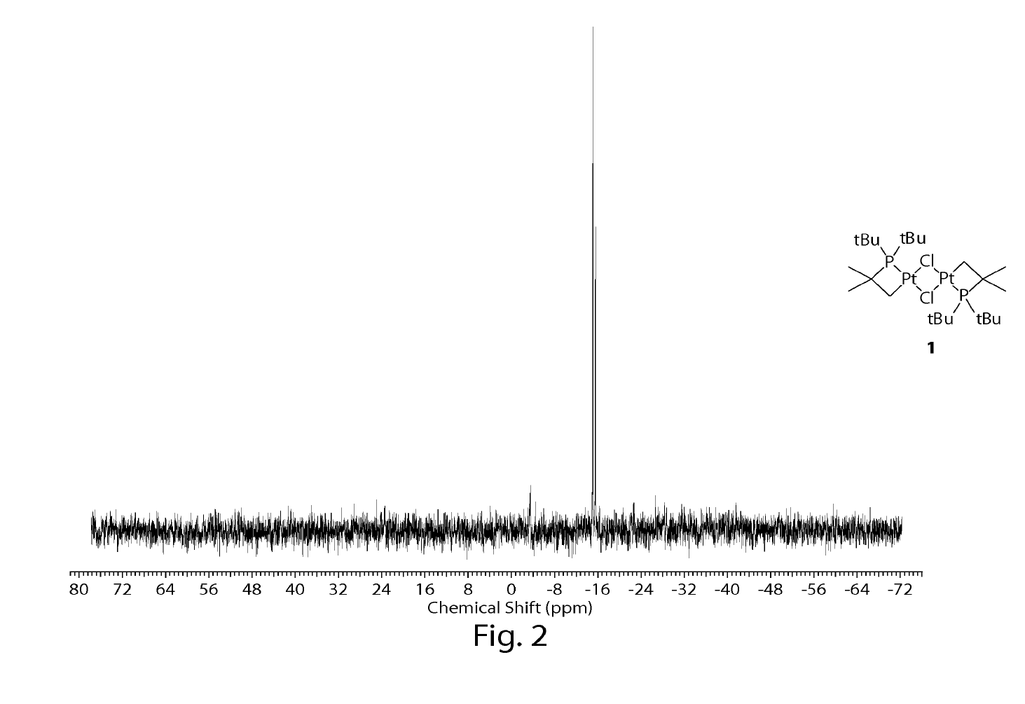

FIG. 3 is a ¹H NMR spectrum of but-3-enyltriethoxysilane (2) synthesized with platinum complex 1:

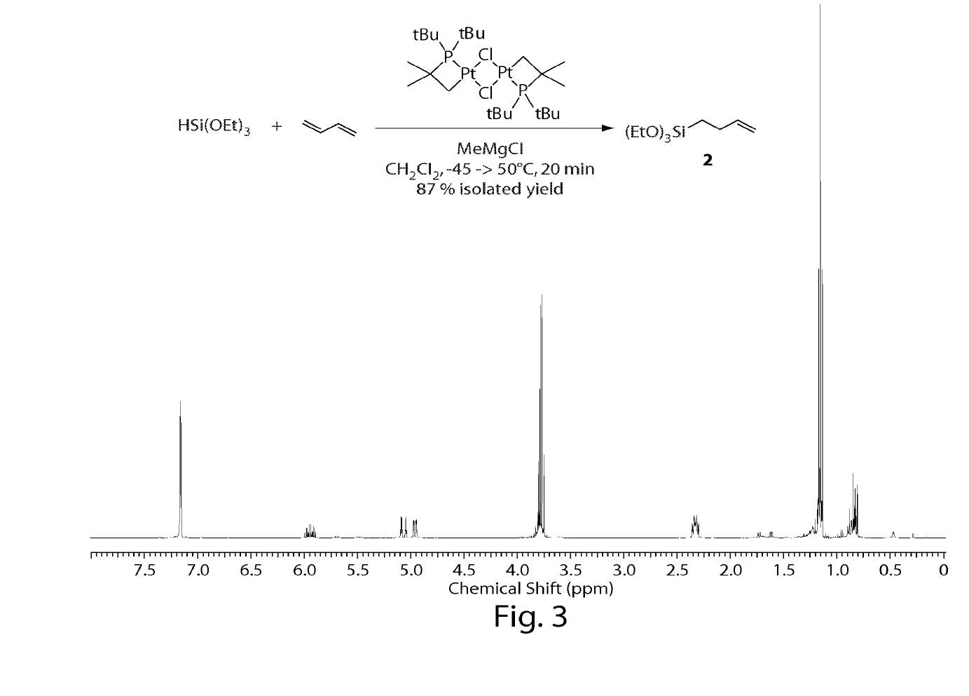

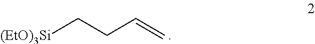

FIG. 4 is a ¹H NMR spectrum of but-3-enyltriethoxysilane (2) independently synthesized without platinum complex 1.

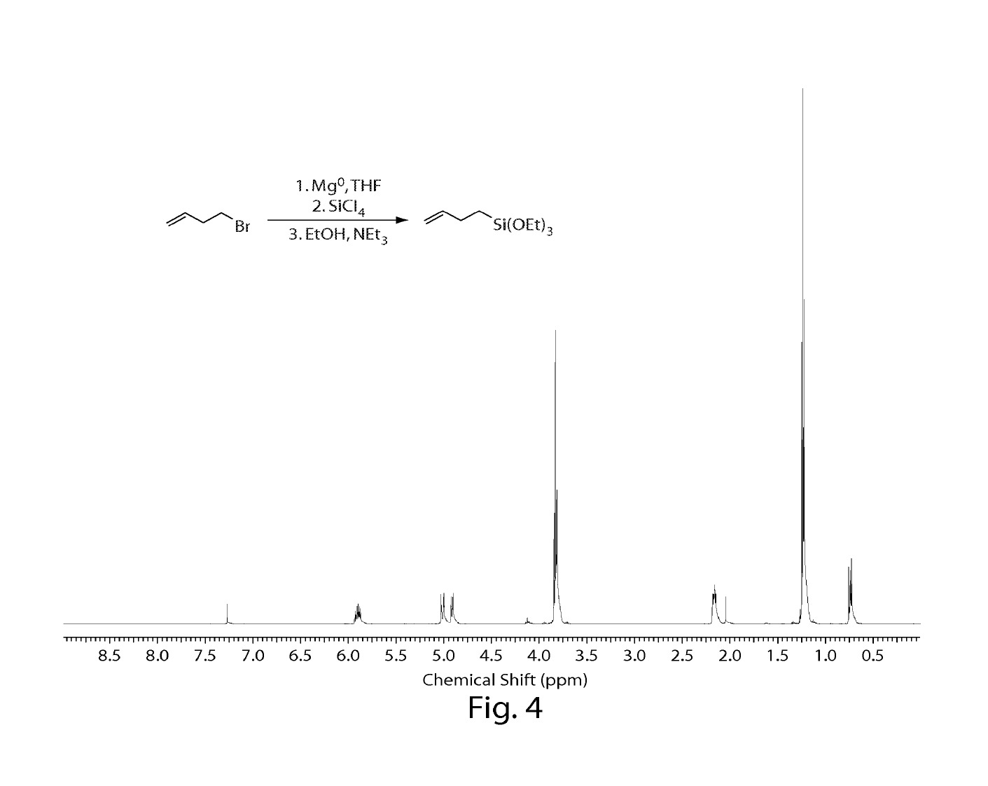

FIG. 5 is a ¹H NMR spectrum of platinum complex 3:

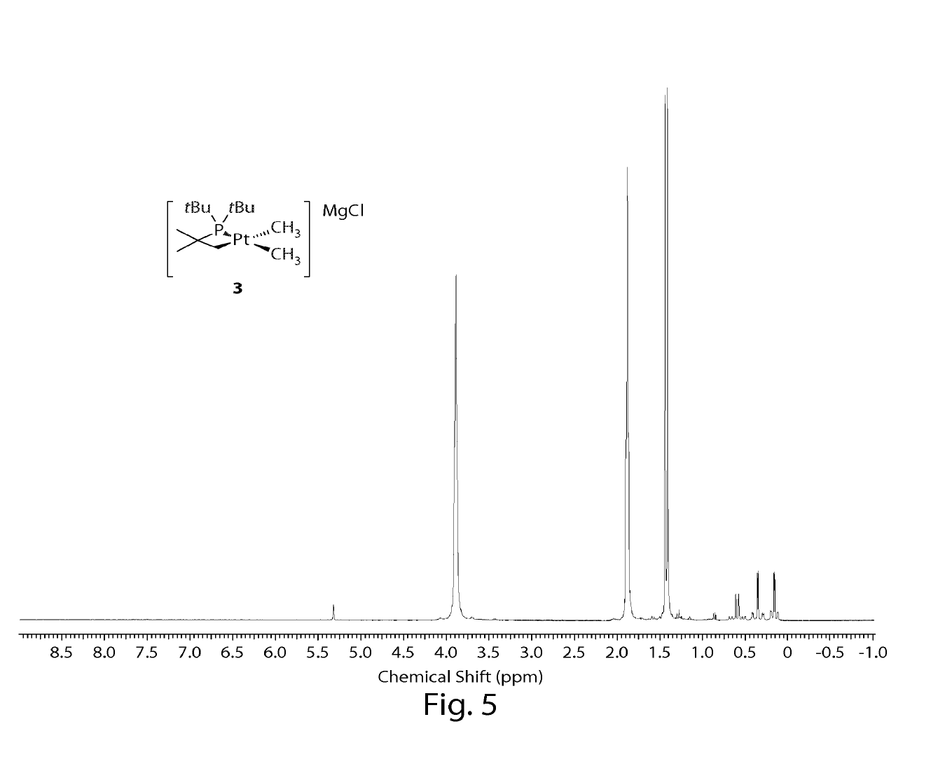

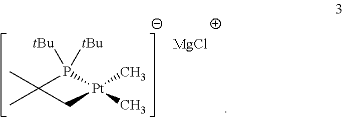

FIG. 6 is a ³¹P NMR spectrum of platinum complex 3.

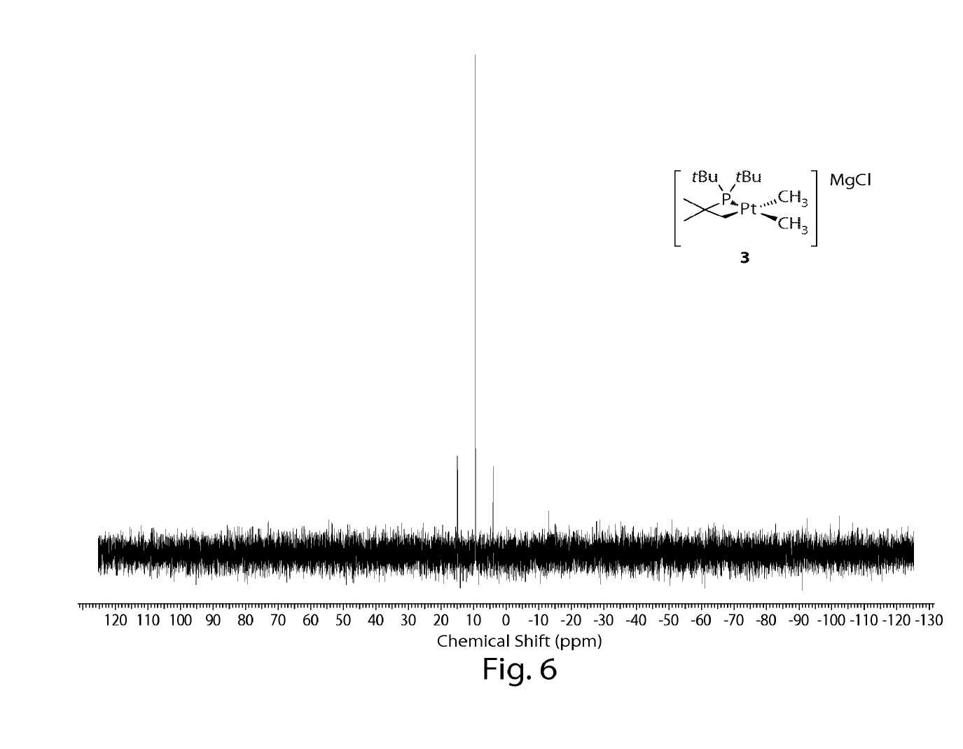

FIG. 7 is a ¹H NMR spectrum of platinum complex 4:

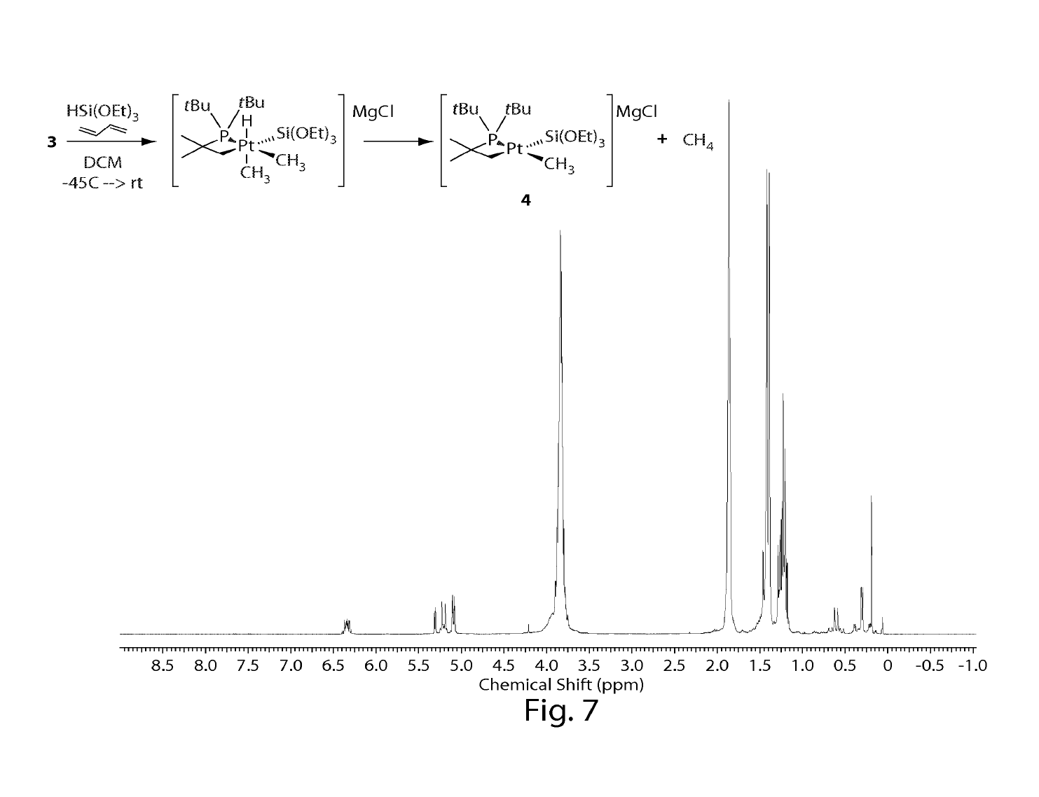

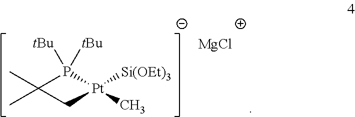

FIG. 8 is a ³¹P NMR spectrum of platinum complex 4.

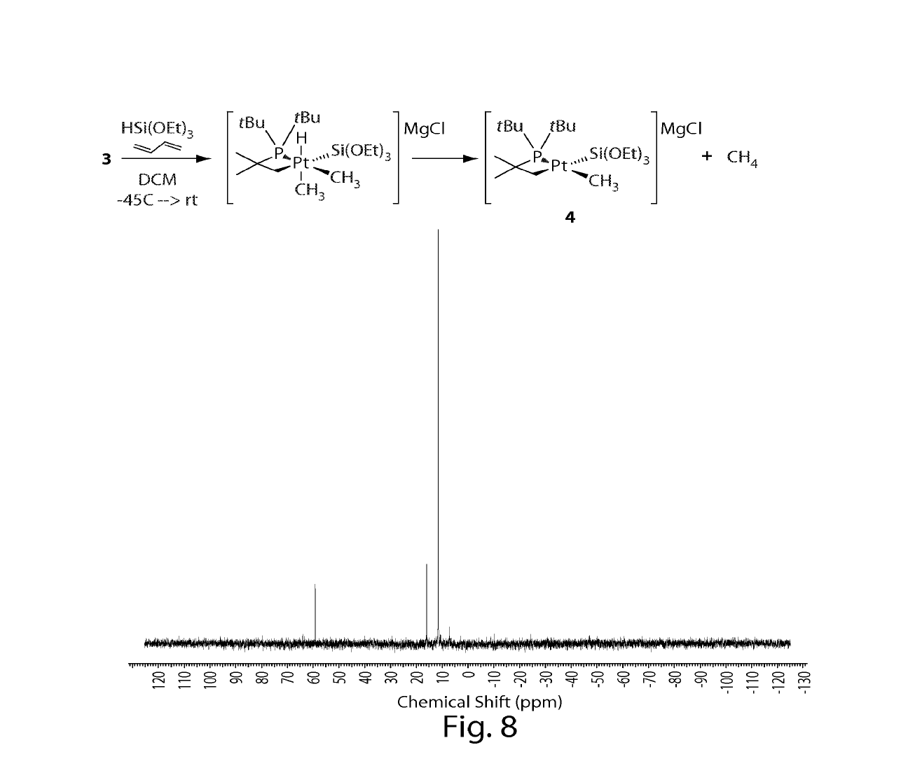

FIG. 9 is a ¹H NMR spectrum of 3-methyl-butenyltriethoxysilane (Si) synthesized with platinum complex 1:

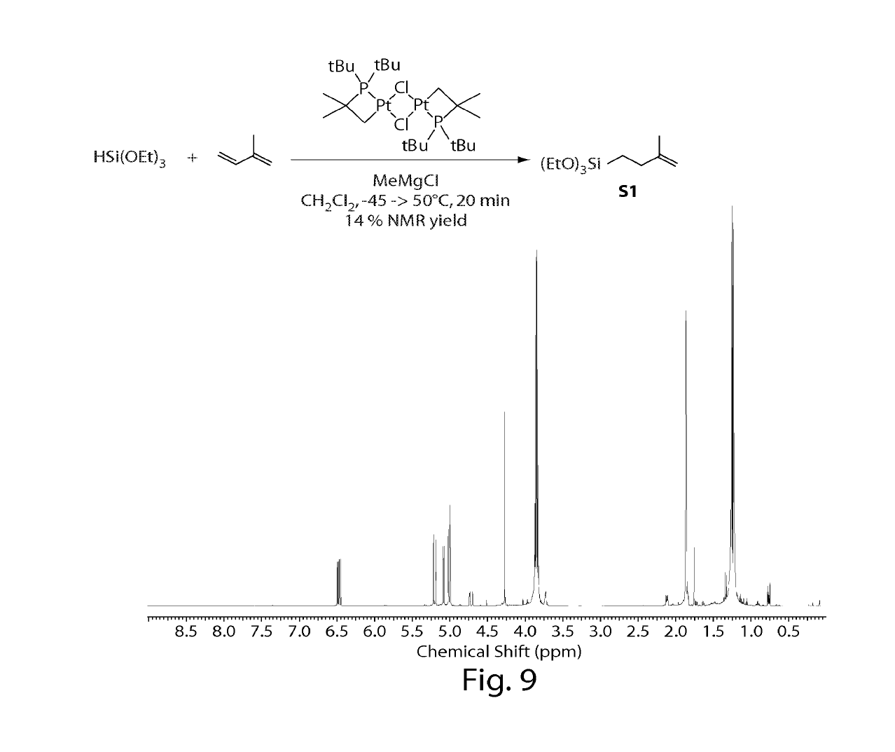

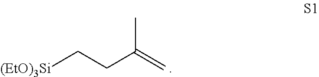

FIG. 10 is a ¹H NMR spectrum of (6,7-dimethyl-3-methyleneoct-6-en-1-yl)triethoxysilane (S2) synthesized with platinum complex 1:

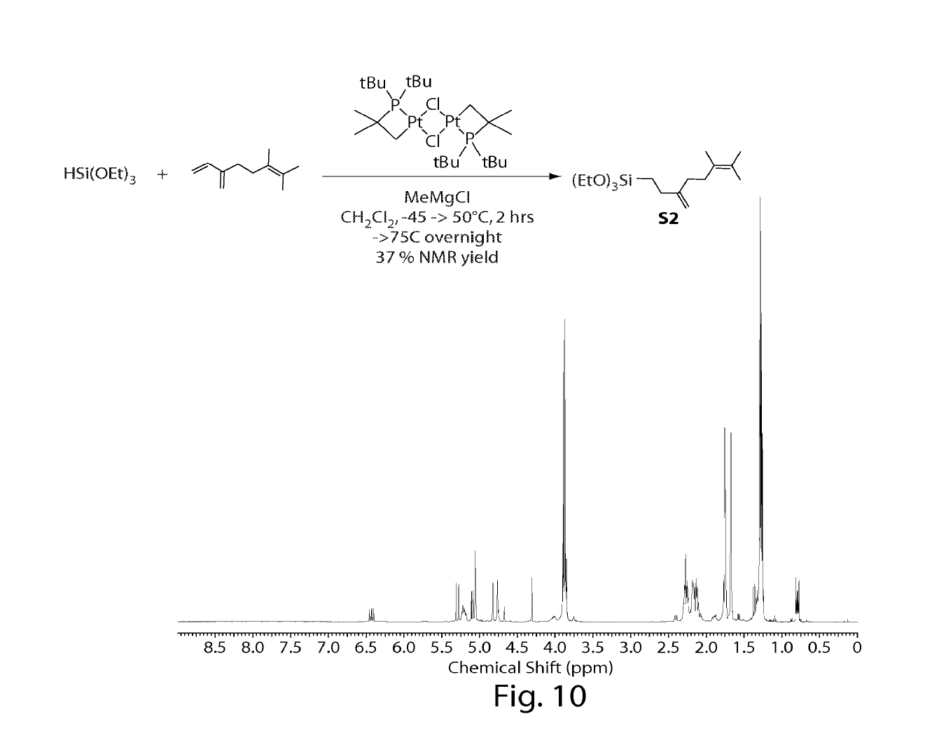

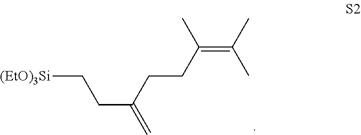

FIG. 11A shows an X-ray structure of the asymmetric unit of S11. Thermal ellipsoids are drawn at the 50% probability level, H-atoms are omitted for clarity. FIG. 11B shows an X-ray structure of S11, showing supramolecular assembly in which two Pt(II) anions are bridged by one Mg²⁺ cation. Thermal ellipsoids are drawn at the 50% probability level, H-atoms are omitted for clarity.

FIG. 12 shows a proposed mechanism of 1,2-hydrosilylation.

FIG. 13A shows an exemplary % conversion vs. time curve of a hydrosilylation reaction of butadiene using precatalyst 5. FIG. 13B shows exemplary % product vs. time curves of a hydrosilylation reaction of butadiene using precatalyst 5.

FIG. 14A shows an exemplary % conversion vs. time curve of a hydrosilylation reaction of butadiene using precatalyst 7. FIG. 14B shows exemplary % product vs. time curves of a hydrosilylation reaction of butadiene using precatalyst 7.

FIG. 15A shows an X-ray structure of the Pt anion of 6. Thermal ellipsoids are drawn at the 50% probability level, H-atoms and disorder are omitted for clarity. FIG. 15B shows an X-ray structure of the asymmetric unit of 6. Thermal ellipsoids are drawn at the 50% probability level, H-atoms are omitted for clarity. The disorder model is depicted with transparent ellipsoids. FIG. 15C shows an X-ray structure of 9, showing supramolecular assembly featuring 2 Pt atoms and 4 Mg atoms. Thermal ellipsoids are drawn at the 50% probability level, H-atoms and disorder are omitted for clarity.

### DETAILED DESCRIPTION OF CERTAIN EMBODIMENTS OF THE INVENTION

The present invention provides platinum complexes of Formulae (I)-(IV), salts thereof, compositions thereof, and kits thereof. Also provided are methods of using the platinum complexes of Formulae (I)-(IV), to selectively catalyze 1,2-hydrosilylation of 1,3-dienes. The platinum complexes described herein have one phosphine ligand bound to the central platinum atom, which has an oxidation state of +2. Also described herein are compositions, reaction mixtures and kits comprising the platinum complexes or salts thereof.

### Platinum Complexes

As generally described herein, the present disclosure provides platinum complexes of Formula (I):

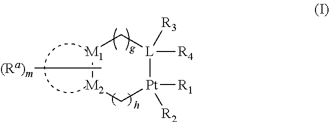

or salts thereof,
wherein:

[symbol] is absent, or a fused ring selected from the group consisting of optionally substituted aryl, optionally substituted heteroaryl, and optionally substituted heterocyclyl;

each of M₁ and M₂ is independently C or N;

L is P, N or As;

each instance of R^{a} is independently selected from the group consisting of hydrogen, halogen, optionally substituted acyl, —CN, —NO₂, —OR^{O1}, —N(R^{N1})₂, and optionally substituted alkyl;

each instance of R₁ and R₂ is independently hydrogen, optionally substituted C₁₋₆ alkyl, —Si(R^{b})₃, or halogen;

each instance of R₃ and R₄ is independently hydrogen, optionally substituted C₁₋₆ alkyl, or halogen, each instance of R^{b} is optionally substituted C₁₋₆ alkyl or —OR^{O1};

each instance of R^{O1} is independently selected from the group consisting of hydrogen, optionally substituted acyl, optionally substituted alkyl, and an oxygen protecting group;

each instance of R^{N1} is independently selected from the group consisting of hydrogen, optionally substituted acyl, optionally substituted alkyl, and a nitrogen protecting group;

each instance of h and g is independently 0, 1, 2, or 3; and

m is independently 0, 1, 2, 3, 4, 5, 6, 7, 8, 9, 10.

As generally described above, M₁ is independently C or N. In some embodiments, M₁ is C. In some embodiments, M₁ is N.

As generally described above, M₂ is independently C or N. In some embodiments, M₂ is C. In some embodiments, M₂ is N.

As generally described above, L is P, N or As. In some embodiments, L is P. In some embodiments, L is N. In some embodiments, L is As.

As generally described above, [symbol] is absent, or a fused ring selected from the group consisting of optionally substituted aryl, optionally substituted heteroaryl, and optionally substituted heterocyclyl. In certain embodiments, [symbol] is absent, and the platinum complex of Formula (I) is of Formula (I-a). In certain embodiments, [symbol] is optionally substituted aryl. In certain embodimens, [symbol] is optionally substituted heteroaryl. In certain embodiments, [symbol] is optionally substituted aryl. In certain embodiments, [symbol] is optionally substituted heterocyclyl. In certain embodiments, [symbol] is optionally substituted five-membered heteroaryl. In certain embodiments, [symbol] is optionally substituted five-membered heterocyclyl. In certain embodiments, [symbol] is optionally substituted six-membered heteroaryl. In certain embodimens, [symbol] is optionally substituted six-membered heterocyclyl. In certain embodimens, [symbol] is of the formula:

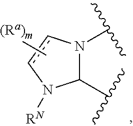

wherein R^{a}, R^{N}, and m are as defined herein. In certain embodimens, [symbol] is of the formula:

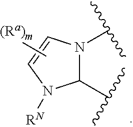

In certain embodimens, [symbol] is of the formula:

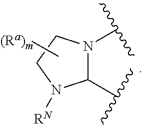

In certain embodiments, [symbol] is one of the following formulae, or a saturated or partially saturated derivative thereof:

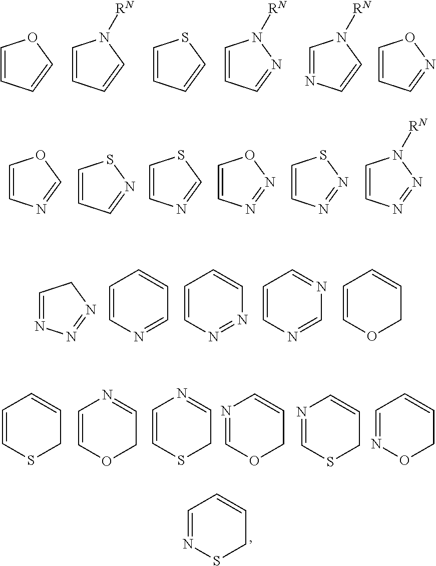

wherein the point of attachment can be any two adjacent positions as valency permits.

In certain embodiments, the platinum complex of Formula (I) is of Formula (I-a):

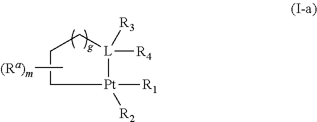

or salts thereof, wherein R₁, R₂, R₃, R₄, L, R^{a}, g, and m are as defined herein.

In certain embodiments, the platinum complex of Formula (I) is of Formula (I-a2):

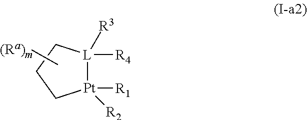

or salts thereof, R₁, R₂, R₃, R₄, R^{a}, L, and m are as defined herein.

In certain embodiments, the platinum complex of Formula (I) is of Formula (I-a3):

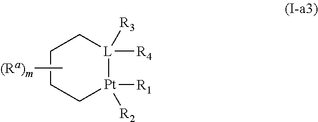

or salts thereof, wherein R₁, R₂, R₃, R₄, R^{a}, L, and m are as defined herein.

In certain embodiments, the platinum complex of Formula (I) is of Formula (I-b):

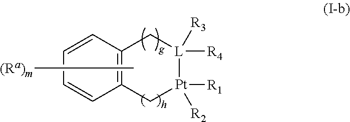

or salts thereof, wherein R₁, R₂, R₃, R₄, g, h, R^{a}, L, and m are as defined herein.

In certain embodiments, the platinum complex of Formula (I) is of Formula (I-b1):

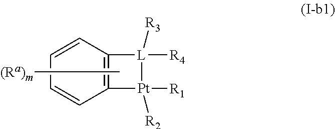

or salts thereof, wherein R₁, R₂, R₃, R₄, R^{a}, L, and m are as defined herein.

In certain embodiments, the platinum complex of Formula (I) is of Formula (I-b2):

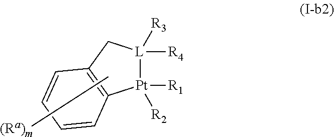

or salts thereof, wherein R₁, R₂, R₃, R₄, R^{a}, L, and m are as defined herein.

In certain embodiments, the platinum complex of Formula (I) is of Formula (I-b3):

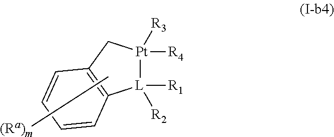

or salts thereof, wherein R₁, R₂, R₃, R₄, R^{a}, L, and m are as defined herein.

In certain embodiments, the platinum complex of Formula (I) is of Formula (I-b4):

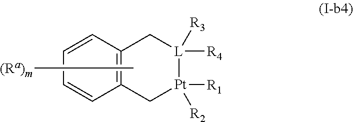

or salts thereof, wherein R₁, R₂, R₃, R₄, R^{a}, L, and m are as defined herein.

In certain embodiments, the platinum complex of Formula (I) is of Formula (I-c):

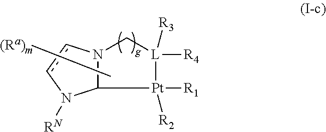

or salts thereof, wherein R₁, R₂, R₃, R₄, g, L, R^{a}, R^{N}, and m are as defined herein, and [symbol] represents a single bond or a double bond. In certain embodiments, [symbol] represents a single bond. In certain embodiments, [symbol] represents a double bond.

In certain embodiments, the platinum complex of Formula (I) is of Formula (I-c1):

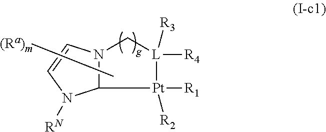

or salts thereof, wherein R₁, R₂, R₃, R₄, g, L, R^{a}, R^{N}, and m are as defined herein.

In certain embodiments, the platinum complex of Formula (I) is of Formula (I-c2):

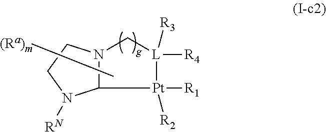

or salts thereof, wherein R₁, R₂, R₃, R₄, g, L, R^{a}, R^{N}, and m are as defined herein.

As generally described above, R^{a} is independently selected from the group consisting of hydrogen, halogen, optionally substituted acyl, —CN, —NO₂, —OR^{O1}, —N(R^{N1})₂, and optionally substituted alkyl; wherein each instance of R^{O1} is independently selected from the group consisting of hydrogen, optionally substituted acyl, optionally substituted alkyl, and an oxygen protecting group; and each instance of R^{N1} is independently selected from the group consisting of hydrogen, optionally substituted acyl, optionally substituted alkyl, and a nitrogen protecting group. In some embodiments, R^{a} is hydrogen. In some embodiments, R^{a} is halogen. In certain embodiments, R^{a} is F. In certain embodiments, R^{a} is Cl. In certain embodiments, R^{a} is Br. In certain embodiments, R^{a} is I. In some embodiments, R^{a} is optionally substituted alkyl. In some embodiments, R^{a} is optionally substituted acyl. In some embodiments, R^{a} is —OR^{O1}, wherein R^{O1} is defined herein. In some embodiments, R^{a} is —N(R^{N1})₂, wherein R^{N1} is defined herein.

As used herein, R^{O1} is independently selected from the group consisting of hydrogen, optionally substituted acyl, optionally substituted alkyl, and an oxygen protecting group. In some embodiments, R^{O1} is hydrogen. In some embodiments, R^{O1} is acyl. In some embodiments, R^{O1} is optionally substituted alkyl. In some embodiments, R^{O1} is an oxygen protecting group.

As used herein, R^{N1} is independently selected from the group consisting of hydrogen, optionally substituted acyl, optionally substituted alkyl, and a nitrogen protecting group. In some embodiments, R^{N1} is hydrogen. In some embodiments, R^{N1} is acyl. In some embodiments, R^{N1} is optionally substituted alkyl. In some embodiments, R^{N1} is a nitrogen protecting group.

As used herein, R^{N} is independently selected from the group consisting of hydrogen, optionally substituted acyl, optionally substituted alkyl, and a nitrogen protecting group. In some embodiments, R^{N1} is hydrogen. In some embodiments, R^{N1} is acyl. In some embodiments, R^{N1} is optionally substituted alkyl. In some embodiments, R^{N1} is a nitrogen protecting group.

As generally described above, R₁ is independently hydrogen, optionally substituted C₁₋₆ alkyl, —Si(R₃)₃, or halogen. In certain embodiments, R₁ is hydrogen. In certain embodiments, R₁ is optionally substituted C₁₋₆ alkyl. In certain embodiments, R₁ is substituted C₁₋₆ alkyl. In certain embodiments, R₁ is unsubstituted C₁₋₆ alkyl. In certain embodiments, R₁ is substituted methyl. In certain embodiments, R₁ is unsubstituted methyl.

In certain embodiments, R₁ is substituted ethyl. In certain embodiments, R₁ is unsubstituted ethyl. In certain embodiments, R₁ is substituted propyl. In certain embodiments, R₁ is unsubstituted propyl. In certain embodiments, R₁ is substituted n-propyl. In certain embodiments, R₁ is unsubstituted n-propyl. In certain embodiments, R₁ is substituted iso-propyl. In certain embodiments, R₁ is unsubstituted iso-propyl. In certain embodiments, R₁ is —Si(R^{b})₃, wherein R^{b} is defined herein. In certain embodiments, R₁ is halogen. In certain embodiments, R₁ is F. In certain embodiments, R₁ is Cl. In certain embodiments, R₁ is Br. In certain embodiments, R₁ is I. In certain embodiments, R₁ is a bridging halogen. In certain embodiments, R₁ is a bridging halogen wherein the bridging halogen is a ligand of another platinum complex of Formula (I). In certain embodiments, R₁ is the bridging fluorine. In certain embodiments, R₁ is the bridging chloride. In certain embodiments, R₁ is the bridging bromide. In certain embodiments, R₁ is the bridging iodide.

As generally described above, R₂ is independently hydrogen, optionally substituted C₁₋₆ alkyl, —Si(R^{b})₃, or halogen. In certain embodiments, R₂ is hydrogen. In certain embodiments, R₂ is optionally substituted C₁₋₆ alkyl. In certain embodiments, R₂ is substituted C₁₋₆ alkyl. In certain embodiments, R₂ is unsubstituted C₁₋₆ alkyl. In certain embodiments, R₂ is substituted methyl. In certain embodiments, R₂ is unsubstituted methyl. In certain embodiments, R₂ is substituted ethyl. In certain embodiments, R₂ is unsubstituted ethyl. In certain embodiments, R₂ is substituted propyl. In certain embodiments, R₂ is unsubstituted propyl. In certain embodiments, R₂ is substituted n-propyl. In certain embodiments, R₂ is unsubstituted n-propyl. In certain embodiments, R₂ is substituted iso-propyl. In certain embodiments, R₂ is unsubstituted iso-propyl. In certain embodiments, R₂ is —Si(R^{b})₃, wherein R^{b} is defined herein. In certain embodiments, R₂ is halogen. In certain embodiments, R₂ is F. In certain embodiments, R₂ is Cl. In certain embodiments, R₂ is Br. In certain embodiments, R₂ is I. In certain embodiments, R₂ is a bridging halogen. In certain embodiments, R₂ is a bridging halogen wherein the bridging halogen is a ligand of another platinum complex of Formula (I). In certain embodiments, R₂ is the bridging fluorine. In certain embodiments, R₂ is the bridging chloride. In certain embodiments, R₂ is the bridging bromide. In certain embodiments, R₂ is the bridging iodie.

As used herein, R^{b} is optionally substituted C₁₋₆ alkyl or —OR^{O1}. In certain embodiments, R^{b} is substituted C₁₋₆ alkyl. In certain embodiments, R^{b} is unsubstituted C₁₋₆ alkyl. In certain embodiments, R^{b} is substituted methyl. In certain embodiments, R^{b} is unsubstituted methyl. In certain embodiments, R^{b} is substituted ethyl. In certain embodiments, R^{b} is unsubstituted ethyl. In certain embodiments, R^{b} is substituted propyl. In certain embodiments, R^{b} is unsubstituted propyl. In certain embodiments, R^{b} is substituted n-propyl. In certain embodiments, R^{b} is unsubstituted n-propyl. In certain embodiments, R^{b} is substituted n-substituted iso-propyl. In certain embodiments, R^{b} is —OR^{O1}, wherein R^{O1} is defined herein. In certain embodiments, R^{b} is substituted methoxy. In certain embodiments, R^{b} is unsubstituted methoxy. In certain embodiments, R^{b} is substituted ethoxy. In certain embodiments, R^{b} is unsubstituted ethoxy. In certain embodiments, R^{b} is substituted propyloxy. In certain embodiments, R^{b} is unsubstituted propyloxy. In certain embodiments, R^{b} is substituted n-propyloxy. In certain embodiments, R^{b} is unsubstituted n-propyloxy. In certain embodiments, R^{b} is substituted 2-propyloxy. In certain embodiments, R^{b} is unsubstituted 2-propyloxy.

As generally described above, R₃ is independently hydrogen, optionally substituted C₁₋₆ alkyl, or halogen. In certain embodiments, R₃ is hydrogen. In certain embodiments, R₃ is optionally substituted C₁₋₆ alkyl. In certain embodiments, R₃ is substituted C₁₋₆ alkyl. In certain embodiments, R₃ is unsubstituted C₁₋₆ alkyl. In certain embodiments, R₃ is substituted methyl. In certain embodiments, R₃ is unsubstituted methyl. In certain embodiments, R₃ is substituted ethyl. In certain embodiments, R₃ is unsubstituted ethyl. In certain embodiments, R₃ is substituted propyl. In certain embodiments, R₃ is unsubstituted propyl. In certain embodiments, R₃ is substituted n-propyl. In certain embodiments, R₃ is unsubstituted n-propyl. In certain embodiments, R₃ is substituted iso-propyl. In certain embodiments, R₃ is unsubstituted iso-propyl. In certain embodiments, R₃ is halogen. In certain embodiments, R₃ is F. In certain embodiments, R₃ is Cl. In certain embodiments, R₃ is Br. In certain embodiments, R₃ is I. In certain embodiments, R₃ is a bridging halogen. In certain embodiments, R₃ is a bridging halogen. In certain embodiments, R₃ is the bridging fluorine. In certain embodiments, R₃ is the bridging chloride. In certain embodiments, R₃ is the bridging bromide. In certain embodiments, R₃ is the bridging iodide.

As generally described above, R₄ is independently hydrogen, optionally substituted C₁₋₆ alkyl, or halogen. In certain embodiments, R₄ is hydrogen. In certain embodiments, R₄ is optionally substituted C₁₋₆ alkyl. In certain embodiments, R₄ is substituted C₁₋₆ alkyl. In certain embodiments, R₄ is unsubstituted C₁₋₆ alkyl. In certain embodiments, R₄ is substituted methyl. In certain embodiments, R₄ is unsubstituted methyl. In certain embodiments, R₄ is substituted ethyl. In certain embodiments, R₄ is unsubstituted ethyl. In certain embodiments, R₄ is substituted propyl. In certain embodiments, R₄ is unsubstituted propyl. In certain embodiments, R₄ is substituted n-propyl. In certain embodiments, R₄ is unsubstituted n-propyl. In certain embodiments, R₄ is substituted iso-propyl. In certain embodiments, R₄ is unsubstituted iso-propyl. In certain embodiments, R₄ is halogen. In certain embodiments, R₄ is F. In certain embodiments, R₄ is Cl. In certain embodiments, R₄ is Br. In certain embodiments, R₄ is I. In certain embodiments, R₄ is a bridging halogen. In certain embodiments, R₄ is a bridging halogen. In certain embodiments, R₄ is the bridging fluorine. In certain embodiments, R₄ is the bridging chloride. In certain embodiments, R₄ is the bridging bromide. In certain embodiments, R₄ is the bridging iodide.

As generally described above, R₅ is independently optionally substituted C₁₋₆ alkyl. In certain embodiments, R₅ is substituted C₁₋₆ alkyl. In certain embodiments, R₅ is unsubstituted C₁₋₆ alkyl. In certain embodiments, R₅ is substituted methyl. In certain embodiments, R₅ is unsubstituted methyl. In certain embodiments, R₅ is substituted ethyl. In certain embodiments, R₅ is unsubstituted ethyl. In certain embodiments, R₅ is substituted propyl. In certain embodiments, R₅ is unsubstituted propyl. In certain embodiments, R₅ is substituted n-propyl. In certain embodiments, R₅ is unsubstituted n-propyl. In certain embodiments, R₅ is substituted iso-propyl. In certain embodiments, R₅ is unsubstituted iso-propyl.

As generally defined above, h is 0, 1, 2, or 3. In some embodiments, h is 0. In some embodiments, h is 1. In some embodiments, h is 2. In some embodiments, h is 3.

As generally defined above, g is 0, 1, 2, or 3. In some embodiments, g is 0. In some embodiments, g is 1. In some embodiments, g is 2. In some embodiments, g is 3.

As generally defined above, m is 0, 1, 2, 3, 4, 5, 6, 7, 8, 9, or 10. In some embodiments, m is 0. In some embodiments, m is 1. In some embodiments, m is 2. In some embodiments, m is 3. In some embodiments, m is 4. In some embodiments, m is 5. In some embodiments, m is 6. In some embodiments, m is 7. In some embodiments, m is 8. In some embodiments, m is 9. In some embodiments, m is 10.

In certain embodiments, the platinum complex is of Formula (II):

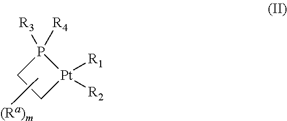

or a salt thereof.

In certain embodiments, the platinum complex is of Formula (II-a):

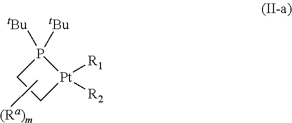

or a salt thereof.

In certain embodiments, the platinum complex is of Formula (II-b):

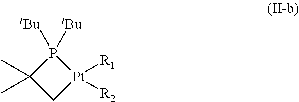

or a salt thereof.

In certain embodiments, the platinum complex is of Formula (II-b1):

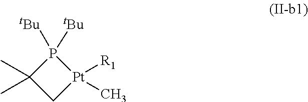

or a salt thereof.

In certain embodiments, the platinum complex is of Formula (II-b2):

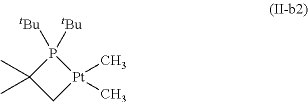

or a salt thereof.

In certain embodiments, the platinum complex is of Formula (II-b3):

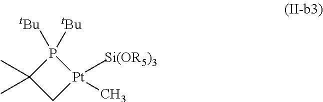

or a salt thereof.

In certain embodiments, the platinum complex is of Formula (II-b3-i):

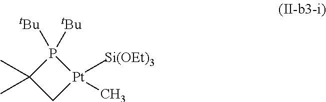

or a salt thereof.

In certain embodiments, the platinum complex of Formula (II) has a four-coordinate, square planer geometry as

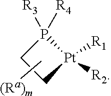

In certain embodiments, the platinum complex is a dimer of Formula (III):

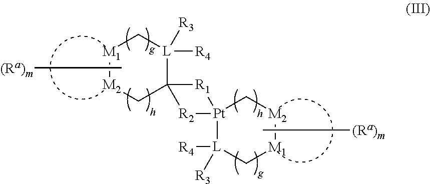

or salts thereof, wherein R₁, R₂, R₃, R₄, L, M₁, M₂, R^{a}, g, h, and m are as defined herein.

In certain embodiments, the platinum complex is of Formula (III-a):

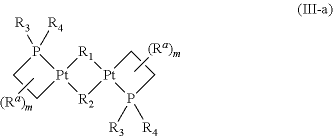

or salts thereof, wherein R₁, R₂, R₃, R₄, R^{a}, and m are as defined herein.

In certain embodiments, the platinum complex is of Formula (III-a1):

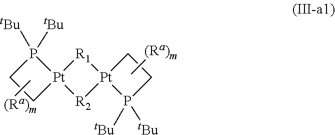

or a salt thereof, wherein R₁, R₂, R^{a}, and m are as defined herein.

In certain embodiments, the platinum complex is of Formula (III-a2):

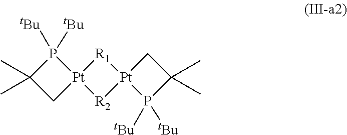

or a salt thereof, wherein R₁ and R₂ are as defined herein.

In certain embodiments, the platinum complex is of Formula (III-a2-i):

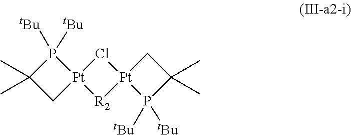

or a salt thereof, wherein R₂ is as defined herein.

In certain embodiments, the platinum complex is of Formula (III-a2-ii):

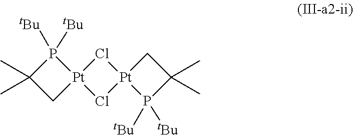

or a salt thereof.

In certain embodiments, the platinum complex is of Formula (III-a2-iii):

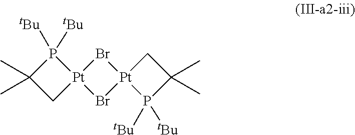

or a salt thereof.

In certain embodiments, the platinum complex is of the formula:

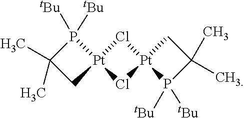

In certain embodiments, the platinum complex of Formula (I) is a salt. In certain embodiments, the platinum complex of Formula (I) is a salt with the counterion Z^{⊕}. In certain embodiments, the platinum complex of Formula (II) is a salt of Formula (IV):

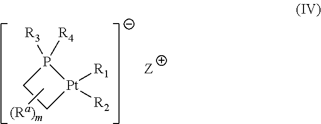

wherein Z^{⊕} is a counterion.

The counterion Z may be an organic cation or an inorganic cation, optionally with other ligands as valence permits. In one embodiment, the counterion Z is an inorganic cation. Non-limiting examples of inorganic cations include alkali metal cations, alkaline earth metal cations, transition metal cations, and inorganic ammonium cations (NH₄⁺). In another embodiment, the counterion Z is an organic cation, for example, an organic ammonium cation, an organic phosphonium cation, an organic sulfonium cation, or a mixture thereof. In certain embodiments, Z is an alkali metal cation. In certain embodiments, Z is Li. In certain embodiments, Z is Na. In certain embodiments, Z is K. In certain embodiments, Z is an alkaline earth metal cation. In certain embodiments, Z is an alkaline earth metal cation with one halogen. In certain embodiments, Z is MgCl. In certain embodiments, Z is MgBr. In certain embodiments, Z is MgI. In certain embodiments, Z is a transition metal cation. In certain embodiments, Z is ZnCl. In certain embodiments, Z is ZnBr. In certain embodiments, Z is Ag. In certain embodiments, Z is CuCl. In certain embodiments, Z is FeCl. In certain embodiments, Z is NH₄.

In certain embodiments, the platinum complex is of Formula (IV-a):

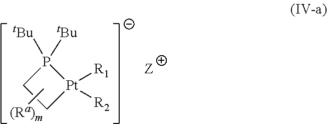

wherein R₁, R₂, R^{a}, m, and Z are as defined herein.

In certain embodiments, the platinum complex is of Formula (IV-b):

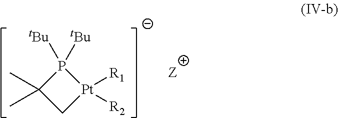

wherein R₁, R₂, and Z are as defined herein.

In certain embodiments, the platinum complex is of Formula (IV-b1):

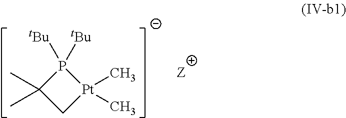

wherein Z is as defined herein.

In certain embodiments, the platinum complex is of the formula:

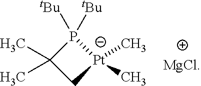

In certain embodiments, the platinum complex is of the formula:

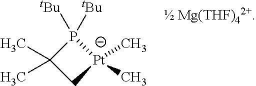

In certain embodiments, the platinum complex is of Formula (IV-b2):

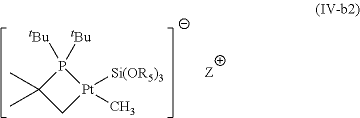

wherein Z is as defined herein, and R₅ is optionally substituted C₁₋₆ alkyl.

In certain embodiments, the platinum complex is of the formula:

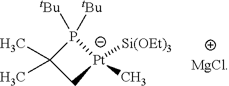

In certain embodiments, the platinum complex is of the formula:

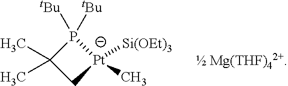

In certain embodiments, the platinum complex is of the formula:

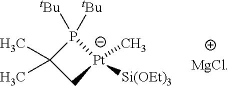

In certain embodiments, the platinum complex is of the formula:

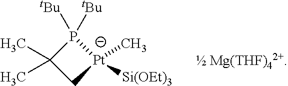

### Synthetic Methods

The platinum complexes described herein can be prepared by the following exemplary procedure. For example, a platinum-phosphine complex of Formula (III-a) can be prepared by:

(A) providing a solution of (PhCN)₂PtCl₂ in a first organic solvent;

(B) adding a base to the solution of step (A) to form a mixture; and

(C) adding a solution of P(tBu)₃ in a second organic solvent to the mixture of step (B).

In certain embodiments, the first organic solvent and the second organic solvent are the same. In certain embodiments, the first organic solvent and the second organic solvent are different. In some embodiments, the first organic solvent and/or the second organic solvent is a polar aprotic solvent (e.g., methylene chloride, dichloroethane, or tetrahydrofuran). In some embodiments, the first organic solvent and/or the second organic solvent is a nonpolar solvent (e.g., benzene). Exemplary organic solvents include, but are not limited to, benzene, toluene, xylene, acetonitrile, acetone, ethyl acetate, ethyl ether, tetrahydrofuran, methylene chloride, dichloroethane, and chloroform, or a mixture thereof. In certain embodiments, the first and second organic solvents are acetonitrile. In certain embodiments, the first and second organic solvents are benzonitrile. In certain embodiments, the first and second organic solvents are methylene chloride. In certain embodiments, the first and second organic solvents are tetrahydrofuran. In certain embodiments, the first and second organic solvents are diethyl ether. In certain embodiments, the first and second organic solvents are benzene, toluene, or a xylene. In certain embodiments, the first and second organic solvents are pentane, hexane, heptane, or petroleum ether.

The base used in step (B) can be any organic base. Exemplary organic bases include, but are not limited to, tri-C₁₋₆-alkylamines such as trimethylamine, triethylamine, tributylamine, diisopropylethylamine, tert-butyldimethylamine, N—C₃₋₆-cycloalkyl-N,N-di-C₁₋₆-alkylamines or N,N-bis-C₃₋₆-cycloalkyl-N—C₁₋₆-alkylamines such as ethyldicyclohexylamine, cyclic tertiary amines including N—C₁₋₆-alkyl-nitrogen heterocycles such as N-methylpyrrolidine, N-methylpiperidine, N-methylmorpholine, N,N′-dimethylpiperazine, pyridine compounds such as pyridine, collidine, lutidine or 4-dimethylaminopyridine, and bicyclic amines, such as diazabicycloundecene (DBU) or diazabicyclononene (DBN). In certain embodiments, the base in step (B) is collidine.

The synthetic process can be carried out at room temperature. In certain embodiments, the synthetic method is carried out at a temperature from about 20° C. to about 25° C.

The amount of (PhCN)₂PtCl₂ and P(tBu)₃ in the process of preparation is stoichiometric. The reaction can be carried out under the protection of inert atmosphere. In certain embodiments, the reaction is carried out under nitrogen (N₂). In certain embodiments, the reaction is carried out under argon.

In certain embodiments, the platinum complex from step (C) is further treated with a reductant. In certain embodiments, the reductant is a Grignard reagent (e.g. an alkyl magnesium halide (e.g., MeMgCl, EtMgCl, or MeMgBr) or aryl magnesium halide (e.g., PhMgCl or PhMgBr). Treatment with the Grignard reagent activates the platinum complex. The activation step is carried out at about −78° C., about −60° C., about −45° C., about −40° C., about −20° C., about 0° C., or about 23° C. In certain embodiments, The activation step is carried out at about −45° C. In certain embodiments, the activation step is carried out at about −40° C. After Grignard reagent is added to the platinum complex from step (C), the resulting solution can be shaken for a few seconds at room temperature to reach homogeneous. The solution can be further cooled to about −45° C. for the activation to go to completion. The formed active platinum complex can be isolated or used in situ.

In certain embodiments, the isolated active platinum complex is in the form of a salt. In certain embodiments, the active platinum complex is of Formula (IV):

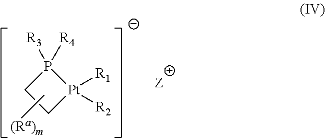

wherein R₁, R₂, R₃, R₄, R^{a}, m, and Z are as defined herein.

In certain embodiments, the active platinum complex is of Formula (IV-a):

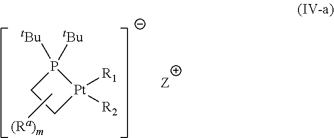

wherein R₁, R₂, R^{a}, m, and Z are as defined herein.

In certain embodiments, the isolated active platinum complex is of Formula (IV-b):

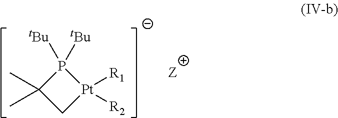

wherein R₁, R₂, and Z are as defined herein.

In certain embodiments, the isolated active platinum complex is of Formula (IV-b1):

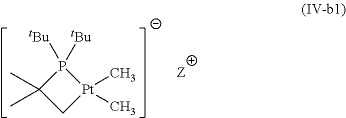

wherein Z is as defined herein.

In certain embodiments, the isolated active platinum complex is of Formula (IV-b2):

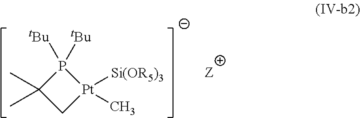

wherein R₅ and Z are as defined herein.

### Compositions, Methods of Use, and Kits

The present invention provides hydrosilylation catalyst compositions comprising one or more platinum complexes described herein, e.g., one or more platinum complexes of Formula (I)-(IV), or salts thereof, and an organic solvent. Exemplary organic solvents include, but are not limited to, pentane, hexane, heptane, benzene, toluene, xylenes, acetonitrile, benzonitrile, acetone, ethyl acetate, ethyl ether, tetrahydrofuran, methylene chloride, dichloroethane, chloroform, or a mixture thereof (e.g., petroleum ether). In certain embodiments, the organic solvent is dichloromethane. In certain embodiments, the organic solvent is diethyl ether. In certain embodiments, the organic solvent is benzonitrile. In certain embodiments, the organic solvent is benzene or toluene. In certain embodiments, the platinum complexes described herein, or salts thereof, are provided in a catalytic amount.

In some embodiments, provided platinum complexes or salts thereof are useful in selectively catalyzing the 1,2-hydrosilylation of 1,3-dienes. In some embodiments, provided platinum complexes or salts thereof are useful in increasing the ratio of 1,2-versus 1,4-hydrosilylation of 1,3-dienes. In some embodiments, the platinum complexes described herein provide 1,2-versus 1,4-hydrosilylation of 1,3-dienes in a ratio of about 1:1 to about 100:1. In some embodiments, the platinum complexes described herein provide 1,2-versus 1,4-hydrosilylation of 1,3-dienes in a ratio of about 3:1. In some embodiments, the platinum complexes described herein provide 1,2-versus 1,4-hydrosilylation of 1,3-dienes in a ratio of about 6:1. In some embodiments, the platinum complexes described herein provide 1,2-versus 1,4-hydrosilylation of 1,3-dienes in a ratio of about 9:1. In some embodiments, the platinum complexes described herein provide 1,2-versus 1,4-hydrosilylation of 1,3-dienes in a ratio of about 10:1. In some embodiments, the platinum complexes described herein provide 1,2-versus 1,4-hydrosilylation of 1,3-dienes in a ratio of about 20:1. In some embodiments, the platinum complexes described herein provide 1,2-versus 1,4-hydrosilylation of 1,3-dienes in a ratio of about 30:1. In some embodiments, the platinum complexes described herein provide 1,2-versus 1,4-hydrosilylation of 1,3-dienes in a ratio of about 40:1. In some embodiments, the platinum complexes described herein provide 1,2-versus 1,4-hydrosilylation of 1,3-dienes in a ratio of about 50:1. In some embodiments, the platinum complexes described herein provide 1,2-versus 1,4-hydrosilylation of 1,3-dienes in a ratio of about 60:1. In some embodiments, the platinum complexes described herein provide 1,2-versus 1,4-hydrosilylation of 1,3-dienes in a ratio of about 70:1. In some embodiments, the platinum complexes described herein provide 1,2-versus 1,4-hydrosilylation of 1,3-dienes in a ratio of about 80:1. In some embodiments, the platinum complexes described herein provide 1,2-versus 1,4-hydrosilylation of 1,3-dienes in a ratio of about 90:1. In some embodiments, the platinum complexes described herein provide 1,2-versus 1,4-hydrosilylation of 1,3-dienes in a ratio of about 100:1.

The 1,3-dienes suitable for the selective 1,2-hydrosilylation catalyzed by the platinum complexes described herein can be any molecules having two carbon-carbon double bonds separated by a single bond. In certain embodiments, the 1,3-diene is a 2-substituted diene. In some embodiments, the 1,3-diene is isoprene. In some embodiments, the 1,3-diene is myrcene. In certain embodiments, the 1,3-diene is 1-substituted dienes such as butadiene, and cis- and trans-1,3-pentadiene. In certain embodiments, the 1,3-diene is a 1,1-disubstituted diene such as 4-methyl-1,3-pentadiene. In certain embodiments, the 1,3-diene is a cyclic dienes such as 1,3-cyclohexadiene. In certain embodiments, the 1,3-diene is a 2,3-disubstituted diene such as 2,3-dimethylbutadiene. Exemplary 1,3-dienes are of the formulae:

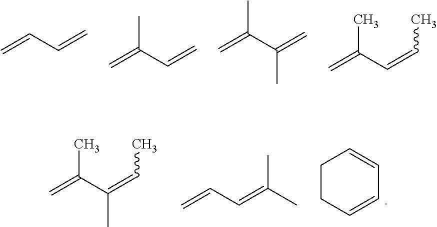

The present invention provides methods for the hydrosilylation of 1,3-dienes. In certain embodiments, the present invention provides methods for the selective 1,2-hydrosilylation of 1,3-dienes. The inventive method of selective hydrosilylation of a 1,3-diene comprises the steps of:

(A) providing one or more platinum complexes, or salts thereof, of Formula (I), (II), (III), or (IV); and

(B) contacting the platinum complexes, or salts thereof, with a 1,3-diene and a hydrosilane under suitable conditions to hydrosilylate the 1,3-diene.

In certain embodiments, the platinum complexes described herein, or salts thereof, are present in the amount of about 0.01 mol % to about 10 mol % relative to the 1,3-diene. In certain embodiments, the platinum complexes described herein, or salts thereof, are present in the amount of about 0.01 mol % to about 5 mol % relative to the 1,3-diene. In certain embodiments, the platinum complexes described herein, or salts thereof, are present in the amount of about 0.01 mol % to about 1 mol % relative to the 1,3-diene. In certain embodiments, the platinum complexes described herein, or salts thereof, are present in the amount of about 0.01 mol % to about 0.5 mol % relative to the 1,3-diene. In certain embodiments, the platinum complexes described herein, or salts thereof, are present in the amount of about 0.01 mol % to about 0.4 mol % relative to the 1,3-diene. In certain embodiments, the platinum complexes described herein, or salts thereof, are present in the amount of about 0.05 mol % to about 0.4 mol % relative to the 1,3-diene. In certain embodiments, the platinum complexes described herein, or salts thereof, are present in the amount of about 0.1 mol % to about 0.4 mol % relative to the 1,3-diene. In certain embodiments, the platinum complexes described herein, or salts thereof, are present in the amount of about 0.2 mol % to about 0.3 mol % relative to the 1,3-diene. In certain embodiments, the platinum complexes described herein, or salts thereof, are present in the amount of about 0.25 mol % relative to the 1,3-diene.

In certain embodiments, the platinum complexes, or salts thereof, are pre-catalysts that would undergo further activation before contacting the diene. In certain embodiments, activation of the platinum complexes is carried out in the presence of a Grignard reagent. In certain embodiments, the Grignard reagent is (unsubstituted C₁₋₆ alkyl)MgX, wherein X is Cl, Br, or I. In certain embodiments, the Grignard reagent is MeMgCl. In certain embodiments, the Grignard reagent is EtMgCl. In certain embodiments, the Grignard reagent is MeMgBr. In certain embodiments, the Grignard reagent is PhMgCl, PhMgBr, or PhMgI. In certain embodiments, activation of the platinum complexes is carried out in the presence of an alkyl lithium. In certain embodiments, the alkyl lithium is methyl lithium. In certain embodiments, the alkyl lithium is ethyl lithium. In certain embodiments, the alkyl lithium is n-propyl lithium. In certain embodiments, the alkyl lithium is n-butyl lithium. In certain embodiments, the alkyl lithium is s-butyl lithium. In certain embodiments, the alkyl lithium is t-butyl lithium. In certain embodiments, activation of the platinum complexes is carried out in the presence of an alkyl potassium. In certain embodiments, the alkyl potassium is benzylpotassium. In certain embodiments, activation of the platinum complexes is carried out in the presence of an alkyl zinc. In certain embodiments, the alkyl zinc is diethylzinc.

In certain embodiments, the activation reaction is carried out at a temperature from about −50° C. to about 100° C. In certain embodiments, the activation reaction is carried out at a variable temperature (e.g., from about −45° C. to about 23° C., or from about −40° C. to about 23° C., or from about −45° C. to about 50° C., or from about −40° C. to about 50° C., or from about −45° C. to about 75° C., or from about −40° C. to about 75° C., over 1 hour, 2 hours, 3 hours, 6 hours, or 12 hours). The temperature of the activation reaction is dependent on the activating reagent and the solvent used. In certain embodiments, the activation reaction is carried out at a temperature of about −45° C. with a Grignard reagent in methylene chloride. In certain embodiments, the activation reaction is carried out at a temperature of about −35° C. with MeLi in toluene. In certain embodiments, the activation reaction is carried out at a temperature of about 50° C. with BnK in benzene.

The length of the activation reaction can be from about 1 hour to 15 hours. In certain embodiments, the activation reaction lasts 3 hours with a Grignard reagent in methylene chloride at about −45° C. In certain embodiments, the activation reaction lasts 12 hours with MeLi in toluene at about −35° C. In certain embodiments, the activation reaction lasts about 12 hours with BnK in benzene at about 50° C.

The resulting active platinum complexes, or salts thereof, can be isolated or used in situ. In some embodiments, the active platinum complexes or salts thereof are isolated. The active platinum complexes can be isolated by filteration of the reaction mixture. In some embodiments, impurities of the isolated platinum complexes can be removed by trituration with hydrocarbon solvents such as pentane and hexane. In some embodiments, impurities of the isolated platinum complexes can be removed by recrystallization. In some embodiments, the recrystallization to remove the impurities is carried out with benzene/hexane. In some embodiments, the recrystallization to remove the impurities is carried out with methylene chloride/pentane. In some embodiments, the recrystallization to remove the impurities is carried out with THF/hexane.

In some embodiments, the active platinum complexes or salts thereof are used in situ. When used in in situ, one or more of the platinum complexes, or salts thereof, are contacted with a 1,3-diene and an organosilane for hydrosilylation. In some embodiments, the temperature for mixing the active platinum complexes, 1,3-diene, and an organosilane is carried out below the boiling point of the 1,3-diene. In some embodiments, the 1,3-diene and the organosilane are contacted with the active platinum complexes, or salts thereof, at a temperature from about −50° C. to about −5° C. The subsequent hydrosilylation reaction is carried out by warming up the reaction mixture to a temperature of about 20° C. to 100° C. In certain embodiments, the hydrosilylation reaction is carried out at about 20° C. to about 25° C. In certain embodiments, the hydrosilylation reaction is carried out at about 40° C. In certain embodiments, the hydrosilylation reaction is carried out at about 50° C. In certain embodiments, the hydrosilylation reaction is carried out at about 60° C. In certain embodiments, the hydrosilylation reaction is carried out at about 70° C. In certain embodiments, the hydrosilylation reaction is carried out at about 80° C. In certain embodiments, the hydrosilylation reaction is carried out at about 90° C. In certain embodiments, the hydrosilylation reaction is carried out at about 100° C.

In certain embodiments, activation of platinum complexes can be carried out in any aprotic organic solvent. In certain embodiments, the aprotic organic solvent is not reactive with a Grignard reagent. In certain embodiments, the aprotic organic solvent is not reactive with an alkyl lithium. In certain embodiments, the aprotic organic solvent is not reactive with an alkyl potassium. In certain embodiments, the aprotic organic solvent is not reactive with an alkyl zinc. Exemplary aprotic organic solvents include, but are not limited to, benzene, toluene, xylenes, acetonitrile, tetrahydrofuran, methylene chloride, dichloroethane, and chloroform, and mixtures thereof. In certain embodiments, the hydrosilylation reaction can be conducted without any solvent.

In certain embodiments, the hydrosilane is H—Si(O-unsubstituted C₁₋₆ alkyl)₃ (e.g., triethoxysilane). In certain embodiments, the hydrosilane is H—Si(unsubstituted C₁₋₆ alkyl)₃ (e.g., triethylsilane). In certain embodiments, the hydrosilane is H—Si(Ph)(unsubstituted C₁₋₆ alkyl)₂ (e.g., dimethylphenylsilane). In certain embodiments, the hydrosilane is trihalosilane (e.g., trichlorosilane).

In certain embodiments, the hydrosilylation reaction can be carried out in any aprotic organic solvent. In certain embodiments, The hydrosilylation reaction solvent is the same as the solvent used in the activation reaction of the platinum complexes. In certain embodiments, the hydrosilylation reaction solvent is different from the solvent used in the activation reaction of the platinum complexes. In certain embodiments, the hydrosilylation reaction is carried out in the absence of any solvent. In certain embodiments, the hydrosilylation reaction is carried out in the absence of any solvent and the activation reaction is carried out in the presence of a solvent.

In certain embodiments, the hydrosilylation reaction is carried out under inert conditions. In certain embodiments, the hydrosilylation reaction is carried out under N₂. In certain embodiments, the hydrosilylation reaction is carried out under Argon.

Without wishing to be bound by any particular theory, hydrosilylation using a platinum complex described herein as a catalyst or pre-catalyst may create coordinative saturation at the platinum complex following 1,2-migratory insertion and prevents n-allyl formation during the catalytic cycle, which may lead to 1,2-selectivity. A platinum complex described herein may exclude formation of π-allyl intermediates upon migratory insertion of 1,3-dienes and may result in catalyst (e.g., the platinum complex)-controlled 1,2-selective addition (see σ-alkyl intermediate in Scheme 4). Because π-allyl ligands require two coordination sites while σ-alkyls require only one, exclusion of π-allyl intermediates can be enforced by coordinative saturation at the catalyst.

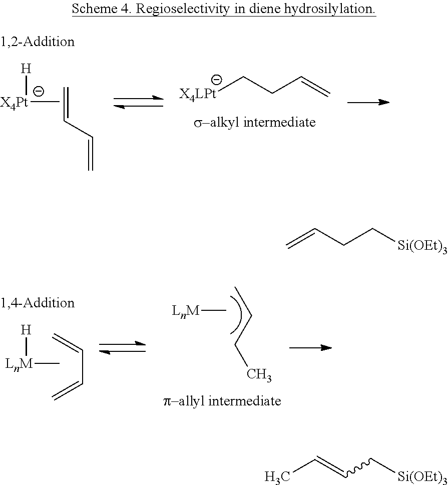

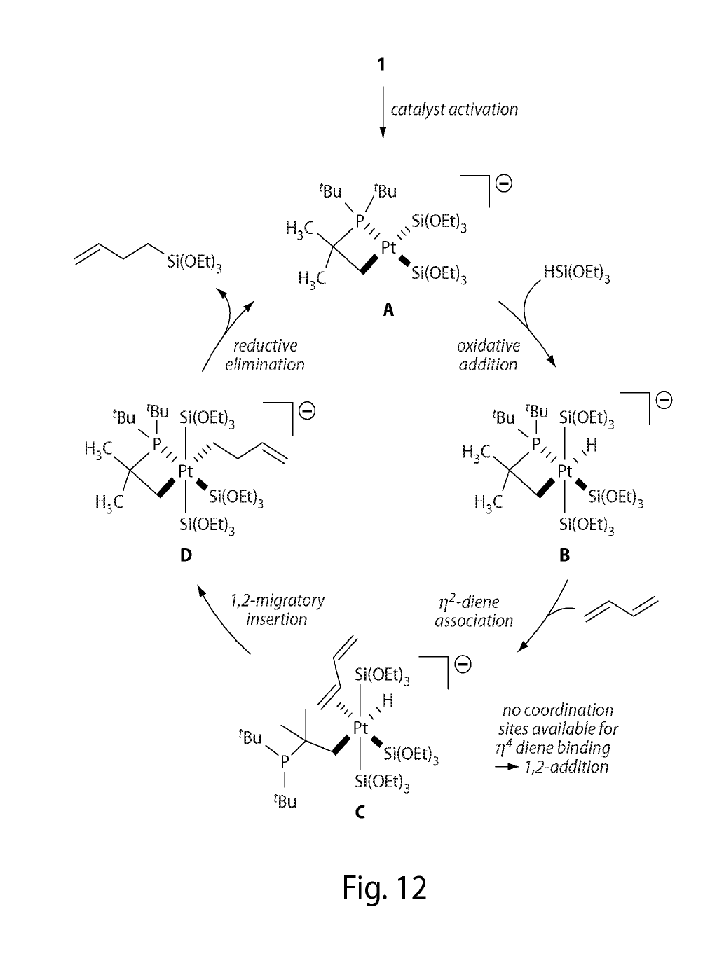

Without wishing to be bound by any particular theory, a Pt(II/IV) catalytic cycle was proposed to rationalize the selectivity for 1,2-addition (FIG. 12).¹⁰ Catalyst activation provides an electron-rich anionic Pt(II) complex (A) that can undergo oxidative addition of triethoxysilane to form coordinatively saturated Pt(IV) intermediate B. Because B is coordinatively saturated, a ligand must dissociate prior to diene coordination (C). Importantly, because the phosphine contained in the bidentate ligand is the only ligand which can readily dissociate from B, the incoming diene is restricted to η²-coordination. 1,2-Migratory insertion to form linear alkyl complex D is followed by reductive elimination, which releases the desired 1,2-hydrosilylation product and regenerates A. This proposed mechanism is different from a Pt(0/II) mechanism, which is typical for conventional platinum-catalyzed hydrosilylation.¹¹

Another aspect of the present invention relates to methods of preparing a polymer, the method comprising the steps of:

(A) providing one or more platinum complexes, or salts thereof, of Formula (I), (II), (III), or (IV);

(B) contacting the platinum complexes, or salts thereof, with a 1,3-diene and a hydrosilane under suitable conditions to hydrosilylate the 1,3-diene to provide a (3-alken-1-yl)silane; and

(C) polymerizing the (3-alken-1-yl)silane to provide a polymer.

In certain embodiments, the polymer prepared by an inventive method is a poly(organosiloxane). In certain embodiments, the polymer prepared by an inventive method is a substituted polyethylene.

The platinum complexes described herein, or salts thereof, or compositions thereof, may be provided in a kit. The kit includes one or more platinum complexes useful in a method described herein provided in a container. In certain embodiments, the kit contains informational material. The informational material can be descriptive, instructional, marketing, or other material that relates to the methods described herein and/or the use of the complex in the methods described herein. In some embodiments, the platinum complexes are bound to a solid support.

The informational material of the kits is not limited in its form or content. In one embodiment, the informational material includes information about production of the platinum complex, molecular weight of the platinum complex, concentration, date of expiration, batch or production site information, and so forth. In one embodiment, the informational material includes a description of methods of using the platinum complex.

In one embodiment, the informational material includes instructions to use the platinum complex described herein in a suitable manner to perform the methods described herein, e.g., in a suitable amount, form, or mode of application. In another embodiment, the informational material can include instructions to use a platinum complex described herein with a suitable substrate, e.g., a 1,3-diene.

In addition to a compound described herein, the composition of the kit can include other ingredients, such as a Grignard reagent, or a solvent. In certain embodiments, the kit can include instructions for admixing a platinum complex, or a salt described herein and the other ingredients, or for using a platinum complex, or a salt, described herein together with the other ingredients.

In some embodiments, the components of the kit are stored under inert conditions (e.g., under nitrogen or another inert gas such as argon). In some embodiments, the components of the kit are stored under anhydrous conditions (e.g., with a desiccant). In some embodiments, the components are stored in a light blocking container such as an amber vial.

The platinum complexes, or salts thereof, or compositions thereof described herein can be provided in any form, e.g., liquid, dried, or lyophilized form. In some embodiments, the platinum complexes are substantially pure. When platinum complexes or salts described herein are provided in a liquid solution, the liquid solution can be an organic solvent. When platinum complexes described herein are provided as a dried form, reconstitution generally is by the addition of a suitable organic solvent. The solvent can optionally be provided in the kit.

The kit can include one or more containers for the composition containing a platinum complex or salts described herein. In some embodiments, the kit contains separate containers, dividers or compartments for the composition and informational material. For example, the composition can be contained in a bottle, vial, or syringe, and the informational material can be contained in a plastic sleeve or packet. In other embodiments, the separate elements of the kit are contained within a single, undivided container. The containers of the kits can be air tight, waterproof (e.g., impermeable to changes in moisture or evaporation), and/or light-tight.

### EXAMPLES

In order that the invention described herein may be more fully understood, the following examples are set forth. It should be understood that these examples are for illustrative purposes only and are not to be construed as limiting the invention in any manner.

All reactions were carried out under an inert atmosphere (nitrogen) using standard techniques for manipulating air-sensitive compounds unless otherwise stated (Shriver et al., Inert-Atmosphere Glove Boxes. The Manipulation of Air-Sensitive Compounds, 2nd ed.; John Wiley & Sons: New York, 1986; pp. 45-67). All glassware was stored in an oven or was flame-dried prior to use under an inert atmosphere of nitrogen or argon as stated. Anhydrous solvents were obtained either by filtration through drying columns (CH₂Cl₂, pentane, toluene, ether) on an mBraun system or by distillation over sodium/benzophenone (THF, benzene, Dioxane) or CaH₂ (DCE) (Pangborn et al., J. Organometallics, 1996, 15, 1518-1520). Purified compounds were further dried under high vacuum (0.01-0.05 Torr). Yields refer to purified and spectroscopically pure compounds unless otherwise stated. Analytical thin-layer chromatography (TLC) was performed on EMD TLC plates pre-coated with 250 μm thickness silica gel 60 F254 plates visualized by fluorescence quenching under UV light and stained using potassium permanganate stain. Flash chromatography was performed on Silicycle silica gel 60 (40-63 μm) using a forced flow of eluent at 0.3-0.5 bar pressure (Still et al., J. Org. Chem. 1978, 43, 2923-2925). Yields refer to purified and spectroscopically pure compounds. ¹H NMR spectra were recorded on a Varian Unity/Inova 600 spectrometer operating at 600 MHz for ¹H acquisitions, a Varian Unity/Inova 500 spectrometer operating at 500 MHz for ¹H acquisitions or at 125 MHz for ¹³C acquisitions, a Varian Unity/Inova 400 spectrometer operating at 400 MHz for ¹H acquisitions, or a Varian Mercury 400 spectrometer operating at 400 HMz, 375 MHz, and 162 MHz for ¹H, ¹⁹F, and ³¹P acquisitions, respectively. Chemical shifts for H and ¹³C acquisitions are reported in parts per million from tetramethylsilane with the solvent resonance as the internal standard (¹H: CDCl₃, δ 7.26; (CD₃)₂SO, δ 2.50; CD₃CN, δ 1.94; (CD₃)₂CO, δ 2.05), (¹³C: CDCl₃, δ77.16; CD₃CN, δ 1.32, (CD₃)₂SO, δ 39.52; (CD₃)₂CO, δ 29.84, 206.26) (Fulmer, G. R.; Miller, A. J. M.; Sherden, N. H.; Gottlieb, H. E.; Nudelman, A.; Stoltz, B. M.; Bercaw, J. E.; Goldberg, K. I. Organometallics 2010, 29, 2176-2179). Chemical shifts for ³¹P acquisitions are reported in parts per million from 85% H₃PO₄ in H₂O as an external standard (³¹P: CDCl₃, δ 0). Chemical shifts for ¹⁹F acquisitions are reported in ppm with CFCl₃ as the external standard (¹⁹F: CDCl₃). Data are reported as follows: chemical shift, multiplicity (s=singlet, d=doublet, t=triplet, q=quartet, m=multiplet and br=broad), coupling constant in Hz, and integration. All deuterated solvents were purchased from Cambridge Isotope Laboratories, dried over 4 Å molecular sieves (MS), and degassed by the freeze-pump-thaw method prior to use. High-resolution mass spectra were obtained at the Harvard University Mass Spectrometry Facilities. High-resolution mass spectra were obtained on a Bruker Maxis Impact q-TOF. Low-resolution mass spectra were obtained on a Shimadzu GCMS-QP2010S equipped with an SHRXI-5MS column (30 m x 0.25 mm i.d. x 0.25 μm film thickness) operated under the following heating program: initial temperature 50° C. followed by a ramp of 20° C./min to a final temperature of 250° C. which was held for 5 min. GC analysis was performed on an Agilent 7890A GC equipped with an HP-5 cross-linked methyl silicone column (30 m×0.32 mm i.d.×0.25 μm film thickness) operating under the following heating programs. Program 1: initial temperature of 50° C. followed by a ramp of 20° C./min to a final temperature of 250° C. and held for 5 min. Program 2: initial temperature of 50° C. followed by a ramp of 2.5° C./min to 85° C. followed by a ramp of 20° C./min to a final temperature of 250° C. Retention times are reported in minutes followed by the integration. The butenylsilanes described herein were purified by bulb-to-bulb distillation using a Biichi B-585 Kugelrohr. Reagents: Butadiene, myrcene, norbornadiene, isoprene, triethoxysilane, methylmagnesium chloride, P(^{t}Bu)₃, PNp(^{t}Bu)₂, but-3-en-1-ol, triethylamine, TMS₂O, and thionyl chloride were purchased from SigmaAdrich. K₂PtCl₄, PtCl₂, and AgOTf were purchased from Strem. Butadiene and isoprene were dried with dibutylmagnesium and distilled by vacuum transfer prior to use. Myrcene and norbornadiene were distilled, dried over 4 Å MS, and degassed by the freeze-pump-thaw method prior to use. Triethoxysilane was distilled and degassed by the freeze-pump-thaw method prior to use. Triethylamine was dried over CaH₂, distilled, and degassed by sparging with argon prior to use. Bis-benzonitrileplatinum(II) chloride was synthesized as a mixture of cis- and trans-isomers from PtCl₂ or K₂PtCl₄ as described in the literature (Braunstein et al., J. Inorg. Synth. 1989, 26, 341-50; Kiyooka et al., Tetrahedron, 2010, 66, 1806-1816). 4-Chlorobut-1-ene (Schmidt, T.; Kirschning, A. Ang. Chem. Int. Ed. 2012, 51, 1063-1066), 3-butenylmagnesium chloride in THF (Trust, R. I.; Ireland, R. E. Org. Syn. 1973, 53, 116-120), and MgCl₂(THF)₂ (Sivaram, S.; Satyanarayana, G. Indian, IN 186303 A 1, 2001) were prepared according to previously reported methods. Other reagents were purchased from Aldrich, Strem, or Alfa Aesar and used as received unless otherwise noted. Butadiene was dried over dibutylmagnesium, vacuum transferred, and degassed by the freeze-pump-thaw method prior to use (Armarego et al., Purification of Laboratory Chemicals, 5th ed.; Butterworth Henemann: Amsterdam, 2003; pp. 29-30). Other dienes and triethoxysilane were purified by distillation and degassed by the freeze-pump-thaw method prior to use. Safety note regarding triethoxysilane: Triethoxysilane has been reported to form flammable gases upon exposure to hydrosilylation catalysts (Berk et al., J. Org. Chem. 1992, 57, 37513753; U.S. Pat. No. 5,220,020, 1993; Buchwald, S. L., Chem. Eng. News, 1993, 71, 2). A recommended substitute for triethoxysilane is diethoxymethylsilane.

### [PtCl(CH₂CMe₂PtBu₂-C,P)]₂ (1)

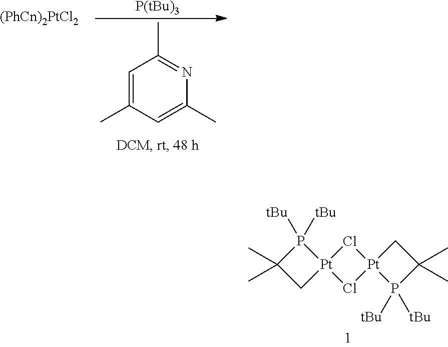

In an N₂-filled glovebox (PhCN)₂PtCl₂ (197.6 mg, 0.418 mmol, 1.0 equiv.) was charged in a 20 mL scintillation vial with a TEFLON-coated magnetic stir bar and suspended in 5.0 mL of dichloromethane (Clark et al., Preparation and characterization of platinum(II) complexes Pt(P—C)LX. Inorg. Chem. 1980, 19, p 3220-5). Collidine was added to the reaction vial (55 μL, 0.418 mmol, 1.0 equiv.). P(tBu)₃ (88.5 mg, 0.437 mmol, 1.05 equiv.) and 2.0 mL of dichloromethane were added to a second vial, forming a clear, colorless solution. The P(tBu)₃ solution was added to the suspension of (PhCN)₂PtCl₂ over approximately 2 minutes. After approximately half the phosphine solution was, the reaction became yellow and homogeneous. The phosphine-containing vial was rinsed with 2×2.0 mL dichloromethane and these portions were added to the reaction vessel. The yellow solution was stirred for 48 hours at room temperature. During this time the color of the reaction changed from yellow to a darker orange/red, then back to yellow. The reaction vial was removed from the glovebox and the solution was concentrated under vacuum to yield a yellow residue. The residue was taken up in 10.0 mL 95% EtOH and stirred for 30 minutes, during which time the product (1) precipitated as a white solid. The solid was collected by centrifugation and triturated with 2×10.0 mL EtOH and 2×10.0 mL Hexanes. The product was isolated as a mixture of head-to-head and head-to-tail isomers and used as without further purification (125.2 mg, 0.145 mmol, 34.6% yield). NMR Characterization: 1H NMR (399 MHz, Benzene) 6 ppm 1.15 (d, ³J_{P-H}=14.27 Hz, 4H) 1.21 (d, ³J_{P-H}=14.27 Hz, 6H) 1.32 (d, ³J_{P-H}=13.54 Hz, 27H) 1.57 (d, ³J_{P-H}=7.32 Hz, 1H) 1.64 (d, ³J_{P-H}=6.95 Hz, 1H). ³¹P NMR (162 MHz, Benzene) δ ppm −15.53 (s, ³J_{Pt-P=}3773 Hz), −15.0 (s, ³J_{Pt-P}=3773 Hz).

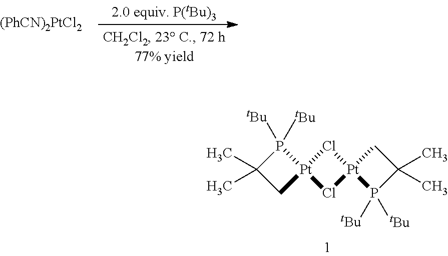

In another set of experiments performed according to a reported method (Clark, H. C.; Goel, A. B.; Goel, R. G.; Goel, S. Inorg. Chem. 1980, 19, 3220-3225), Pt(PhCN)₂Cl₂ (1.18 g, 2.49 mmol, 1.00 equiv.), a TEFLON-coated magnetic stirring bar, and dichloromethane (2.5 mL) were added to a 20 mL scintillation vial at 23° C. in a dry, N₂-filled glovebox. While stirring, a solution of P(^{t}Bu)₃ (1.01 g, 4.98 mmol, 2.00 equiv.) in dichloromethane (3.0 mL) was added dropwise. Dichloromethane (3×1.5 mL) was used to rinse the vial that had contained the phosphine solution and the rinseate was added to the reaction mixture. After 30 min., the solids had dissolved to form a clear red solution that faded to pale yellow after 72 hours at 23° C. The solution was concentrated by rotary evaporation to 25% of its initial volume, then diluted with ethanol (10 mL) and stirred for 20 min. at 23° C., at which time a colorless precipitate was observed. Centrifugation followed by decantation of the supernatant yielded a colorless solid that was washed with EtOH (2×10 mL) and hexanes (3×10 mL) to yield the title compound as a colorless solid (0.832 g, 0.964 mmol, 77% yield). The product was used as obtained, but if desired, 1 can be recrystallized by cooling a saturated solution of 1 (toluene, 50° C.) to −35° C. for 24 hours to yield clear, colorless crystals. NMR Spectroscopy: ¹H NMR (400 MHz, CD₂Cl₂, 25° C., 6): 1.56-1.41 (m, 48H), 1.36 (d, ³J_{P-H}=7.4 Hz, 2H), 1.30 (d, ³J_{P-H}=7.4 Hz, 1.2H). ¹³C NMR (100 MHz, CD₂Cl₂, 25° C., 6): 55.0 (d, J_{P-C}=27.6 Hz), 38.4 (d, J_{P-C}=17.5 Hz), 38.3 (d, J_{P-C}=17.5 Hz), 32.5-30.5 (m), −0.66 (d, J_{P-C}=27.6 Hz), −0.85 (d, J_{P-C}=27.6 Hz). ³¹P NMR (162 MHz, CD₂Cl₂, 25° C., δ): −15.5 (¹J_{P-Pt}=3761 Hz), −15.9 (¹J_{P-Pt}=3747 Hz). Spectroscopic data match those reported for the title compound as a 2:1 mixture of head-to-tail and head-to-head dimeric structures.

[κ²-((^{t}Bu)₂PCMe₂CH₂)Pt(CH₃)₂][Mg(THF)₄]ₙ (5)

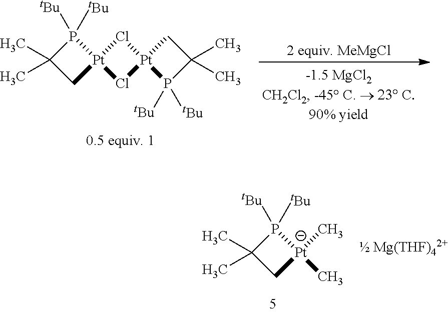

In a dry, N₂-filled glovebox, Pt-chloride dimer 1 (50.0 mg, 58.0 pmol, 1.00 equiv.), dichloromethane (1.5 mL), and a TEFLON-coated magnetic stirring bar were added to a 4 mL scintillation vial at 23° C. The vial was chilled at −45° C. in a CO₂/ⁱPrOH-cooled cold well for 30 min. and methylmagnesium chloride in THF (3.28 M, 71.3 L, 0.232 mmol, 4.00 equiv.) was added. The reaction vial was sealed with a TEFLON-lined cap and the vial was removed from the cold well and stirred at 23° C. for 90 seconds to dissolve frozen droplets of Grignard reagent. The solution was stirred at −45° C. for 3 hours, then at 23° C. for 30 min., at which time precipitation of a white solid was observed. Filtration through glass wool afforded a clear colorless solution which was diluted with benzene (1.5 mL) and concentrated in vacuo to half the orginial volume. The remaining solution was frozen at −45° C. and the resulting solid was lyophilized. The title compound was isolated as a white powder (73.3 mg) containing the product and aggregated MgCl₂(THF)₂. The product could not be purified by recrystallization due to the high solubility of 5 in organic solvents and the high lattice energy of MgCl₂(THF)₂. Attempts to purify 5 by crystallization yielded decomposition of 5 and crystalline magnesium salts. The tendency of 5 to aggregate with MgCl₂(THF)₂ and its resistance to further purification by recrystallization prevented us from obtaining satisfactory results from elemental microanalysis. Reaction yield and purity were determined in a separate experiment from ¹H NMR integrations relative to an internal standard.

Yield Determination.

In a dry, N₂-filled glovebox, Pt-chloride dimer 1 (25.4 mg, 29.0 μmol, 1.00 equiv.) and dichloromethane-d₂ (0.5 mL) were added to a 4 mL scintillation vial to form a clear colorless solution. The vial was cooled at −45° C. in a CO₂/ⁱPrOH-cooled cold well for 30 min. and methylmagnesium chloride in THF (3.33 M, 35.7 μL, 0.119 mmol, 4.00 equiv.) was added. The reaction vial was sealed with a TEFLON-lined cap and the vial was shaken for 90 seconds at 23° C. to dissolve frozen droplets of the Grignard reagent. The reaction vial was cooled −45° C. for 3 hours, then warmed at 23° C. for 30 min., at which time precipitation of a white solid was observed. The reaction vial was unsealed and 1,5-cyclooctadiene (internal standard, 7.2 μL, 6.4 mg, 59 μmol, 2.0 equiv.) was added and the contents of the vial mixed thoroughly. The white mixture was transferred to an NMR tube which was sealed with a plastic cap and electrical tape. ¹H NMR analysis showed the title compound, 5, in 98% yield relative to the internal standard. ³¹P NMR of this sample showed only the signal for the title compound. NMR Spectroscopy: ¹H NMR (600 MHz, CD₂Cl₂, 25° C., δ): 4.08 (s, br, 12H), 1.94 (s, br, 12H), 1.42 (d, ³J_{P-H}=11.2 Hz, 24H), 0.60 (d, ³J_{P-H}=13.5 Hz, ²J_{Pt-H}=61.0 Hz, 2H), 0.36 (d, ³J_{P-H}=4.7 Hz, ²J_{Pt-H}=47.0 Hz, 3H), 0.16 (d, ³J_{P-H}=2.9 Hz, ²J_{Pt-H}=30.5 Hz). ¹³C NMR (125 MHz, CD₂Cl₂, 25° C., δ): 70.0, 54.8 (d, J_{P-C}=25.3 Hz), 36.0, 35.0 (s, J_{Pt-C}=43.7 Hz), 32.0, 25.5, 20.1 (d, J_{P-C}=19.9 Hz, J_{Pt-C}=452.4 Hz), −9.3 (d, J_{P-C}=88.2 Hz), −17.5 (s, J_{Pt-C}=279.9 Hz). ³¹P NMR (162 MHz, CD₂Cl₂, 25° C., δ): 9.4 (¹J_{P-Pt}=1814 Hz).

[κ²-((^{t}Bu)₂PCMe₂CH₂)Pt(CH₃)(Si(OEt)₃)][Mg(THF)₄] (6)

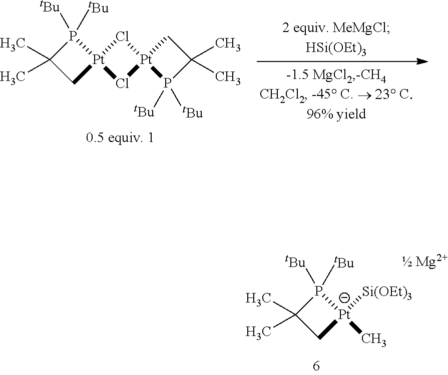

Complex 6 can be prepared from Pt-chloride dimer 1 or from dimethyl platinate 5. In this procedure, in situ generation of dimethyl platinate 5 followed by transformation to silyl methyl platinate 6 is described.

Formation of Platinate 5.

In a dry, N₂-filled glovebox, Pt-chloride dimer 1 (50.0 mg, 58.0 μmol, 1.00 equiv.), dichloromethane (1.5 mL), and a TEFLON-coated magnetic stirring bar were added to a 4 mL scintillation vial at 23° C. The vial was cooled at −45° C. in a CO₂/ⁱPrOH-cooled cold well for 30 min. Methylmagnesium chloride in THF (3.28 M, 71.3 μL, 0.232 mmol, 4.00 equiv.) was added, the reaction vial was sealed with a TEFLON-lined cap, and the vial was removed from the cold well and shaken at 23° C. for 90 seconds to dissolve frozen droplets of Grignard reagent. The solution was stirred at −45° C. for 3 hours, then at 23° C. for 30 min., at which time precipitation of a white solid was observed.

Silylation to Form Platinate 6.

The reaction vial was chilled at −45° C. for 30 minutes, then butadiene (100 μL) and triethoxysilane (112 μL, 99.7 mg, 0.609 mmol, 2.00 equiv.) were added. The solution was stirred for 60 min. at 23° C. Filtration through glass wool afforded a clear, pale yellow solution which was reduced in volume to about 3 mL in vacuo, diluted with benzene (5 mL), and frozen at −45° C. before the resulting solid was lyophilized. Platinate 6 was isolated as a pale yellow powder (499 mg). Attempts to purify 6 by recrystallization yielded mixtures of crystals containing crystals of 6 in multiple aggregation modes and crystalline magnesium salts. The tendency of 6 to aggregate with MgCl₂(THF)₂ and its resistance to further purification by recrystallization prevented obtaining satisfactory results from elemental microanalysis. Reaction yield and purity was determined in a separate experiment from ¹H NMR integrations relative to an internal standard.

Yield Determination.

In a dry, N₂-filled glovebox, 1 (25.4 mg, 29.0 μmol, 1.00 equiv.) and dichloromethane-d₂ (0.5 mL) were added to a 4 mL scintillation vial to form a clear colorless solution. The vial was cooled to −45° C. in a CO₂/ⁱPrOH-cooled cold well for 30 min. and methylmagnesium chloride in THF (3.33 M, 35.7 μL, 0.119 mmol, 4.00 equiv.) was added. The reaction vial was sealed with a TEFLON-lined cap and the vial was removed from the cold well and shaken for 90 seconds at 23° C. to dissolve frozen droplets of Grignard reagent. The solution was stirred at −45° C. for 3 hours, then at 23° C. for 30 min., at which time precipitation of a white solid was observed. The reaction vial was stirred at −45° C. for 30 min. Butadiene (20 μL) and triethoxysilane (11.4 μL, 10.1 mg, 62.0 μmol, 2.00 equiv.) were added and the reaction stood at 23° C. for 3 hours. The vial was unsealed and 1,5-cyclooctadiene (internal standard, 7.2 μL, 6.4 mg, 59 μmol, 2.0 equiv.) was added. The vial contents were thoroughly mixed and transferred to an NMR tube which was sealed with a plastic cap and electrical tape. ¹H NMR analysis showed the title compound, 6, in 85% yield relative to the internal standard. NMR Spectroscopy: ¹H NMR (400 MHz, CD₂Cl₂, 25° C., δ): 4.02 (s, br, 12H), 3.90 (q, 9H) 1.95 (s, br, 12H), 1.49 (d, ³J_{P-H}=11.2 Hz, 6H), 1.43 (d, ³J_{P-H}=11.2 Hz, 18H), 0.36 (d, ³J_{P-H}=4.7 Hz, ²J_{Pt-H}=47.0 Hz, 3H), 1.25 (t, 9H), 0.63 (d, ³J_{P-H}=14.7 Hz, ²J_{Pt-H}=68.1 Hz), 0.33 (d, ³J_{P-H}=5.28 Hz, ²J_{P-tH}=66.9 Hz). ¹³C NMR (125 MHz, CD₂Cl₂, 25° C., δ): 69.7, 57.8, 36.2 (s, J_{Pt-C}=38.2 Hz), 34.9, 32.4, 31.9, 17.9, 17.7. ³¹P NMR (162 MHz, CD₂Cl₂, 25° C., δ): 16.6 ppm (¹J_{P-Pt}=1421 Hz).

Preparation of X-Ray Quality Crystals.

Single crystals suitable for X-ray diffraction were grown in a dry, N₂-filled glovebox from a saturated acetonitrile or THF/hexanes solution of 6. THF/hexanes conditions (6): in a 4 mL scintillation vial, 6 (25.0 mg) was dissolved in THF (0.5 mL) and the resulting clear solution was filtered through a plug of glass wool and diluted with hexanes (3 mL) before cooling at −30° C. for one week, forming block-like colorless crystals. Acetonitrile conditions (S11): in a 4 mL scintillation vial, 6 (50.0 mg) was suspended in MeCN (0.5 mL) to form a suspension. The suspension was filtered through glass wool to remove undissolved solids and cooled at −30° C. for 4 weeks to yield colorless needle-like crystals.

[(κ²-(^{t}Bu)₂PCH₂CMe₂CH₂)PtCl]₂ (S12)

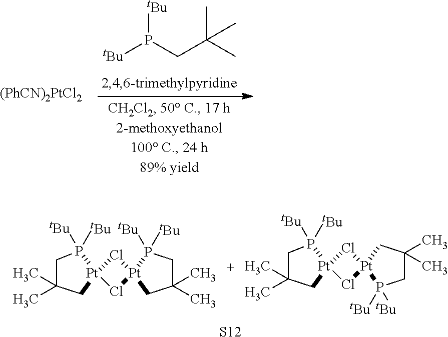

Preparation of S12 was adapted from the method of Mason et al. (Mason, R.; Textor, M.; Al-Salem N.; Shaw, B. Chem. Commun. 1976, 292-293). In a dry, N₂-filled glovebox, (PhCN)₂PtCl₂ (441 mg, 0.934 mmol, 1.00 equiv.), dichloromethane (1.9 mL), and a TEFLON-coated magnetic stirring bar were added to a 20 mL scintillation vial at 23° C., forming a yellow suspension. Di-tert-butylneopentylphosphine (241 μL, 202 mg, 0.934 mmol, 1.00 equiv.) and 2,4,6-trimethylpyridine (124 μL, 114 mg, 0.934 mmol, 1.00 equiv.) were added. The reaction vial was sealed with a polyethylene-lined cap and removed from the glovebox. The reaction mixture was stirred at 50° C. in an aluminum heating block for 16.5 hours, cooled at 23° C. for 5 min., and opened under ambient atmosphere. The solvent was removed by rotary evaporation, then 2-methoxyethanol (1.9 mL) was added and the resulting suspension was stirred at 100° C. for 24.5 hours. Centrifugation followed by decantation of the supernatant yielded a residue that was washed with methanol (2×1 mL) and hexanes (1 mL) to afford the title compound as a colorless solid (370 mg, 0.415 mmol, 89% yield).

NMR Spectroscopy: ¹H NMR (400 MHz, CD₂Cl₂, 25° C., δ): 2.00 (d, ²J_{P-tH}=105 Hz, 4H), 1.73 (d, ²J_{P-H}=8.72 Hz, 4H), 1.40 (d, J_{P-H}=13.7 Hz, 36H), 1.21 (s, 12H). ¹³C NMR (125 MHz, CD₂Cl₂, 25° C., δ): 42.9 (d, J_{P-C}=7.60 Hz), 37.0 (d, J_{P-C}=32.1 Hz), 35.0 (d, J_{P-C}=27.5 Hz), 31.9 (d, J_{P-C}=8.82 Hz), 31.2, 29.6-29.5 (m). ³¹P NMR (162 MHz, CD₂Cl₂, 25° C., δ): 69.7 (¹J_{P-Pt}=4977 Hz), 69.5 (¹J_{P-Pt}=5005 Hz). Anal: calcd for C₂₆H₅₆Cl₂P₂Pt₂: C, 35.02; H, 6.33. found: C, 35.05; H, 6.09. Spectroscopic data shows the title compound as a 1:2.5 mixture of head-to-head and head-to-tail dimeric structures.

[(κ²-(^{t}Bu)₂PCH₂CMe₂CH₂)Pt(MeCN)₂][OTf] (S13)

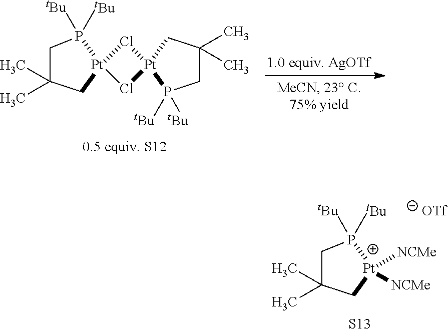

Platinum complex S12 (250 mg, 0.280 mmol, 1.00 equiv.), AgOTf (144 mg, 0.560 mmol, 2.00 equiv.), and a TEFLON-coated magnetic stirring bar were added to a 20 mL amber-colored scintillation vial. Acetonitrile (5.5 mL) was added at 23° C. to form a white suspension, which was sealed with a TEFLON-lined cap and stirred at 23° C. for 12 hours. The vial was opened, and the white suspension was filtered through a plug of glass wool to yield a clear, colorless solution. The solvent was removed by rotary evaporation, and dichloromethane (2 mL) was added. The resulting suspension was filtered through a plug of CELITE, and the colorless filtrate was concentrated by rotary evaporation. The colorless solid was purified by recrystallization from a saturated solution in acetonitrile/diethyl ether cooled at −30° C. to yield the title compound as a white powder (269 mg, 0.419 mmol, 75%).

NMR Spectroscopy: ¹H NMR (400 MHz, CD₂Cl₂, 25° C., δ): 2.42 (s, 3H), 2.34 (s, 3H), 1.95 (d, ²J_{Pt-H}=95.9 Hz, 2H), 1.79 (d, ²J_{P-H}=9.19 Hz, 2H), 1.35 (d, J_{P-H}=14.1 Hz, 18H), 1.18 (s, 6H). ¹³C NMR (125 MHz, CD₂Cl₂, 25° C., δ): 125.5 (d, J_{Pt-C}=321 Hz), 119.4 (d, J_{P-C}=15.5 Hz), 43.3 (d, J_{P-C}=6.51 Hz), 36.6 (d, J_{P-C}=33.2 Hz), 35.4 (d, J_{P-C}=28.4 Hz), 35.4 (d, J_{P-C}=28.4 Hz), 32.6 (d, J_{P-C}=9.05 Hz), 29.8 (d, J_{P-C}=3.05 Hz), 28.4. ³¹P NMR (162 MHz, CD₂Cl₂, 25° C., δ): 69.4 (¹J_{P-Pt}=4604 Hz). ¹⁹F NMR (376 MHz, CD₂Cl₂, 25° C., δ): −78.8. Anal: calcd for C₃₈H₃₄F₃N₂P₃ PPtS: C, 33.70; H, 5.34; N, 4.37. found: C, 33.84; H, 5.22; N, 4.28.

[(κ²-(^{t}Bu)₂PCH₂CMe₂CH₂)Pt(Me)₂][MgCl(THF)₃] (7)

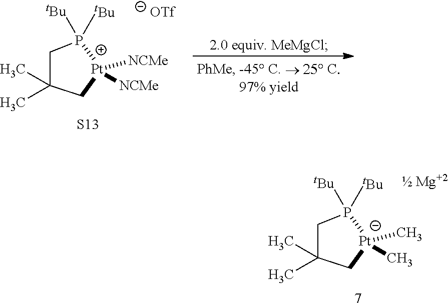

In a dry, N₂-filled glovebox, platinum complex S13 (97.5 mg, 0.152 mmol, 1.00 equiv.), toluene (1.0 mL), and a TEFLON-coated magnetic stirring bar were added to a 4 mL scintillation vial, forming a white suspension. The mixture was stirred at −45° C. in a CO₂/ⁱPrOH-cooled cold well for 30 min. and methylmagnesium chloride in THF (3.28 M, 93.0 μL, 0.304 mmol, 2.00 equiv.) was added. The reaction vial was sealed with a TEFLON-lined cap and the vial was removed from the cold well and shaken for 90 seconds to dissolve frozen droplets of Grignard reagent. The suspension was stirred at −45° C. for 2 hours, then at −30° C. in the glovebox freezer for 14 hours, at which point precipitation of a dark solid was observed. Filtration through glass wool afforded a clear colorless solution which was concentrated in vacuo to yield the title compound as a colorless solid (103 mg) containing the product and aggregated MgCl₂(THF)₂. The product could not be purified by recrystallization due to the high solubility of 7 in organic solvents and the high lattice energy of MgCl₂(THF)₂. Attempts to purify 7 by crystallization yielded decomposition of 7 and crystalline magnesium salts. The tendency of 7 to aggregate with MgCl₂(THF)₂ and its resistance to further purification by recrystallization prevented obtaining satisfactory results from elemental microanalysis. Reaction yield and purity were determined in a separate experiment from 1H NMR integrations relative to an internal standard.

Yield Determination.

In a dry, N₂-filled glovebox, platinum complex S13 (31.3 mg, 48.9 mol, 1.00 equiv.), toluene-d₈ (0.5 mL), and a TEFLON-coated magnetic stirring bar were added to a 4 mL scintillation vial at 23° C. The suspension was stirred at −45° C. in a CO₂/ⁱPrOH-cooled cold well for 30 min. and methylmagnesium chloride in THF (3.33 M, 29.4 μL, 97.8 mol, 2.00 equiv.) was added. The reaction vial was sealed with a TEFLON-lined cap and the vial was shaken for 90 seconds at 23° C. to dissolve frozen droplets of Grignard reagent. The resulting suspension was stirred at −45° C. for 2 hours, then at −30° C. for 8 hours in the glovebox freezer. The vial was unsealed and 1,5-cyclooctadiene (internal standard, 10.0 μL, 8.82 mg, 81.0 mol, 1.66 equiv.) was added. The suspension was thoroughly mixed and transferred to an NMR tube which was sealed with a plastic cap and electrical tape. ¹H NMR analysis showed the title compound, 7, in 97% yield relative to the internal standard. NMR Spectroscopy: ¹H NMR (400 MHz, CD₂Cl₂, 25° C., δ): 4.02 (s, br, 8H), 1.93 (s, br, 8H) 1.81 (d, ²J_{P-H}=7.70 Hz, 2H), 1.26 (d, ³J_{P-H}=12.1 Hz, 18H), 1.20-0.92 (m, 8H), 0.42 (d, ³J_{P-H}=3.91 Hz, ²J_{P-tH}=43.3 Hz, 3H), 0.19 (d, ²J_{P-tH}=28.0 Hz, 3H). ¹³C NMR (100 MHz, CD₂Cl₂, 25° C., 6): 70.2, 49.9 (d, J_{Pt-C}=570 Hz), 43.7 (d, J_{P-C}=14.6 Hz), 41.2 (d, J_{P-C}=26.3 Hz), 35.0 (d, J_{P-C}=6.10 Hz), 30.3 (d, J_{P-C}=6.48 Hz), 25.8, −3.47 (J_{P-C}=106 Hz), −13.9. ³¹P NMR (162 MHz, CD₂Cl₂, 25° C., δ): 70.8 (¹J_{P-Pt}=2412 Hz).

[(κ²-(^{t}Bu)₂PCMe₂CH₂)Pt(NCMe)₂](S3)

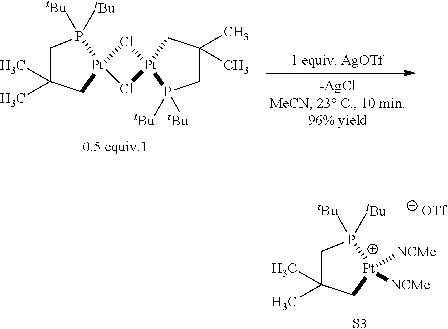

In a dry, N₂-filled glovebox, platinum complex 1 (0.500 g, 0.579 mmol, 1.00 equiv.), AgOTf (0.297 g, 1.16 mmol, 2.00 equiv.), a TEFLON-coated magnetic stirring bar, and acetonitrile (10 mL) were added to a 20 mL scintillation vial at 23° C. to form a white suspension. After 10 minutes, the suspension was filtered through glass wool to yield a clear, colorless filtrate. Concentration of the filtrate yielded the title compound as a colorless crystalline solid (0.701 g, 1.12 mmol, 96%). The title compound was used as obtained, but could be further purified by recrystallization. A saturated solution of S3 in MeCN at 23° C. was layered with Et₂O and cooled at −30° C. for 24 hours to yield colorless crystals.

NMR Spectroscopy: ¹H NMR (600 MHz, CD₂Cl₂, 25° C., δ): 2.38 (s, 3H), 2.34 (s, 3H), 1.48 (d, ³J_{P-H}=14.1 Hz, 18H), 1.47 (d, ³J_{P-H}=14.7 Hz, δH), 1.37 (d, ³J_{P-H}=8.2 Hz, 2H). ¹³C NMR (100 MHz, CD₂Cl₂, 25° C., δ): 122.8, 120.1, 119.2, 119.1, 37.5 (d, J_{P-C}=18.4 Hz), 31.7, 31.1, 3.1 (d, J_{P-C}=9.2 Hz), 3.0, 3.3 (d, ²J_{P-C}=26.1 Hz). One resonance was not observed. ³¹P NMR (162 MHz, CD₂Cl₂, 25° C., δ): −17.5 (¹J_{P-Pt}=3451 Hz). ¹⁹F NMR (376 MHz, CD₂Cl₂, 25° C., δ): −78.9. Anal: calcd for C₁₇H₃₂F₃N₂O₃ PPtS: C, 32.54; H, 5.14; N, 4.46. found: C, 32.63; H, 5.01; N, 4.48.

### [(κ²-(Bu)₂PCMe₂CH₂)PtCHa(NCMe)] (S4)

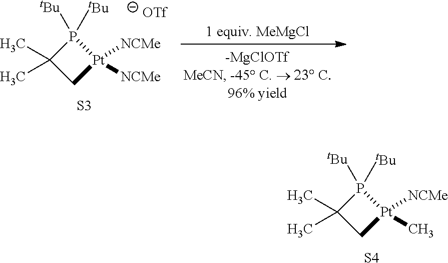

In a dry, N₂-filled glovebox, platinum complex S3 (50.0 mg, 80.0 μmol, 1.00 equiv.), a TEFLON-coated magnetic stirring bar, and acetonitrile (1.0 mL) were added to a 20 mL scintillation vial at 23° C. to form a clear, colorless solution. The solution was cooled to −40° C. in a CO₂/ⁱPrOH-cooled cold well for 30 min. and methylmagnesium chloride in THF (c=3.25 M, 24.6 μL, 0.080 mmol, 1.00 equiv.) was added. The reaction vial was sealed with a polyethylene-lined cap and shaken for 90 seconds at 23° C. to dissolve frozen droplets of Grignard reagent. The resulting solution was stirred at −40° C. for 15 minutes and then at 23° C. for 15 min. The vial was opened, and the solution diluted with diethyl ether (6.0 mL), then pentane (6.0 mL), at which time a white precipitate was observed. Filtration through glass wool yielded a clear, colorless solution. Evaporation of the solvent in vacuo afforded the title compound as a colorless crystalline solid (34.6 mg, 76.0 μmol, 96% yield).

NMR Spectroscopy: ¹H NMR (400 MHz, CD₃CN, 23° C., δ): 1.96 (s, 3H), 1.45-1.37 (m, 24H), 1.14 (d, ³J_{P-H}=14.4 Hz, ²J_{Pt-H}=98.3 Hz, 2H), −0.01 (d, ³J_{P-H}=7.4 Hz, ²J_{Pt-H}=71.4 Hz, 3H). ¹³C NMR (125 MHz, CD₃CN, 25° C., δ): 55.2 (d, J_{P-C}=20.7 Hz), 37.0, 33.6 (s, J_{Pt-C}=60.9 Hz), 32.1 (d, J_{P-C}=4.6 Hz), 4.6 (d, J_{P-C}=17.8 Hz), −2.3 (d, J_{P-C}=105.2 Hz). ³¹P NMR (162 MHz, CD₃CN, 25° C., δ): 21.8 (¹J_{P-Pt}=1359 Hz). Anal: calcd for C₁₅H₃₂NPPt: C, 39.82; H, 7.13; N, 3.10. found: C, 39.58; H, 6.87; N, 3.05.

[(κ²-(^{t}Bu)₂PCMe₂CH₂)Pt(Si(OEt)₃)(NCMe)] (S5)

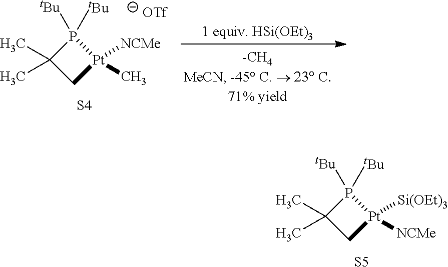

In a dry, N₂-filled glovebox, platinum complex S4 (100.0 mg, 0.2210 mmol, 1.000 equiv.), a TEFLON-coated magnetic stirring bar, and acetonitrile (2.0 mL) were added to a 20 mL scintillation vial at 23° C. The clear, colorless solution was cooled at −40° C. in a CO₂/ⁱPrOH-cooled cold well for 30 min. Triethoxysilane (40.8 μL, 36.3 mg, 0.221 mmol, 1.00 equiv.) was added, and the solution was stirred at 23° C. for 1 hour and then cooled to −30° C. for 14 hours in the glovebox freezer, at which time a tan-colored crystalline precipitate was observed. The supernatant was decanted and the crystals were washed with cold MeCN (2×0.2 mL) and dried in vacuo to yield the title compound as a tan-colored crystalline solid (97.4 mg, 0.162 mmol, 73%). After solvent removal, continued exposure of the product to vacuum resulted in discoloration and decomposition (observed by ¹H and ³¹P NMR). Although obtained as a single isomer, the title compound isomerizes rapidly in solution at 23° C. to form the diastereomeric coordination complex in which the silicon ligand is trans to the phosphine.

NMR Spectroscopy: ¹H NMR (600 MHz, CD₃CN, 23° C., 6): 3.74 (q, J=48.1 Hz, 6H), 1.96 (s, 3H), 1.46 (d, ³J_{P-H}=13.5 Hz, 18H), 1.42 (d, ³J_{P-H}=13.5 Hz, δH), 1.11 (t, J=6.8 Hz, 9H), 0.58 (d, ³J_{P-H}=10.6 Hz, ²J_{Pt-H}=48.1 Hz, 2H). ¹³C NMR (125 MHz, CD₃CN, 25° C., δ): 57.0, 54.6 (d, J_{P-C}=35.0 Hz), 37.1 (d, J_{P-C}=14.9 Hz), 35.9 (s, J_{Pt-C}=45.5 Hz), 31.8, 28.1 (s, J_{P-C}=28.8 Hz), 19.4 (d, J_{P-C}=22.0 Hz). One signal not observed. ³¹P NMR (162 MHz, CD₃CN, 25° C., δ): −3.4 (¹J_{P-Pt}=3578 Hz). Anal: calcd for C₂₀H₄₄NO₃PPtSi: C, 39.99; H, 7.38; N, 2.33. found: C, 39.89; H, 7.12; N, 2.33.

[(κ²-(^{t}Bu)₂PCMe₂CH₂)Pt(Si(OEt)₃)(CH₂CH₂CH═CH₂)] (8)

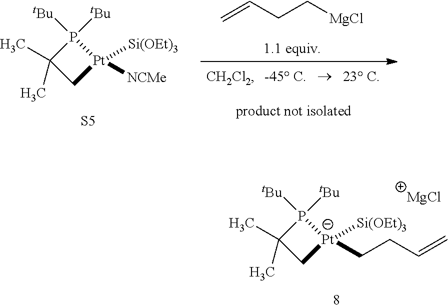

In a dry, N₂-filled glovebox, platinum complex S5 (25.0 mg, 55.0 μmol, 1.00 equiv.) was added to a 4 mL scintillation vial and cooled at −45° C. in a CO₂/¹PrOH-cooled cold well for 30 min. Pre-cooled dichloromethane-d₂ (0.5 mL) was added at −45° C. to form a pale yellow solution. 3-Butenylmagnesiumchloride in THF (1.15 M, 48.0 μL, 55.0 μmol, 1.00 equiv.) was added and the reaction vial was sealed with a TEFLON-lined cap and shaken at 23° C. for 90 seconds to dissolve any frozen droplets of Grignard reagent. The pale yellow solution was stirred at −45° C. for 30 min., then at 23° C. for 30 min. The contents of the reaction vial were transferred to a screw-capped NMR tube for analysis. Attempts to isolate 8 by diluting the reaction solution with benzene (3 mL) then freezing the solution at −45° C. and lyophilizing the resulting solid in vacuo resulted in partial decomposition. The title compound was used for catalysis as obtained, without isolation.

NMR Spectroscopy: ¹H NMR (400 MHz, CD₂Cl₂, 23° C., δ): 6.02-5.84 (m, 1H), 4.75 (d, 19.5 Hz, 1H), 4.58 (d, 8.58 Hz, 1H), 3.84 (q, ³J_{H-H}=7.0 Hz, δH), 3.73 (s)*, 2.39-2.12 (m, 2H), 1.63 (s)*, 1.51-1.35 (m, 24H), 1.22 (t, ³J_{H-H}=7.4 Hz, 9H), 0.68 (d, ³J_{P-H}=14.8 Hz, ²J_{Pt-H}=55.4 Hz, 2H). ¹³C NMR (125 MHz, CD₂Cl₂, 23° C., δ): 109.1, 68.7*, 57.8, 37.9, 36.6, 35.2, 32.6, 32.3, 26.1*, 18.5, 18.2, 2.27. One signal not observed. ³¹P NMR (162 MHz, CD₂Cl₂, 23° C., δ): 13.49 (s, J_{Pt-P}=1300 Hz). *Signals correspond to THF co-solvent from in situ generation of 5.

But-3-enyltriethoxysilane (2)

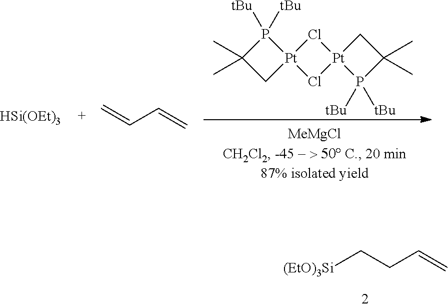

In an N₂-filled glovebox, [PtCl(CH₂CMe₂PtBu₂—C,P)]₂ (1) (2.6 mg, 2.96 μmol, 0.0025 equiv.) was charged in an sealable, screw-capped NMR tube with 0.3 mL of D₂-dichloromethane to form a clear, colorless solution. The reaction tube was chilled to −45° C. in a dry ice/isopropanol-cooled cold well and MeMgCl (3.3 M in THF, 3.59 μL, 0.012 mmol, 0.010 equiv.) was added, immediately freezing on the wall of the tube. The reaction tube was capped and shaken at room temperature for 90 seconds until the solution appeared homogeneous, then replaced in the cold well and stirred for 3 hours at −45° C. Butadiene (100.0 μL, 1.18 mmol, 1.0 equiv.), then triethoxysilane (218.0 L, 1.18 mmol, 1.0 equiv.) were added and the reaction tube sealed, removed from the glovebox, and heated to 50° C. in an oil bath. After 20 minutes, ¹H NMR analysis indicated the reaction had reached 89% conversion and 10 μL N,N′-dimethylethylenediamine added to quench the platinum catalyst. The reaction was not run to 100% conversion to prevent isomerization to the undesired allyl silane products after completion of the reaction. The solvent was removed under vacuum and the product purified by column chromatography on silica gel, eluting with 10% ethyl acetate/90% hexanes to yield a mixture of 2 and products of 1,4-hydrosilylation. Isomer ratios were determined by integrating the ¹H NMR signals for the three isomers in the product mixture. Yield=86%, 9:1 ratio of the 1,2-:1,4-addition products. NMR Characterization: 1H NMR (399 MHz, Benzene) δ ppm 0.80-0.86 (m, 2H) 1.16 (t, J=6.95 Hz, 9H) 1.56-1.78 (m, 1H) 2.27-2.39 (m, 2H) 3.78 (q, J=6.95 Hz, 6H) 4.96 (dq, J=9.93, 1.57 Hz, 1H) 5.07 (dq, J=17.02, 1.77 Hz, 1H) 5.40-5.78 (m, 1H) 5.94 (s, 1H).

In another set of experiments, platinum precatalyst 1 (119.5 mg, 0.1380 mmol, 0.2500 mol %), a TEFLON-coated magnetic stirring bar, and dichloromethane (15 mL) were added to a 20 mL scintillation vial in a dry, N₂-filled glovebox. After chilling at −45° C. in a CO₂/ⁱPrOH-cooled cold well for 30 minutes, methylmagnesium chloride in THF was added (3.28 M, 168 μL, 0.552 mmol, 1.00 mol %), and the vial was sealed with a polyethylene-lined cap and shaken for 90 seconds at 23° C. to dissolve frozen droplets of Grignard reagent. The reaction mixture was stirred at −45° C. for 3 hours then at 23° C. for 30 min., at which time precipitation of a white solid was observed. The vial was chilled at −45° C. for 30 min then its contents were transferred to a pre-cooled, 100 mL Schlenk vessel. A TEFLON-coated magnetic stirring bar, butadiene (7.00 mL, 4.48 g, 83.0 mmol, 1.50 equiv.), triethoxysilane (10.2 mL, 9.07 g, 55.2 mmol, 1.00 equiv.), and dichloromethane (7.0 mL) were added, and the Schlenk vessel was sealed and removed from the glovebox. The reaction mixture was stirred at 50° C. in a pre-heated oil bath for one hour and then cooled at 23° C. for 5 min. The tube was opened under ambient atmosphere and the contents decanted into a 50 mL round-bottom flask. Solvent was removed by rotary evaporation and the product was purified by bulb-to-bulb distillation (5 Torr, 85° C.) to yield butenyltriethoxysilane as a mixture of 1,2- and 1,4-addition products (10.2 g, 10:1 1,2-:1,4-addition, 85%). Ratio of 1,2-:1,4-addition products determined to be 10:1 by 1H NMR integration of signals corresponding to alkenyl protons (5.96-5.86 ppm for 3-butenyltriethoxysilane signal corresponds to 1H; 5.49-5.37 for 2-butenyltriethoxysilanes, overlapping signals for cis- and trans-isomers correspond to 2H) and 91:9 by GC analysis (HP-5, 6 psi, Program 1): t_{R} (major, 1,2-addition product)=3.44 min. (90.6), t_{R} (minor, 1,4-addition products)=3.59 min. (9.3). NMR Spectroscopy: 1H NMR (600 MHz, CD₂Cl₂, 25° C., δ): 5.92 (m, 1H), 5.40-5.20 (m)*, 5.0 (dd, ³J_{H-H}=17.3 Hz, ²J_{H-H}=2.1 Hz, 1H), 4.90 (dd, ³J_{H-H}=10.0 Hz, ²J_{H-H}=1.8 Hz, 1H), 3.8 (q, ³J_{H-H}=7.0 Hz, δH), 2.14 (m, 2H), 1.2 (t, ³J_{H-H}=7.0 Hz, 9H), 1.63-1.72 (m)*, 1.60-1.54 (m)*, 0.7 (m, 2H). ¹³C NMR (125 MHz, CD₂Cl₂, 25° C., δ): 141.7, 113.2, 58.8, 27.5, 18.7, 10.2. HRMS-FIA (m/z): calcd for C₁₀H₂₂O₃SiNa [M+Na]⁺, 241.1230. Found, 241.1239. *Signals correspond to cis- and trans-triethoxysilylbut-2-ene.

Independent Synthesis of But-3-enyltriethoxysilane (2)

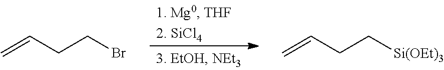

Magnesium turnings (1.44 g, 59.1 mmol, 1.2 equiv.) were added to a dry 250 mL 2-neck round-bottom flask equipped with a reflux condenser under a nitrogen atmosphere. THF (150 mL) was cannulated into the flask, then 4-bromobutene (5.0 mL, 49.3 mmol, 1.0 equiv.) was slowly added by syringe under vigorous stirring until the reaction mixture became cloudy and slightly yellow in color. After this point the remaining 4-bromobutene was added at a rate sufficient to maintain reflux, after the addition was complete the reaction was maintained at reflux in an oil bath until an aliquot quenched in MeOH showed no signals corresponding to 4-bromobutene by ¹H NMR.

After cooling to 0° C. in an ice bath, SiCl₄ (28.3 mL, 246 mmol, 5.0 equiv.) was added slowly and the reaction stirred vigorously at room temperature for 30 hours. The nitrogen line was disconnected and the flask connected to a sodium-hydroxide trap to quench gaseous HCl, and the reaction flask was cooled to 0° C. in an ice bath. Dry, degassed NEt₃ (20.6 mL, 148 mmol, 3.0 equiv.) was added via syringe, then dry, degassed >99.95% EtOH (20 mL) was added slowly to minimize fuming. The reaction stirred 24 hours at room temperature. After filtration to remove magnesium salts, the resulting solution was concentrated under reduced pressure to approximately 10% of its volume, then the product was distilled using a Kugelrohr to yield pure 2 (3.9 g, 17.9 mmol, 36.3% yield).

NMR Characterization: ¹H NMR (600 MHz, CHLOROFORM-d) δ ppm 0.61-0.81 (m, 2H) 1.11-1.30 (m, 9H) 2.07-2.22 (m, 2H) 3.69-3.88 (m, 6H) 4.82-4.96 (m, 1H) 4.96-5.07 (m, 1H) 5.81-5.96 (m, 1H).

### [(CH₂CMe₂PtBu₂—C,P)PtMe₂][MgCl] (3)

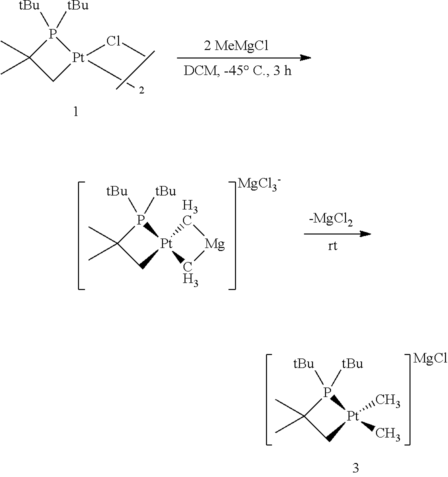

In an N₂-filled glovebox, [PtCl(CH₂CMe₂PtBu₂—C,P)]₂ (1) (50.0 mg, 0.058 mmol, 1.0 equiv.) was charged in a 4 mL scintillation vial with a TEFLON-coated magnetic stir bar and 2.5 mL of dichloromethane to form a clear, colorless solution. The reaction vial was chilled to −45° C. in a dry ice/isopropanol-cooled cold well and MeMgCl (3.3 M in THF, 70.0 μL, 0.232 mmol, 4.0 equiv.) was added, immediately freezing on the wall of the vial. The reaction vial was capped and shaken at room temperature for 90 seconds until the solution was homogeneous, then replaced in the cold well and stirred for 3 hours at −45° C. The clear, colorless solution was allowed to warm to room temperature for 30 minutes, forming a white precipitate. After re-cooling to −45° C., the white suspension was filtered through CELITE to yield a clear, colorless solution that was concentrated under vacuum to a reddish glassy residue. Trituration with hexanes (4×2 mL) yielded 3 as a white powder.

Redissolution of 3 in dichloromethane or benzene gave yellow solutions that quickly darkened to red with the corresponding appearance and growth of a new peak in the ³¹P NMR spectrum that we have assigned as a decomposition product of 3. Dissolution in THF or dioxane led to decomposition more slowly, allowing ¹H and ³¹P Characterization of the product containing only trace decomposition products. The cause of this decomposition was found to be the trace amount of water present in these solvents. Stable solutions of all the platinum complexes described herein were prepared in solvents that were rigorously dry.

NMR Characterization in situ: ¹H NMR (399 MHz, CD₂Cl₂) δ ppm 0.16 (d, ²J_{P-H}=3.5 Hz, ²J_{Pt-H}=32.8 Hz, 3H) 0.35 (d, ²J_{P-H}=4.7 Hz, ²J_{Pt-H}=50.3 Hz, 3H) 0.59 (d, ³J_{P-H}=13.7 Hz, ²J_{Pt-H}=47.2 Hz, 2H) 1.42 (d, ³J_{P-H}=11.7 Hz, 34H). ³¹P NMR (162 MHz, CD₂Cl₂) δ ppm 9.45 (s, ¹J_{Pt-P}=1776 Hz).

NMR Characterization after isolation and redissolution: ³¹P NMR (162 MHz, THF) δ ppm 6.8 (s, ¹J_{Pt-p}=1720 Hz) 11.33 (s).

Hydrosilylation of Butadiene from Complex 3

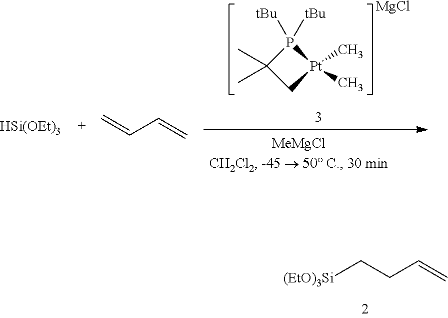

Complex 3 was generated in situ by the following procedure: In an N₂-filled glovebox, [PtCl(CH₂CMe₂PtBu₂—C,P)]₂ (1) (10.0 mg, 0.012 mmol, 1.0 equiv.) was charged in a 4 mL scintillation vial with a TEFLON-coated magnetic stir bar and 2.5 mL of dichloromethane to form a clear, colorless solution. The reaction vial was chilled to −45° C. in a dry ice/isopropanol-cooled cold well and butadiene (1.96 μL, 0.0023 mmol, 2.0 equiv.) then MeMgCl (3.3 M in THF, 14.0 μL, 0.046 mmol, 4.0 equiv.) was added, immediately freezing on the wall of the vial. The reaction vial was capped and shaken at room temperature for 90 seconds until the solution was homogeneous, then replaced in the cold well and stirred for 3 hours at −45° C. The clear, colorless solution was allowed to warm to room temperature for 30 minutes, forming a white precipitate. After re-cooling to −45° C., the white suspension was filtered through CELITE to remove the precipitate. Butadiene (200 μL, 2.366 mmol, 204 equiv.) and triethoxysilane (436 μL, 2.362 mmol, 204 equiv.). The reaction vial was sealed and brought out of the glovebox then heated to 50° C. for 30 minutes. The reaction was quenched by adding N,N′-dimethylethylenediamine (10 μL) then TMS₂O (20 μL) was added as an internal standard. After analyzing the reaction mixture by ¹H NMR, the products were identified as a mixture of 2 and the products of 1,4-hydrosilylation (38% yield, 6:1 ratio 1,2-:1,4-addition products) with spectral data matching those shown above.

Formation of 4 In Situ with Generation of Methane

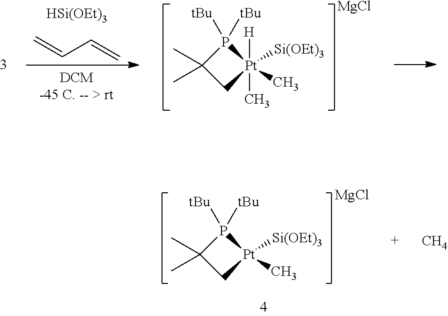

Platinate 3 was formed in situ by the method described for the isolation of platinate 3 above from chloride-bridged dimer 1 (10.0 mg, 0.012 mmol, 1.0 equiv.) and MeMgCl (3.3M in THF, 14.0 μL, 0.046 mmol, 4.0 equiv.) in CD₂Cl₂ (0.3 mL). After removal of MgCl₂ by filtration at −45° C., butadiene (2.0 μL, 0.023 mmol, 2.0 equiv.) was added to the clear colorless solution of 3 in dichloromethane, followed by triethoxysilane (4.27 μL, 0.023 mmol, 2.0 equiv.). The resulting clear, colorless solution was transferred to a pre-chilled, sealable, screw-capped NMR tube and brought out of the glovebox. The NMR tube was immediately immersed in a dry ice/acetone bath until inserted into the NMR spectrometer (about 10 minute delay) upon which point it rapidly warmed to room temperature. Initially the ¹H and ³¹P NMR signals for dimethylplatinate 3 were observed. Upon slight heating (35° C.) a new set of peaks began to appear and after 20 minutes the reaction was complete and by ³¹P NMR two species were present: one major platinum-containing species (about 90% by integration) and one minor species (unbound P(tBu)₃) without platinum satellites. Methane was observed at δ 0.24 ppm in the 1H NMR spectrum, along with small amounts of methyltriethoxysilane that we attribute to an alternate reductive elimination pathway from putative intermediate S1. The geometry of methylsilylplatinate complex 4 was assigned based on the magnitude of J²_{P-H} observed for the remaining methyl group in complex 4.

¹H NMR (399 MHz, CD₂Cl₂) δ ppm 0.07 (s, 1H) 0.19 (s, 1H) 0.31 (dd, J=70.54, 6.58 Hz, 3H) 0.61 (dd, J=53.0, 15.0 Hz, 2H) 1.23 (s, 20H) 1.40 (d, J=11.3 Hz, 32H) 3.84 (br. s., 42H) 4.21 (s, 1H) 5.09 (d, J=8.8 Hz, 2H) 5.15-5.26 (m, 2H) 6.25-6.43 (m, 1H).

Hydrosilylation of Butadiene from Complex 4

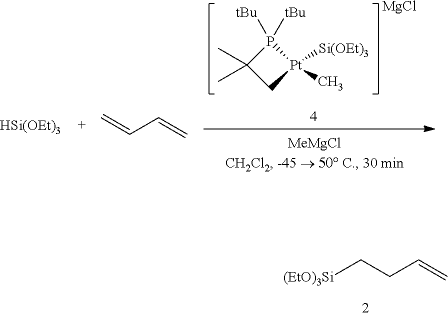

Complex 4 was generated in situ as described above. After confirming the identity of 4 by ¹H and ³¹P NMR, the sealed NMR tube was brought back into the glovebox and the contents transferred to a 4 mL scintillation vial. The vial was cooled to −45° C. and butadiene (200.0 μL, 2.37 mmol, 204 equiv.) and triethoxysilane (437.0 μL, 2.37 mmol, 204 equiv.) were added. The reaction vial was sealed and brought out of the glovebox, then heated to 50° C. for 30 minutes. The reaction was quenched by adding N,N′-dimethylethylenediamine (10 μL) then TMS₂O (20 μL) was added as an internal standard. After analyzing the reaction mixture by ¹H NMR, the products were identified as a mixture of 2 and the products of 1,4-hydrosilylation (66% yield, 8:1 ratio 1,2-:1,4-addition products).

Precatalyst 1, although the most active precatalyst in the hydrosilylation of butadiene, is less active in the hydrosilylation of substituted dienes than precatalyst 6. When it was attempted to carry out hydrosilylation using precatalyst 1 with substituted dienes, lower yields were obtained than when starting with precatalyst 6. It has been independently observed that the reaction of 5 with triethoxysilane to form 6 is cleaner in the presence of butadiene than in its absence, although the butadiene is not incorporated into the product (6). In combination, these observations suggest that catalyst activation benefits from the presence of an unhindered diene, and that substituted dienes are not able to confer this benefit as strongly as butadiene. To illustrate the difference in substituted diene hydrosilylation using precatalysts 1 vs. 6, information for both precatalysts for the hydrosilylation of isoprene is included herein.

Because precatalyst 6 exists in complex aggregation with MgCl₂(THF)₂, exact catalyst loadings for the following experiments could not be calculated. For the purpose of these experiments, the smallest possible molecular weight for each complex (calculated with 0.5 Mg²⁺ as the counter ion and 2 coordinated THF molecules) was assumed. As a consequence, the catalyst loadings reported in these procedures correspond to the highest catalyst loading possible for the mass of catalyst added.

3-methyl-butenyltriethoxysilane (S1)

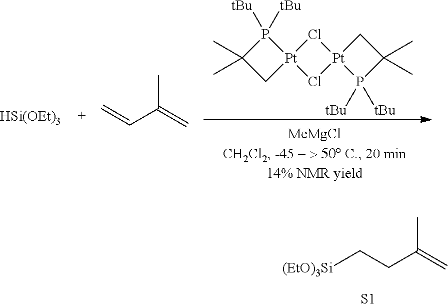

In an N₂-filled glovebox, [PtCl(CH₂CMe₂PtBu₂—C,P)]₂ (1) (2.9 mg, 3.30 μmol, 0.0033 equiv.) was charged in an sealable, screw-capped NMR tube and 0.3 mL of D₂-dichloromethane to form a clear, colorless solution. The reaction tube was chilled to −45° C. in a dry ice/isopropanol-cooled cold well, and MeMgCl (3.3 M in THF, 4.0 μL, 0.013 mmol, 0.0132 equiv.) was added, immediately freezing on the wall of the tube. The reaction tube was capped and shaken at room temperature for 90 seconds until the solution was homogeneous, then replaced in the cold well and stirred for 3 hours at −45° C. Isoprene (100 μL, 1.00 mmol, 1.0 equiv.), then triethoxysilane (185 μL, 1.00 mmol, 1.0 equiv.) were added and the reaction tube sealed, removed from the glovebox, and heated to 50° C. for 30 min in an oil bath. 1H NMR analysis indicated the reaction was not progressing so the temperature was increased to 75° C. overnight. 1H NMR analysis indicated the reaction generated a 14% yield of product S1 based on integration. The product was not isolated. 1H NMR (600 MHz, CD₂Cl₂) δ ppm 0.75 (s, 2H) 1.16-1.37 (m, 63H) 1.76 (s, 2H) 1.82-1.93 (m, 18H) 2.08-2.16 (m, 2H) 3.69-3.76 (m, 2H) 3.77-3.94 (m, 39H) 4.27 (s, 6H) 4.66-4.77 (m, 2H) 5.01 (d, J=12.33 Hz, 8H) 5.08 (d, J=10.56 Hz, 4H) 5.20 (d, J=17.02 Hz, 5H) 6.47 (dd, J=17.31, 10.86 Hz, 4H).

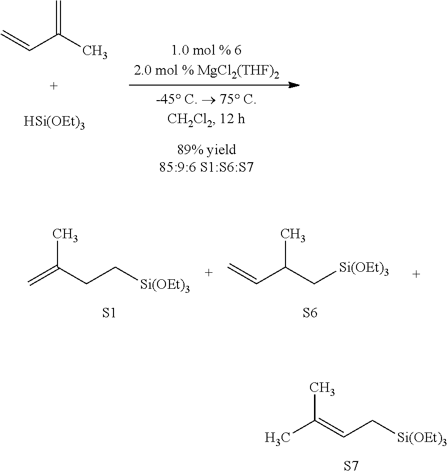

In another set of experiments, In a dry, N₂ filled glovebox, platinum complex 6 (15.8 mg, 24.0 μmol, 1.00 mol %), MgCl₂(THF)₂ (12.4 mg, 51.8 μmol, 2.16 mol %), a TEFLON-coated magnetic stirring bar, dichloromethane (2 mL), and tetrahydrofuran (10 L) were added to a 20 mL scintillation vial at 23° C. to form a white suspension. The reaction vial was chilled at −45° C. in a CO₂/iPrOH-cooled cold well for 30 min. Isoprene (240 μL, 163 mg, 2.40 mmol, 1.00 equiv.) and triethoxysilane (443 μL, 394 mg, 2.40 mmol, 1.00 equiv.) were added, and the reaction vial was capped with a polyethylene-lined cap and removed from the glovebox. The reaction mixture was stirred at 75° C. in a pre-heated aluminum heating block for 12 h. The vial was opened under ambient atmosphere and the solvent was removed by rotary evaporation. The product was purified by bulb-to-bulb distillation (145° C., 5 Torr) to afford the title compound as a colorless liquid (493 mg, 2.13 mmol, 89% yield). Ratio of S1:S6:S7 determined to be 15:2:1 by GC analysis (HP-5, 6 psi, Program 2): t_{R} (minor, S6)=12.15 (8.7), t_{R} (minor, S7)=14.1 (5.8), t_{R} (major, Si)=14.4 (85.5).

NMR Spectroscopy: ¹H NMR (600 MHz, CDCl₃, 25° C., 6): 5.90-5.80 (m)*, 5.21-5.12 (t, ³J_{H-H}=7.6 Hz)**, 4.97 (d, J_{H-H}=17.0 Hz)*, 4.85 (d, J_{H-H}=8.8 Hz)*, 4.70 (d, J_{H-H}=18.8 Hz, 1H), 3.83 (q, ³J_{H-H}=7.0 Hz, 6H), 2.42 (sept, ³J_{H-H}=6.5 Hz)*, 2.17-2.03 (m, 2H), 1.74 (s, 3H), 1.70 (s)**, 1.62 (s)**, 1.55 (d, ³J_{H-H}=8.2 Hz)**, 1.24 (t, ³J_{H-H}=8.8 Hz), 9H), 1.09 (d, ³J_{H-H}=7.0 Hz)*, 0.83-0.74 (m, 2H), 0.69 (d, ³J_{H-H}=8.2 Hz)*, 0.65 (d, ³J_{H-H}=7.6 Hz)*. ¹³C NMR (125 MHz, CDCl₃, 25° C., δ): 148.1, 108.6, 58.5, 30.7, 22.4, 18.5, 8.8. HRMS-FIA (m/z) calcd for C₁₁H₂₄O₃SiNa [M+Na]⁺, 255.1387. found, 255.1381. *Signals correspond to minor isomer triethoxy(2-methylbut-3-en-1-yl)silane (S6). **Signals correspond to minor isomer triethoxy(3-methylbut-2-en-1-yl)silane (S7).

In another set of experiments, in a dry, N₂-filled glovebox, platinum precatalyst 1 (10.4 mg, 12.0 mol, 0.50 mol %), a TEFLON-coated magnetic stirring bar, and dichloromethane (1.0 mL) were added to a 4 mL scintillation vial at −45° C. in a CO₂/ⁱPrOH-cooled cold well to form a clear, colorless solution. After chilling at −45° C. for 30 min., methylmagnesium chloride in THF (3.28 M, 14.6 L, 48.0 mol, 2.00 mol %) was added, and the reaction vessel was sealed with a TEFLON-lined cap and shaken for 90 seconds at 23° C. to dissolve frozen droplets of Grignard reagent. The vial was cooled at −45° C. for 2.5 hours, warmed at 23° C. for 30 min., and cooled at −45° C. for 20 min. Isoprene (241 L, 166 mg, 2.40 mmol, 1.00 equiv.) and triethoxysilane (443 L, 394 mg, 2.40 mmol, 1.00 equiv.) were added. The reaction vessel was resealed, removed from the glovebox, and heated to 75° C. in a pre-heated aluminum heating block for 12 hours. The vial was opened under ambient atmosphere, and the solvent was removed by rotary evaporation. The product was purified by bulb-to-bulb distillation (150° C., 5 Torr) to afford the title compound (S1+S6+S7 only, 363 mg, 1.56 mmol, 65% yield) as a mixture with residual triethoxysilane (12 w/w %). Ratio of S1:S6:S7 determined to be 17:1:1 by ¹H NMR integration of peaks in the olefinic region (5.18-5.14 ppm for triethoxy(3-methylbut-2-en-1-yl)silane (S7) signal corresponds to 1H; 4.97-4.94 for triethoxy(2-methylbut-3-en-1-yl)silane (S6) signal corresponds to 1H; 4.71-4.67 for 3-methyl-3-butenyltriethoxysilane (Si) signal corresponds to 2H).

(6,7-Dimethyl-3-methyleneoct-6-en-1-yl)triethoxysilane (S2)

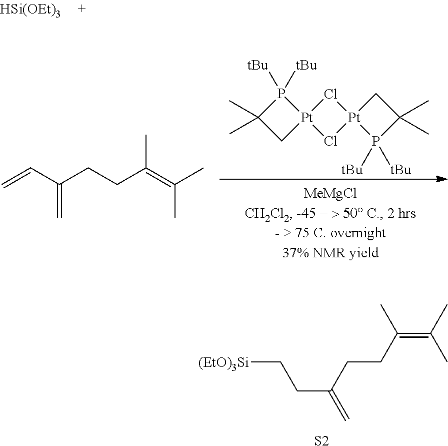

In an N₂-filled glovebox, [PtCl(CH₂CMe₂PtBu₂—C,P)]₂ (1) (2.9 mg, 3.31 μmol, 0.0033 equiv.) was charged in an sealable, screw-capped NMR tube and 0.3 mL of D₂-dichloromethane to form a clear, colorless solution. The reaction tube was chilled to −45° C. in a dry ice/isopropanol-cooled cold well and MeMgCl (3.3 M in THF, 4.0 μL, 13.2 μmol, 0.0132 equiv.) was added, immediately freezing on the wall of the tube. The reaction tube was capped and shaken at room temperature for 90 seconds until the solution was homogeneous, then replaced in the cold well and allowed to react for 3 hours at −45° C. Myrcene (172 μL, 1.00 mmol, 1.0 equiv.), then triethoxysilane (185 μL, 1.00 mmol, 1.0 equiv.) were added and the reaction tube sealed, removed from the glovebox, and heated to 50° C. for 20 min in an oil bath. 1H NMR analysis indicated the reaction was not progressing so the temperature was increased to 75° C. overnight. ¹H NMR analysis indicated the reaction had stalled at 37% yield of product S2 based on integration. The product was not isolated.

¹H NMR (500 MHz, CD₂Cl₂) δ ppm 0.75-0.85 (m, 2H) 1.20-1.35 (m, 23H) 1.62-1.82 (m, 18H) 2.02-2.35 (m, 15H) 3.80-3.96 (m, 12H) 4.31 (s, 1H) 4.64-4.86 (m, 3H) 5.05 (d, J=2.9 Hz, 3H) 5.10 (d, J=10.7 Hz, 1H) 5.15-5.26 (m, 2H) 5.29 (d, J=18.1 Hz, 1H) 6.36-6.49 (m, 1H).

Triethoxy(7-methyl-3-methyleneoct-6-en-1-yl)silane (9)

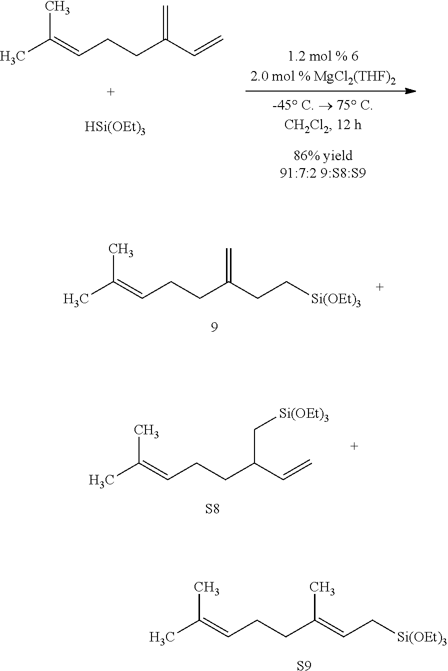

In a dry, N₂ filled glovebox, platinum complex 6 (16.1 mg, 24.4 mol, 1.02 mol %), MgCl₂(THF)₂ (12.2 mg, 51.0 μmol, 2.13 mol %), a TEFLON-coated magnetic stirring bar, dichloromethane (2 mL), and tetrahydrofuran (10 μL) were added to a 20 mL scintillation vial at 23° C. The reaction vial was chilled at −45° C. in a CO₂/iPrOH-cooled cold well for 30 min. Myrcene (414 μL (total), 329 mg, 2.10 mmol (myrcene only), 1.00 equiv.) and triethoxysilane (443 μL, 2.40 mmol, 1.00 equiv.) were added. The reaction vial was sealed with a polyethylene-lined cap and removed from the glovebox. The reaction mixture was stirred at 75° C. in a pre-heated aluminum heating block for 12 hours. The vial was opened under ambient atmosphere, and the solvent was removed by rotary evaporation. Purification by bulb-to-bulb distillation (200° C., 5 Torr) afforded the title compound as a colorless liquid (543 mg, 1.81 mmol, 89% yield). The commercial myrcene used in this experiment contains 15% other terpene isomers with identical mass and similar boiling point. Yield and catalyst loading are based on myrcene content of starting material only. Ratio of 9:S8:S9 determined to be 53:4:1 by GC analysis (HP-5, 6 psi, Program 2): t_{R} (minor, 8)=6.23 (7.6), t_{R} (major, 9)=6.67 (90.7), t_{R} (minor, S9)=8.78 (1.7).

NMR Spectroscopy: ¹H NMR (600 MHz, CDCl₃, 25° C., δ): 5.70-5.62 (m)*, 5.20 (td, J=8.0, 1.0 Hz)**, 5.15-5.07 (m, 1H), 5.04-4.91 (m)*, 4.76 (s, 1H), 4.70 (s, 1H), 3.81 (q, ³J_{H-H}=7.0 Hz, δH), 2.28-2.16 (m)*, 2.14-2.02 (m, 6H), 1.98-2.01 (m)**, 1.68 (s, 3H), 1.60 (s, 3H), 1.55 (d, J=8.0 Hz)**, 1.23 (t, ³J_{H-H}=7.0 Hz), 0.82-0.77 (m, 2H), 0.76-0.72 (m)*. ¹³C NMR (125 MHz, CDCl₃, 25° C., δ): 151.8, 131.6, 124.4, 107.7, 58.5, 36.0, 29.1, 26.7, 25.8, 18.4, 17.8, 8.6. HRMS-FIA (m/z) calcd for C₁₆H₃₂O₃SiNa [M+Na]⁺, 323.2022. found, 323.2013. *Signals correspond to minor isomer triethoxy(6-methyl-2-vinylhept-5-en-1-yl)silane (S8). **Signals correspond to minor isomer (E)-(3,7-dimethylocta-2,6-dien-1-yl)triethoxysilane (S9).

(2,3-Dimethylbut-3-en-1-yl)triethoxysilane (10)

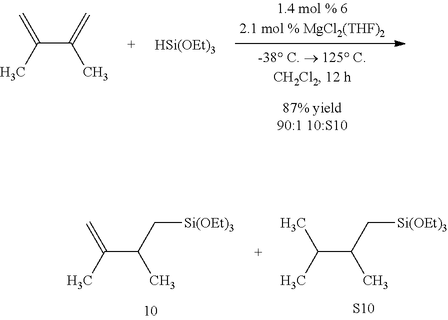

In a dry, N₂ filled glovebox, platinum complex 6 (21.4 mg, 32.4 mol, 1.35 mol %), MgCl₂(THF)₂ (12.1 mg, 50.5 mol, 2.10 mol %), a TEFLON-coated magnetic stirring bar, dichloroethane (2 mL), and tetrahydrofuran (10 L) were added to a 20 mL scintillation vial at 23° C. The reaction vial was chilled at −38° C. in a CO₂/iPrOH-cooled cold well for 30 min. 2,3-Dimethylbutadiene (274 μL, 198 mg, 2.40 mmol, 1.00 equiv.) and triethoxysilane (443 μL, 394 mg, 2.40 mmol, 1.00 equiv.) were added. The reaction vial was sealed with a polyethylene-lined cap and removed from the glovebox. The reaction mixture was stirred at 125° C. in a pre-heated aluminum heating block for 12 hours. The vial was opened under ambient atmosphere, and the solvent was removed by rotary evaporation. Purification by bulb-to-bulb distillation (110° C., 5 Torr) afforded the title compound as a colorless liquid (512 mg, 2.08 mmol, 87%). Ratio of 1,2-:1,4-addition determined to be 90:1 by GC analysis (HP-5, 6 psi, Program 2): t_{R} (major, 10)=4.29 (98.9), t_{R} (minor, S10)=4.48 (1.1).

NMR Spectroscopy: ¹H NMR (600 MHz, CDCl₃, 25° C., δ): 4.72 (s, 1H), 4.61 (s, 1H), 3.82 (q, ³J_{H-H}=7.0 Hz, δH), 2.46-2.39 (m, 2H), 1.70 (s, 3H), 1.23 (t, ³J_{H-H}=7.0 Hz, 9H), 0.88-0.64 (m, 2H). ¹³C NMR (125 MHz, CDCl₃, 25° C., δ): 152.6, 108.0, 58.4, 36.1, 22.0, 19.2, 18.4, 17.5. HRMS-FIA (m/z) calcd for C₁₂H₂₆O₃SiNa [M+Na]⁺, 269.1543. found, 269.1537.

Upon activation with methylmagnesium chloride, cyclometallated platinum complex 1⁹ catalyzes the selective 1,2-hydrosilylation of butadiene with 10:1 selectivity for the 1,2-addition product (Scheme 5) and a turn-over frequency (TOF) of 480/h at 50° C. Precatalyst 1 is air- and moisture-stable and can be used for catalysis without special purification. Activation of precatalyst 1 with methylmagnesium chloride (or other Grignard reagents, such as the ones described herein) is performed at −45° C. in dichloromethane, at which temperature transmetallation from the Grignard reagent proceeds more quickly than reaction with solvent. For hydrosilylation, diene and silane are added to the pre-activated catalyst solution and the vessel is sealed and heated to 50° C. until the reaction is complete. Butenylsilane products can be isolated by distillation of the reaction mixture without additional purification. No excess of diene or silane is necessary for hydrosilylation, but a slight excess of diene prevents isomerization of the 1,2-addition product to the thermodynamically favored 1,4-addition products after the reaction reaches full conversion. Selectivity for 1,2-addition versus 1,4-addition extends to substituted diene substrates and increases with diene substitution, reaching a maximum of 90:1 for 2,3-dimethylbutadiene (Scheme 5).

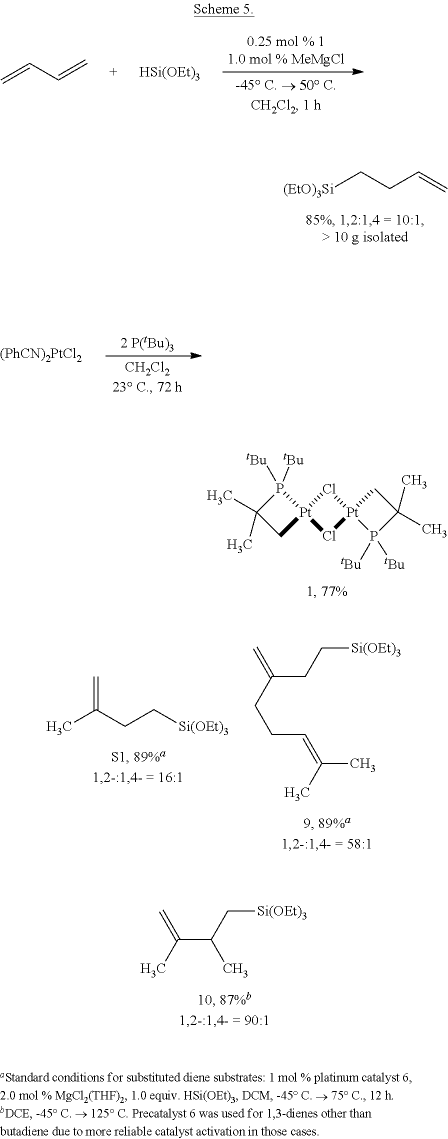

### Catalyst Activation

Activation of precatalyst 1 with two equivalents of methylmagnesium chloride at −45° C. generates electron-rich, anionic Pt(II) complex 5, which reacts with triethoxysilane to give platinate 6 (Scheme 6). Platinates 5 and 6 are isolable as air- and moisture-sensitive aggregates with MgCl₂(THF)₂ and have been characterized by ¹H, ¹³C, and ³¹P NMR spectroscopy as well as by X-ray diffraction (6). Both 5 and 6 are competent precatalysts for 1,2-selective hydrosilylation, which indicates that these complexes are intermediates on the catalyst activation pathway (Table 1A). Precatalyst 6 further reacts with triethoxysilane to form as yet unidentified products. Precatalyst 6 may further react with triethoxysilane by oxidative addition (E) to afford, after reductive elimination of methane (observed by GCMS), active catalyst A. Intermediate E has a second accessible C—H reductive elimination pathway available, which releases the cyclometallated arm of the phosphine ligand to form tri-tert-butylphosphine (observed by ³¹P NMR) and leads to catalyst decomposition (Scheme 6). Consistent with this analysis, formation of tri-tert-butylphosphine has been observed during the early stages of hydrosilylation for platinum precatalysts 1, 5, and 6. Although degradation of homogeneous precatalysts can sometimes generate catalytically-active metal nanoparticals,^{11c,12} addition of elemental mercury for the hydrosilylation reported here showed only a moderate effect on the observed selectivity and conversion using precatalyst 6 (Table 1A). It was concluded that similar activity and selectivity of the catalyst in the presence of elemental mercury is likely a consequence of a homogeneous, molecular catalyst as the active species. However, because all precatalysts showed significant decomposition during activation, it was difficult to obtain reproducible kinetic data to determine a rate law. Therefore, it is to be determined as to the turnover-limiting step or the reversibility of proposed steps on the catalytic cycle.

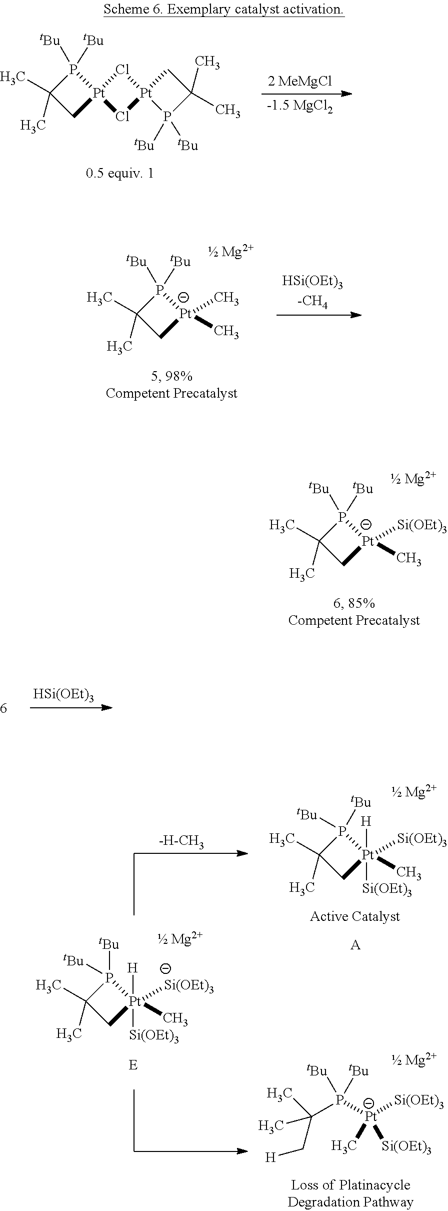

Detection of CH₄.

In the activation pathway of precatalyst 6 for catalysis, oxidative addition of triethoxysilane followed by reductive elimination of methane to form the active catalyst (A) is proposed. To provide support for this activation mechanism, precatalyst 6 was mixed with triethoxysilane and sampled the headspace of the reaction to analyze the methane content by GCMS. Because of the difficulties in separating the gases by GCMS, all the gases present in the headspace elute as a single peak. Such gases commonly include N₂, O₂, H₂O, and other naturally occurring atmospheric gases. The quantity of a single component can be analyzed by integrating the spectrum observed at a single m/z value. For methane, the intensity of the m/z=16 peak in the GCMS spectrum was measured. Oxygen can also give rise to m/z=16 when ionized to O₂²⁺, but this ionization state is much less abundant than O₂⁺, which shows m/z=32. Methane can be detected by comparing the integration of m/z=16 to m/z=32 in the sample compared to a background atmospheric measurement. If methane is present, an enrichment in m/z=16 in the headspace of the reaction compared to that of naturally occurring atmospheric O₂ is observed. Background spectrum was analyzed as follows: in a dry, N₂-filled glovebox a 4 mL scintillation vial was sealed with a cap containing a TEFLON-lined rubber septum; and the vial was removed from the glovebox and a sample of the gas from this vial was analyzed by GCMS (m/z 16/32=0.051). The reaction headspace was analyzed as follows: in a dry, N₂-filled glovebox precatalyst 6 (22.5 mg, 26.0 μmol, 1.00 equiv.), a TEFLON-coated magnetic stirring bar, and dichloromethane-d₂ (0.5 mL) were added to a 4 mL scintillation vial to form a clear, pale yellow solution; the reaction vial was cooled for 30 min. at −45° C. in a CO₂/ⁱPrOH-cooled cold well before adding triethoxysilane (20 μL, 18 mg, 0.11 mmol, 4.1 equiv.); the reaction vial was sealed with a mininert cap containing a butyl rubber septum, removed from the glovebox, and heated to 50° C. in a pre-heated aluminum heating block for 45 min; and after cooling the reaction vial at 23° C. for 30 min., a 50 μL gastight syringe was flushed with the headspace atmosphere three times before 3.5 μL of gas from the headspace was analyzed by GCMS (m/z 16/32=0.94). The results are shown in Table 1.

TABLE 1
Content of CH₄ generated by a reaction using
precatalyst 6 and triethoxysilane measured by GCMS.

| | (Area of peak at m/z 16)/ |
|---|---|
| Sample | (area of peak at m/z 32) |
| Headspace of 6 + HSi(OEt)₃ | 0.94 |
| N₂ (Control) | 0.051 |

TABLE 1A
Performance of platinate and Pt(0) Precatalysts.

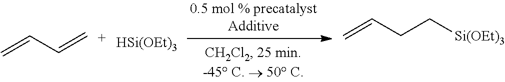

| | | | 1,2:1,4 |
|---|---|---|---|
| Precatalyst | Additive | Yield^{a,b} | selectivity^{a} |
| 1 | MeMgCl | 86%^{c} | 10:1 |
| standard conditions | | | |
| 5 | MgCl₂(THF)₂^{d} | 64% | 9:1 |
| 6 | none | 10% | 3:1 |
| | MgCl₂(THF)₂^{d} | 60% | 9:1 |
| | 1,4-Dioxane | 2% | 3:1 |
| | Hg⁰ + MgCl₂(THF)₂ | 52% | 8:1 |
| 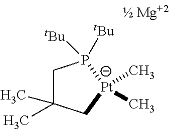 | MgCl₂(THF)₂^{d} | 28% | 9:1 |
| 7 | | | |
| 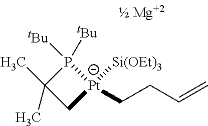 | MgCl₂(THF)₂^{d} | 65% | 10:1 |
| 8 | | | |
| 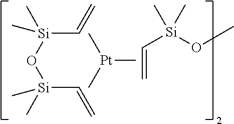 | None | 10% | 1:10 |
| Karstedt's Catalyst | P(t-Bu)₃ | 3% | 1:8 |

^{a}Yield and selectivity determined by integration of the ¹H NMR resonances corresponding to the alkenyl hydrogen atoms vs. hexamethyldisiloxane as internal standard.
^{b}Reaction yield corresponds to reaction conversion as no other products are observed.
^{c}Isolated yield. Reaction stopped by addition of N,N′-dimethylethylenediamine after 25 min.
^{d}Addition of MgCl₂(THF)₂ to reactions with isolated platinate complexes simulates conditions for catalysis with precatalyst 1.

For the purpose of Table 1A, because precatalysts 5-7 exist as aggregates with MgCl₂(THF)₂, the exact catalyst loading could not be precisely calculated. Thus, the smallest possible molecular weight for each complex (calculated with 0.5 Mg²⁺ as the counter ion and the number of THF molecules observed in the 1H NMR spectrum of the isolated complex) was assumed. As a consequence, the catalyst loadings reported in Table 1A correspond to the upper limit of possible catalyst loadings.

Precatalyst 1 for the Purpose of Table 1A.

In a dry, N₂-filled glovebox, platinum precatalyst 1 (2.6 mg, 3.0 μmol, 0.25 mol %) and dichloromethane-d₂ (0.5 mL) were added to a J. Young NMR tube to form a clear, colorless solution. After chilling at −45° C. in a CO₂/ⁱPrOH-cooled cold well for 30 min., methylmagnesium chloride in THF (3.28 M, 3.6 μL, 10 μmol, 1.0 mol %) was added and the reaction tube was sealed and shaken for 90 seconds at 23° C. to dissolve frozen droplets of Grignard reagent. The tube was cooled at −45° C. for 3 hours, warmed at 23° C. for 30 min., and cooled at −45° C. for 30 min. Butadiene (100 μL, 64.0 mg, 1.18 mmol, 1.00 equiv.) and triethoxysilane (218 μL, 194 mg, 1.18 mmol, 1.00 equiv.) were added. The reaction tube was resealed, removed from the glovebox, and heated to 50° C. in a pre-heated oil bath for 25 min. before the reaction progress was measured by ¹H NMR. By ¹H NMR integration of alkenyl signals, 89% conversion to butenylsilane products was observed. The reaction tube was unsealed and N,N′-dimethylethylenediamine (10 μL) was added. The contents of the reaction tube were decanted into a 20 mL scintillation vial, and the solvent was removed by rotary evaporation. The product was purified by column chromatography on silica gel (10% v/v EtOAc/hexanes, R_{f}=0.5) to yield a colorless oil (0.222 g, 1.02 mmol, 86% yield). Ratio of 1,2-:1,4-addition determined to be 10:1 by ¹H NMR integration of signals corresponding to alkenyl protons (5.96-5.86 ppm for 3-butenyltriethoxysilane signal corresponds to 1H; 5.49-5.37 for 2-butenyltriethoxysilanes, overlapping signals correspond to 2H).

Precatalyst 5 for the Purpose of Table 1A.

In a dry, N₂-filled glovebox, platinum precatalyst 5 (3.2 mg, 5.9 μmol, 0.50 mol %), MgCl₂(THF)₂ (2.8 mg, 24 mol, 2.0 mol %), a TEFLON-coated magnetic stirring bar, dichloromethane (0.5 mL), and tetrahydrofuran (10 μL) were added to a 4 mL scintillation vial at 23° C. The vial was chilled at −45° C. in a CO₂/ⁱPrOH-cooled cold well for 30 min. Butadiene (100 μL, 64.0 mg, 1.18 mmol, 1.00 equiv.) and triethoxysilane (218 μL, 194 mg, 1.18 mmol, 1.00 equiv.) were added, and the reaction vial was sealed with a TEFLON-lined cap, removed from the glovebox, and heated to 50° C. in a pre-heated aluminum heating block for 25 min. The vial was opened under ambient atmosphere, and TMS₂O (10 μL, 7.6 mg, 47 μmol, 4.0 mol %) and benzene-d₆ (100 μL) were added. The contents of the reaction vial were mixed thoroughly and transferred to an NMR tube. Ratio of 1,2-:1,4-addition determined to be 10:1 by ¹H NMR integration of signals corresponding to alkenyl protons (5.96-5.86 ppm for 3-butenyltriethoxysilane signal corresponds to 1H; 5.49-5.37 for 2-butenyltriethoxysilanes, overlapping signals correspond to 2H). Yield determined by addition of 1H NMR signal integrations for butenylsilane products (full integration for 3-butenyltriethoxysilane+½ integration for 2-butenyltriethoxysilanes) in comparison to the TMS₂O signal at 0 ppm (integral set to 71.5 to show integrals as molar percents).

Precatalyst 6 for the Purpose of Table 1A.

In a dry, N₂-filled glovebox, platinum precatalyst 6 (3.9 mg, 5.9 μmol, 0.5 mol %), MgCl₂(THF)₂ (5.6 mg, 24 μmol, 2.0 mol %), a TEFLON-coated magnetic stirring bar, dichloromethane (0.5 mL), and tetrahydrofuran (10 μL) were added to a 4 mL scintillation vial at 23° C. The vial was chilled at −45° C. in a CO₂/ⁱPrOH-cooled cold well for 30 min. Butadiene (100 μL, 64.0 mg, 1.18 mmol, 1.00 equiv.) and triethoxysilane (218 μL, 194 mg, 1.18 mmol, 1.00 equiv.) were added, and the reaction vial was sealed with a TEFLON-lined cap, removed from the glovebox, and heated to 50° C. in a pre-heated aluminum heating block for 25 min. The reaction vial was opened under ambient atmosphere, and TMS₂O (10 μL, 47 μmol, 4.0 mol %) and benzene-d₆ (100 μL) were added. The contents of the reaction vial were mixed thoroughly and transferred to an NMR tube. Ratio of 1,2-:1,4-addition determined to be 9:1 by 1H NMR integration of signals corresponding to alkenyl protons (5.96-5.86 ppm for 3-butenyltriethoxysilane signal corresponds to 1H; 5.49-5.37 for 2-butenyltriethoxysilanes, overlapping signals correspond to 2H). Yield determined as 64% by addition of 1H NMR signal integrations for butenylsilane products (full integration for 3-butenyltriethoxysilane+½ integration for 2-butenyltriethoxysilanes) in comparison to the TMS₂O signal at 0 ppm (integral set to 71.5 to show integrals as molar percents).

Precatalyst 6, No Additive, for the Purpose of Table 1A.

In a dry, N₂-filled glovebox, platinum precatalyst 6 (3.9 mg, 5.9 μmol, 0.50 mol %), MgCl₂(THF)₂ (5.6 mg, 24 μmol, 2.0 mol % equiv.), a TEFLON-coated magnetic stirring bar, dichloromethane (0.5 mL), and tetrahydrofuran (10 μL) were added to a 4 mL scintillation vial at 23° C. The vial was chilled at −45° C. in a CO₂/ⁱPrOH-cooled cold well for 30 min. Butadiene (100 μL, 64.0 mg, 1.18 mmol, 1.00 equiv.) and triethoxysilane (218 μL, 194 mg, 1.18 mmol, 1.00 equiv.) were added, and the reaction vial was sealed with a TEFLON-lined cap, removed from the glovebox, and heated to 50° C. in a pre-heated aluminum heating block for 25 min. The reaction vial was opened under ambient atmosphere and TMS₂O (10 μL, 7.6 mg, 47 μmol, 4.0 mol %) and benzene-d₆ (100 μL) were added. The contents of the reaction vial were mixed thoroughly and transferred to an NMR tube. Ratio of 1,2-:1,4-addition determined to be 9:1 by ¹H NMR integration of signals corresponding to alkenyl protons (5.96-5.86 ppm for 3-butenyltriethoxysilane signal corresponds to 1H; 5.49-5.37 for 2-butenyltriethoxysilanes, overlapping signals correspond to 2H). Yield determined as 10% by addition of ¹H NMR signal integrations for butenylsilane products (full integration for 3-butenyltriethoxysilane+½ integration for 2-butenyltriethoxysilanes) in comparison to the TMS₂O signal at 0 ppm (integral set to 71.5 to show integrals as molar percents).

Precatalyst 6, 1,4-Dioxane Added, for the Purpose of Table 1A.

In a dry, N₂-filled glovebox, platinum precatalyst 6 (3.9 mg, 5.9 μmol, 0.50 mol %), MgCl₂(THF)₂ (5.6 mg, 24 μmol, 2.0 mol %), a TEFLON-coated magnetic stirring bar, dichloromethane (0.5 mL), and 1,4-dioxane (10 μL, 10 mg, 0.12 mmol, 9.9 mol %) were added to a 4 mL scintillation vial at 23° C. The reaction vial was chilled at −45° C. in a CO₂/ⁱPrOH-cooled cold well for 30 min. Butadiene (100 μL, 64.0 mg, 1.18 mmol, 1.00 equiv.) and triethoxysilane (218 μL, 194 mg, 1.18 mmol, 1.00 equiv.) were added, and the reaction vial was sealed with a TEFLON-lined cap, removed from the glovebox, and heated to 50° C. in a pre-heated aluminum heating block for 25 min. The reaction vial was opened under ambient atmosphere, and TMS₂O (10 μL, 7.6 mg, 47 μmol, 4.0 mol %) and benzene-d₆ (100 μL) were added. The contents of the reaction vial were mixed thoroughly and transferred to an NMR tube. Ratio of 1,2-:1,4-addition determined to be 3:1 by ¹H NMR integration of signals corresponding to alkenyl protons (5.96-5.86 ppm for 3-butenyltriethoxysilane signal corresponds to 1H; 5.49-5.37 for 2-butenyltriethoxysilanes, overlapping signals correspond to 2H). Yield determined to be 2% by addition of ¹H NMR signal integrations for butenylsilane products (full integration for 3-butenyltriethoxysilane+½ integration for 2-butenyltriethoxysilanes) in comparison to the TMS₂O signal at 0 ppm (integral set to 71.5 to show integrals as molar percents).

Precatalyst 6, Hg Added, for the Purpose of Table 1A.

In a dry, N₂-filled glovebox, platinum precatalyst 6 (3.9 mg, 5.9 μmol, 0.50 mol %), MgCl₂(THF)₂ (5.6 mg, 24 μmol, 2.0 mol %), a TEFLON-coated magnetic stirring bar, dichloromethane (0.5 mL), and tetrahydrofuran (10 μL) were added to a 4 mL scintillation vial at 23° C. The vial was chilled to −45° C. in a CO₂/ⁱPrOH-cooled cold well for 30 min. Elemental mercury (5 drops) was added to the reaction vial. Butadiene (100 μL, 64.0 mg, 1.18 mmol, 1.00 equiv.) and triethoxysilane (218 μL, 194 mg, 1.18 mmol, 1.00 equiv.) were added, and the reaction vial was sealed with a TEFLON-lined cap, removed from the glovebox, and heated to 50° C. in a pre-heated aluminum heating block for 25 min. The reaction vial was opened under ambient atmosphere, and TMS₂O (10 μL, 7.6 mg, 47 μmol, 4.0 mol %) and benzene-d₆ (100 μL) were added. The contents of the reaction vial were mixed thoroughly and transferred to an NMR tube. Ratio of 1,2-:1,4-addition determined to be 8:1 by 1H NMR integration of signals corresponding to alkenyl protons (5.96-5.86 ppm for 3-butenyltriethoxysilane signal corresponds to 1H; 5.49-5.37 for 2-butenyltriethoxysilanes, overlapping signals correspond to 2H). Yield was determined as 52% by addition of ¹H NMR signal integrations for butenylsilane products (full integration for 3-butenyltriethoxysilane+½ integration for 2-butenyltriethoxysilanes) in comparison to the TMS₂O signal at 0 ppm (integral set to 71.5 to show integrals as molar percents).

Precatalyst 7 for the Purpose of Table 1A.

In a dry, N₂-filled glovebox, platinum precatalyst 7 (3.9 mg, 5.9 μmol, 0.50 mol %), MgCl₂(THF)₂ (5.6 mg, 24 mol, 2.0 mol %), a TEFLON-coated magnetic stirring bar, dichloromethane (0.5 mL), and tetrahydrofuran (10 μL) were added to a 4 mL scintillation vial at 23° C. The vial was chilled at −45° C. in a CO₂/ⁱPrOH-cooled cold well for 30 min. Butadiene (100 μL, 64.0 mg, 1.18 mmol, 1.00 equiv.) and triethoxysilane (218 μL, 194 mg, 1.18 mmol, 1.00 equiv.) were added, and the reaction vial was sealed with a TEFLON-lined cap, removed from the glovebox, and heated to 50° C. in a pre-heated aluminum heating block for 25 min. The reaction vial was opened under ambient atmosphere, and TMS₂O (10 μL, 7.6 mg, 47 μmol, 4.0 mol %) and benzene-d₆ (100 μL) were added. The contents of the reaction vial were mixed thoroughly and transferred to an NMR tube. Ratio of 1,2-: 1,4-addition determined to be 9:1 by ¹H NMR integration of signals corresponding to alkenyl protons (5.96-5.86 ppm for 3-butenyltriethoxysilane signal corresponds to 1H; 5.49-5.37 for 2-butenyltriethoxysilanes, overlapping signals correspond to 2H). Yield determined as 28% by addition of ¹H NMR signal integrations for butenylsilane products (full integration for 3-butenyltriethoxysilane+½ integration for 2-butenyltriethoxysilanes) in comparison to the TMS₂O signal at 0 ppm (integral set to 71.5 to show integrals as molar percents).

Precatalyst 8 for the Purpose of Table 1A.

Precatalyst 8 was formed from S3 and butenylmagnesium chloride in CH₂Cl₂, observed by ¹H and ³¹P NMR, and used in catalysis without isolation.

Formation of Precatalyst 8.

In a dry, N₂-filled glovebox, platinum complex S3 (3.6 mg, 5.9 μmol, 0.50 mol %) was added to a 4 mL scintillation vial and chilled for 30 min. at −45° C. in a CO₂/ⁱPrOH-cooled cold well. Pre-cooled dichloromethane-d₂ (0.5 mL) was added to the vial to form a pale yellow solution. But-3-enylmagnesium chloride in THF (1.36 M, 4.4 μL, 5.9 μmol, 0.50 mol %) was added, and the vial sealed with a TEFLON-lined cap and shaken for 90 seconds at 23° C. to dissolve frozen droplets of Grignard reagent. The solution was stirred for 30 min at −45° C. then transferred to a pre-cooled NMR tube which was sealed with a TEFLON-lined cap and removed from the glovebox. ¹H and ³¹P analysis confirmed formation of precatalyst 8.

Hydrosilylation of Butadiene with Precatalyst 8.

The NMR tube was brought into a dry, N₂-filled glovebox and chilled for 30 min. at −45° C. in a CO₂/ⁱPrOH-cooled cold well before butadiene (100 μL, 64.0 mg, 1.18 mmol, 1.00 equiv.) and triethoxysilane (218 μL, 194 mg, 1.18 mmol, 1.00 equiv.) were added. The reaction tube was sealed with a TEFLON-lined cap, removed from the glovebox, and heated to 50° C. in a pre-heated oil bath for 25 min. The reaction vial was opened under ambient atmosphere, and TMS₂O (10 μL, 7.6 mg, 47 μmol, 4.0 mol %) and benzene-d₆ (100 μL) were added. Ratio of 1,2-:1,4-addition determined to be 10:1 by ¹H NMR integration of signals corresponding to alkenyl protons (5.96-5.86 ppm for 3-butenyltriethoxysilane signal corresponds to 1H; 5.49-5.37 for 2-butenyltriethoxysilanes, overlapping signals correspond to 2H). Yield determined as 65% by addition of ¹H NMR signal integrations for butenylsilane products (full integration for 3-butenyltriethoxysilane+½ integration for 2-butenyltriethoxysilanes) in comparison to the TMS₂O signal at 0 ppm (integral set to 71.5 to show integrals as molar percents).

Karstedt's Catalyst for the Purpose of Table 1A.

In a dry, N₂-filled glovebox, Karstedt's catalyst (37.8 mg, 3 w/w % Pt in vinyl-terminated polydimethylsiloxane, 5.90 mol, 0.500 mol %), a TEFLON-coated magnetic stirring bar, dichloromethane (0.5 mL), and tetrahydrofuran (10 μL) were added to a 4 mL scintillation vial at 23° C. The vial was chilled at −45° C. in a CO₂/ⁱPrOH-cooled cold well for 30 min. Butadiene (100 μL, 64.0 mg, 1.18 mmol, 1.00 equiv.) and triethoxysilane (218 μL, 194 mg, 1.18 mmol, 1.00 equiv.) were added, and the reaction vial was sealed with a TEFLON-lined cap, removed from the glovebox, and heated to 50° C. in a pre-heated aluminum heating block for 25 min. The reaction vial was opened under ambient atmosphere, and TMS₂O (10 μL, 7.6 mg, 47 μmol, 4.0 mol %) and benzene-d₆ (100 μL) were added. The contents of the reaction vial were mixed thoroughly and transferred to an NMR tube. Ratio of 1,2-: 1,4-addition determined to be 1:10 by ¹H NMR integration of signals corresponding to alkenyl protons (5.96-5.86 ppm for 3-butenyltriethoxysilane signal corresponds to 1H; 5.49-5.37 for 2-butenyltriethoxysilanes, overlapping signals correspond to 2H). Yield determined as 10% by addition of 1H NMR signal integrations for butenylsilane products (full integration for 3-butenyltriethoxysilane+½ integration for 2-butenyltriethoxysilanes) in comparison to the TMS₂O signal at 0 ppm (integral set to 71.5 to show integrals as molar percents).

Karstedt's Catalyst, P(^{t}Bu)₃ Added, for the Purpose of Table 1A.

In a dry, N₂-filled glovebox, platinum precatalyst 6 (37.8 mg, 3 w/w % Pt in vinyl-terminated siloxane polymer, 5.9 μmol, 0.500 mol %), P(^{t}Bu)₃ (1.2 mg, 5.9 μmol, 0.50 mol %), a TEFLON-coated magnetic stirring bar, dichloromethane (0.5 mL), and tetrahydrofuran (10 μL) were added to a 4 mL scintillation vial at 23° C. The vial was chilled at −45° C. in a CO₂/ⁱPrOH-cooled cold well for 30 min. Butadiene (100 μL, 64.0 mg, 1.18 mmol, 1.00 equiv.) and triethoxysilane (218 μL, 194 mg, 1.18 mmol, 1.00 equiv.) were added, and the reaction vial was sealed with a TEFLON-lined cap, removed from the glovebox, and heated to 50° C. in a pre-heated aluminum heating block for 25 min. The reaction vial was opened under ambient atmosphere, and TMS₂O (10 μL, 7.6 mg, 47 μmol, 4.0 mol %) and benzene-d₆ (100 μL) were added. The contents of the reaction vial were mixed thoroughly and transferred to an NMR tube. Ratio of 1,2-:1,4-addition determined to be 1:8 by 1H NMR integration of signals corresponding to alkenyl protons (5.96-5.86 ppm for 3-butenyltriethoxysilane signal corresponds to 1H; 5.49-5.37 for 2-butenyltriethoxysilanes, overlapping signals correspond to 2H). Yield determined as 3% by addition of ¹H NMR signal integrations for butenylsilane products (full integration for 3-butenyltriethoxysilane+½ integration for 2-butenyltriethoxysilanes) in comparison to the TMS₂O signal at 0 ppm (integral set to 71.5 to show integrals as molar percents).

The data suggest that the magnesium counterion plays an active role in catalysis. In situ generation of precatalyst 6 during catalysis results in a visibly homogeneous solution, whereas at the higher concentrations employed during isolation of 6, MgCl₂(THF)₂ precipitated and was removed by filtration. X-ray data show that more than one aggregate of 6 with MgCl₂(THF)₂ can be formed under different conditions, such as the ones described herein. Aggregation with fewer magnesium atoms may explain why isolated precatalyst 6 shows significantly reduced activity and selectivity in the hydrosilylation of butadiene (Table 1A). Notably, much of the loss in activity and selectivity can be recovered by adding MgCl₂(THF)₂ to reactions catalyzed by isolated 6. The slight difference in yield with 6+MgCl₂(THF)₂ compared to the in situ generated catalyst (from 1+2 MeMgCl) may be contributed to the low solubility of magnesium salts in the chlorinated solvents used in hydrosilylation. Addition of ligand-quantities of 1,4-dioxane, which is known to bind strongly to Mg²⁺ and cause the precipitation of magnesium halide salts,¹³ dramatically reduces conversion in the hydrosilylation of butadiene with 6 (Table 1A).

### Rate Comparison of Precatalysts 5 and 7

To support that precatalyst 5 exhibits a faster rate than precatalyst 7 in the hydrosilylation of butadiene, the conversion vs. time was measured using the two precatalysts under identical conditions.

Precatalyst 5.

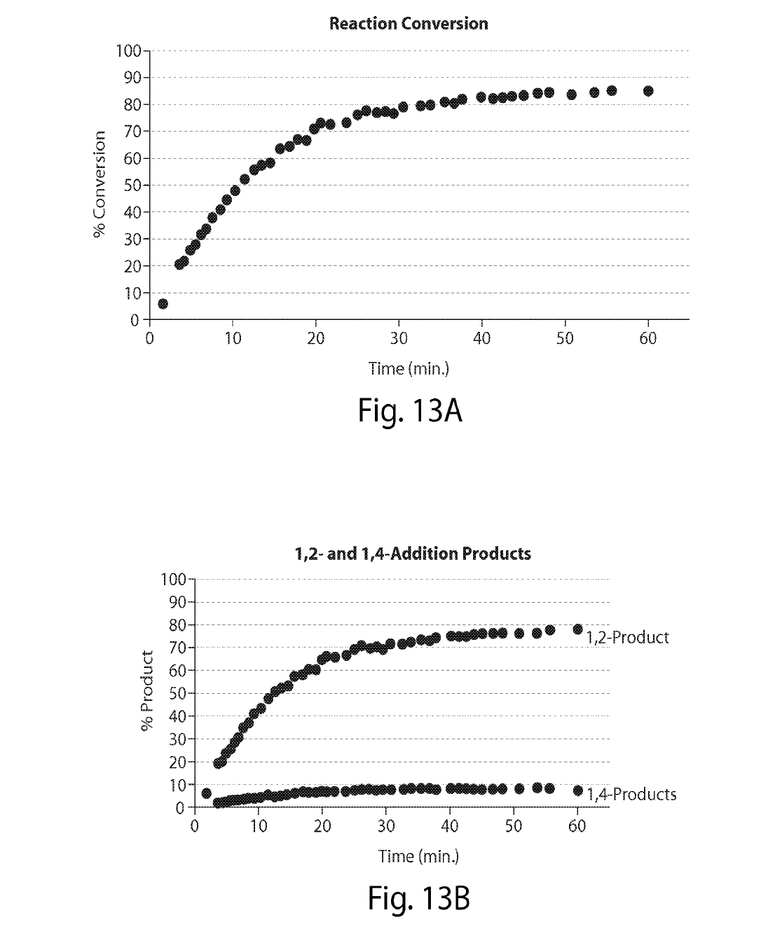

In a dry, N₂-filled glovebox, platinum precatalyst 5 (6.5 mg, 12 μmol, 1.0 mol %), MgCl₂(THF)₂ (5.6 mg, 24 μmol, 2.0 mol %), dichloromethane-d₂ (0.5 mL), tetrahydrofuran (10 μL), and hexamethyldisiloxane (internal standard, 10 μL, 7.6 mg, 47 μmol, 4.0 mol %) were added to a 4 mL scintillation vial at 23° C. The vial was chilled at −45° C. in a CO₂/ⁱPrOH-cooled cold well for 30 min. Butadiene (120 μL, 77.0 mg, 1.42 mmol, 1.20 equiv.) and triethoxysilane (218 μL, 194 mg, 1.18 mmol, 1.00 equiv.) were added, and the reaction mixture was transferred to a pre-cooled J. Young NMR Tube and sealed with a TEFLON cap. The tube was removed from the glovebox and cooled at 0° C. for approximately 5 minutes before inserting into a 600 MHz NMR spectrometer pre-heated to 50° C. Insertion time corresponds to time=0 for kinetic measurements. ¹H NMR spectra were collected approximately each minute for 1 hour, at which point no triethoxysilane was observed in the ¹H NMR spectrum of the reaction. Integration of ¹H NMR signals in the olefinic region (5.96-5.86 ppm for 3-butenyltriethoxysilane signal corresponds to 1H; 5.49-5.37 for 2-butenyltriethoxysilanes, overlapping signals correspond to 2H) were used to determine yield of 1,2- and 1,4-addition products, in comparison to the integration of the signal at 0 ppm corresponding to TMS₂O. Exemplary results are shown in FIGS. 13A-13B.

Precatalyst 7.

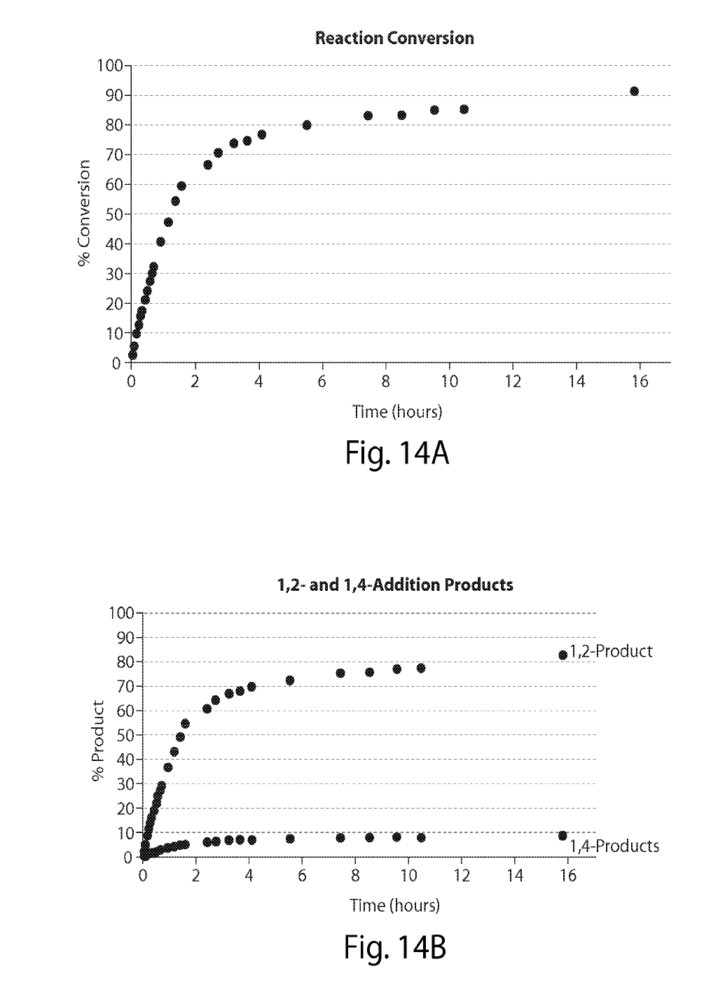

In a dry, N₂-filled glovebox, platinum precatalyst 7 (7.2 mg, 12 μmol, 1.0 mol %), MgCl₂(THF)₂ (5.8 mg, 24 μmol, 2.0 mol %), dichloromethane-d₂ (0.5 mL), and tetrahydrofuran (10 μL) were added to a 4 mL scintillation vial at 23° C. The vial was cooled at −45° C. in a CO₂/ⁱPrOH-cooled cold well for 30 min. Butadiene (120 μL, 77.0 mg, 1.42 mmol, 1.20 equiv.), triethoxysilane (218 μL, 194 mg, 1.18 mmol, 1.00 equiv.) and hexamethyldisiloxane (internal standard, 10 μL, 7.6 mg, 47 μmol, 4.0 mol %) were added, and the reaction mixture was transferred to a pre-cooled NMR Tube that was sealed with a TEFLON-lined cap. The reaction tube was removed from the glovebox and inserted into a 600 MHz NMR spectrometer pre-heated to 50° C. Insertion time corresponds to time=0 for kinetic measurements. ¹H NMR spectra were collected periodically for 16 hours, at which point >90% conversion was observed in the ¹H NMR spectrum of the reaction. Integration of 1H NMR signals in the olefinic region (5.94-5.88 ppm for 3-butenyltriethoxysilane signal corresponds to 1H; 5.48-5.38 for 2-butenyltriethoxysilanes, overlapping signals correspond to 2H) were used to determine yield of 1,2- and 1,4-addition products, in comparison to the integration of the signal at 0 ppm corresponding to TMS₂O. Exemplary results are shown in FIGS. 14A-14B.

Test of Butenylsilane Reductive Elimination from Precatalyst 8

To further support that precatalyst 8 is not an intermediate on the catalytic cycle, precatalyst 8 was tested to see if reductive elimination of butenylsilane is facile under conditions that mimic those present during hydrosilylation. Although some decomposition of precatalyst 8 was observed, the bulk of the material was stable in solution at 50° C., indicating that the rate of reductive elimination from 8 is much slower than the rate of catalysis. From these data, as well as those presented for precatalyst 8 in hydrosilylation in Table S1, it is concluded that precatalyst 8 cannot be an intermediate on the catalytic cycle.

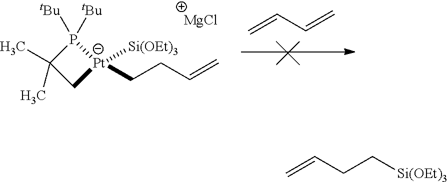

In a dry, N₂-filled glovebox, platinum complex S3 (10.2 mg, 17.0 μmol, 1.0 equiv.) was added to a 4 mL scintillation vial and chilled for 30 min. at −45° C. in a CO₂/ⁱPrOH-cooled cold well. Pre-cooled dichloromethane-d₂ (0.5 mL) was added to the vial to form a pale yellow solution. But-3-enylmagnesium chloride in THF (1.36 M, 13 μL, 18 μmol, 1.04 equiv.) was added and the vial sealed with a TEFLON-lined cap and shaken for 90 seconds at 23° C. to dissolve frozen droplets of Grignard reagent. The solution was stirred for 30 min at −45° C., at 23° C. for 30 min and then recooled at −45° C. for 30 min. Butadiene was added (20 μL) and the solution was transferred to a pre-cooled NMR tube which was sealed with a TEFLON-lined cap and removed from the glovebox. The NMR tube was heated to 50° C. in a 400 MHz NMR spectrometer and the ³¹P NMR spectrum was measured after 5 min. showing precatalyst 8 as the major species.

### Comparison of Reductants

The use of Grignard reagent reductants is necessary for catalysis of hydrosilylation by precatalyst 1. To elucidate the role of the reductant and especially the counterion, the rate and selectivity of hydrosilylation with 1 is compared using different alkyl metal reductants to activate the precatalyst. Exemplary results are summarized in Table 2 and are detailed herein.

TABLE 2
Reductant optimization.

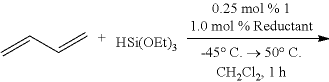

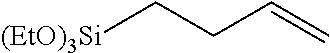

| Reductant | Yield | Ratio of 1,2-:1,4-addition |
|---|---|---|
| MeMgCl | 86% | 10:1 |
| MeLi | 5% | 1:1 |
| BnK | 19% | 1:1 |
| EtMgCl | 57% | 9:1 |
| PhMgCl | 55% | 9:1 |

Methyllithium.

In a dry, N₂-filled glovebox, platinum precatalyst 1 (2.6 mg, 3.0 μmol, 0.25 mol %) and dichloromethane (0.5 mL) were added to a 4 mL scintillation vial to form a clear, colorless solution. After chilling at −45° C. in a CO₂/ⁱPrOH-cooled cold well for 30 min., methyllithium in Et₂O (0.76 M, 16 μL, 12 μmol, 1.0 mol %) was added and the reaction tube was sealed and shaken for 90 seconds at 23° C. The vial was cooled at −45° C. for 3 hours, warmed at 23° C. for 30 min., and cooled at −45° C. for 30 min. Butadiene (100 μL, 64.0 mg, 1.18 mmol, 1.00 equiv.) and triethoxysilane (218 μL, 194 mg, 1.18 mmol, 1.00 equiv.) were added. The reaction tube was resealed, removed from the glovebox, and heated to 50° C. in a pre-heated aluminum heating block for 25 min. The reaction vial was opened under ambient atmosphere, and TMS₂O (10 μL, 7.6 mg, 47 μmol, 4.0 mol %) and benzene-d₆ (100 μL) were added. The contents of the reaction vial were mixed thoroughly and transferred to an NMR tube. Ratio of 1,2-: 1,4-addition determined to be 1.1:1 by ¹H NMR integration of signals corresponding to alkenyl protons (5.96-5.86 ppm for 3-butenyltriethoxysilane signal corresponds to 1H; 5.49-5.37 for 2-butenyltriethoxysilanes, overlapping signals correspond to 2H). Yield determined as 5% by addition of 1H NMR signal integrations for butenylsilane products (full integration for 3-butenyltriethoxysilane+½ integration for 2-butenyltriethoxysilanes) in comparison to the TMS₂O signal at 0 ppm (integral set to 71.5 to show integrals as molar percents).

Benzylpotassium.

In a dry, N₂-filled glovebox, platinum precatalyst 1 (2.6 mg, 3.0 μmol, 0.25 mol %) and benzylpotassium (1.5 mg, 12 μmol, 1.0 mol %) were added to a 4 mL scintillation vial. After chilling at −45° C. in a CO₂/ⁱPrOH-cooled cold well for 30 min., dichloromethane (0.5 mL) was added and the reaction tube was sealed and shaken for 90 seconds at 23° C. The vial was cooled at −45° C. for 3 hours, warmed at 23° C. for 30 min., and cooled at −45° C. for 30 min. Butadiene (100 μL, 64.0 mg, 1.18 mmol, 1.00 equiv.) and triethoxysilane (218 μL, 194 mg, 1.18 mmol, 1.00 equiv.) were added. The reaction tube was resealed, removed from the glovebox, and heated to 50° C. in a pre-heated aluminum heating block for 25 min. The reaction vial was opened under ambient atmosphere, and TMS₂O (10 μL, 7.6 mg, 47 μmol, 4.0 mol %) and benzene-d₆ (100 μL) were added. The contents of the reaction vial were mixed thoroughly and transferred to an NMR tube. Ratio of 1,2-:1,4-addition determined to be 1.3:1 by 1H NMR integration of signals corresponding to alkenyl protons (5.96-5.86 ppm for 3-butenyltriethoxysilane signal corresponds to 1H; 5.49-5.37 for 2-butenyltriethoxysilanes, overlapping signals correspond to 2H). Yield determined as 19% by addition of ¹H NMR signal integrations for butenylsilane products (full integration for 3-butenyltriethoxysilane+½ integration for 2-butenyltriethoxysilanes) in comparison to the TMS₂O signal at 0 ppm (integral set to 71.5 to show integrals as molar percents).

Ethylmagnesium Chloride.

In a dry, N₂-filled glovebox, platinum precatalyst 1 (2.6 mg, 3.0 mol, 0.25 mol %) and dichloromethane (0.5 mL) were added to a 4 mL scintillation vial to form a clear, colorless solution. After chilling at −45° C. in a CO₂/ⁱPrOH-cooled cold well for 30 min., ethylmagnesium chloride in THF (2.0 M, 5.9 μL, 12 μmol, 1.0 mol %) was added and the reaction tube was sealed and shaken for 90 seconds at 23° C. to dissolve frozen droplets of the Grignard solution. The vial was cooled at −45° C. for 3 hours, warmed at 23° C. for 30 min., and cooled at −45° C. for 30 min. Butadiene (100 μL, 64.0 mg, 1.18 mmol, 1.00 equiv.) and triethoxysilane (218 μL, 194 mg, 1.18 mmol, 1.00 equiv.) were added. The reaction tube was resealed, removed from the glovebox, and heated to 50° C. in a pre-heated aluminum heating block for 25 min. The reaction vial was opened under ambient atmosphere, and TMS₂O (10 μL, 7.6 mg, 47 μmol, 4.0 mol %) and benzene-d₆ (100 μL) were added. The contents of the reaction vial were mixed thoroughly and transferred to an NMR tube. Ratio of 1,2-:1,4-addition determined to be 9:1 by ¹H NMR integration of signals corresponding to alkenyl protons (5.96-5.86 ppm for 3-butenyltriethoxysilane signal corresponds to 1H; 5.49-5.37 for 2-butenyltriethoxysilanes, overlapping signals correspond to 2H). Yield determined as 57% by addition of ¹H NMR signal integrations for butenylsilane products (full integration for 3-butenyltriethoxysilane+½ integration for 2-butenyltriethoxysilanes) in comparison to the TMS₂O signal at 0 ppm (integral set to 71.5 to show integrals as molar percents).

Phenylmagnesium Chloride.

In a dry, N₂-filled glovebox, platinum precatalyst 1 (2.6 mg, 3.0 μmol, 0.25 mol %) and dichloromethane (0.5 mL) were added to a 4 mL scintillation vial to form a clear, colorless solution. After chilling at −45° C. in a CO₂/ⁱPrOH-cooled cold well for 30 min., phenylmagnesium chloride in THF (2.0 M, 5.9 μL, 12 μmol, 1.0 mol %) was added and the reaction tube was sealed and shaken for 90 seconds at 23° C. to dissolve frozen droplets of the Grignard solution. The vial was cooled at −45° C. for 3 hours, warmed at 23° C. for 30 min., and cooled at −45° C. for 30 min. Butadiene (100 μL, 64.0 mg, 1.18 mmol, 1.00 equiv.) and triethoxysilane (218 μL, 194 mg, 1.18 mmol, 1.00 equiv.) were added. The reaction tube was resealed, removed from the glovebox, and heated to 50° C. in a pre-heated aluminum heating block for 25 min. The reaction vial was opened under ambient atmosphere, and TMS₂O (10 μL, 7.6 mg, 47 μmol, 4.0 mol %) and benzene-d₆ (100 μL) were added. The contents of the reaction vial were mixed thoroughly and transferred to an NMR tube. Ratio of 1,2-:1,4-addition determined to be 9.4:1 by ¹H NMR integration of signals corresponding to alkenyl protons (5.96-5.86 ppm for 3-butenyltriethoxysilane signal corresponds to 1H; 5.49-5.37 for 2-butenyltriethoxysilanes, overlapping signals correspond to 2H). Yield determined as 55% by addition of ¹H NMR signal integrations for butenylsilane products (full integration for 3-butenyltriethoxysilane+½ integration for 2-butenyltriethoxysilanes) in comparison to the TMS₂O signal at 0 ppm (integral set to 71.5 to show integrals as molar percents).

### Comparison of Solvents

Activation of precatalyst 1 by Grignard reagents requires optimization for efficient activation in solvents other than dichloromethane. To probe the response of hydrosilylation yield and selectivity to different solvents, precatalyst 6 was used, which has already been partially activated.

General Procedure.

In a dry, N₂-filled glovebox, platinum precatalyst 6 (3.9 mg, 5.9 μmol, 0.5 mol %), MgCl₂(THF)₂ (5.6 mg, 24 μmol, 2.0 mol %), solvent (0.5 mL), and tetrahydrofuran (10 μL) were added to a 4 mL scintillation vial at 23° C. The vial was chilled at −45° C. in a CO₂/ⁱPrOH-cooled cold well for 30 min. Butadiene (100 μL, 64.0 mg, 1.18 mmol, 1.00 equiv.) and triethoxysilane (218 μL, 194 mg, 1.18 mmol, 1.00 equiv.) were added and the reaction vial was sealed with a TEFLON-lined cap, removed from the glovebox, and heated at 50° C. in a pre-heated aluminum heating block for 25 min. The reaction vial was opened under ambient atmosphere, and TMS₂O (10 μL, 47 μmol, 4.0 mol %) and benzene-d₆ (100 μL) were added. The contents of the reaction vial were mixed thoroughly and transferred to an NMR tube. Ratio of 1,2-:1,4-addition determined by ¹H NMR integration of signals corresponding to alkenyl protons (5.96-5.86 ppm for 3-butenyltriethoxysilane signal corresponds to 1H; 5.49-5.37 for 2-butenyltriethoxysilanes, overlapping signals correspond to 2H). Yield determined by addition of 1H NMR signal integrations for butenylsilane products (full integration for 3-butenyltriethoxysilane+½ integration for 2-butenyltriethoxysilanes) in comparison to the TMS₂O signal at 0 ppm (integral set to 71.5 to show integrals as molar percents). Exemplary results are shown in Table 3.

TABLE 3
Solvent optimization.

| Solvent | Yield | Ratio of 1,2-:1,4-addition |
|---|---|---|
| Dichloromethane | 86% | 10:1 |
| Tetrahydrofuran | 9% | 2:1 |
| Diethyl ether | 31% | 6:1 |
| Acetonitrile | 6% | 6:1 |
| Benzonitrile | 28% | 8:1 |
| Benzene | 43% | 7:1 |
| Toluene | 37% | 5:1 |
| Pentane | 9% | 3:1 |

### Comparison of Silanes

General Procedure.

In a dry, N₂-filled glovebox, platinum precatalyst 1 (2.6 mg, 3.0 μmol, 0.25 mol %) and dichloromethane (0.5 mL) were added to a 4 mL scintillation vial to form a clear, colorless solution. After chilling at −45° C. in a CO₂/ⁱPrOH-cooled cold well for 30 min., methylmagnesium chloride in THF (3.2 M, 3.6 μL, 12 μmol, 1.0 mol %) was added and the reaction tube was sealed and shaken for 90 seconds at 23° C. The vial was cooled at −45° C. for 3 hours, warmed at 23° C. for 30 min., and cooled at −45° C. for 30 min. Butadiene (100 μL, 64.0 mg, 1.18 mmol, 1.00 equiv.) and silane (1.00 equiv.) were added. The reaction tube was resealed, removed from the glovebox, and heated to 50° C. in a pre-heated aluminum heating block for 25 min. The reaction vial was opened under ambient atmosphere, and TMS₂O (10 μL, 7.6 mg, 47 μmol, 4.0 mol %) and benzene-d₆ (100 μL) were added. The contents of the reaction vial were mixed thoroughly and transferred to an NMR tube. Ratio of 1,2-:1,4-addition determined by ¹H NMR integration of signals corresponding to alkenyl protons (5.96-5.86 ppm for 3-butenylsilane signal corresponds to 1H; 5.49-5.37 for 2-butenylsilanes, overlapping signals correspond to 2H). Yield was determined by addition of 1H NMR signal integrations for butenylsilane products (full integration for 3-butenylsilane+½ integration for 2-butenylsilanes) in comparison to the TMS₂O signal at 0 ppm (integral set to 71.5 to show integrals as molar percents). Exemplary results are shown in Table 4.

TABLE 4
Silane optimization.

| Silane | Yield | Ratio of 1,2-:1,4-addition |
|---|---|---|
| Triethoxysilane | 86% | 10:1 |
| Triethylsilane | 2% | 0.3:1 |
| Dimethylphenylsilane | 10% | 0.4:1 |
| Trichlorosilane | 19% | 0.5:1 |

### X-ray Crystallographic Analysis

General Procedure for X-ray Data Collection and Refinement.

A crystal was mounted on a nylon loop using Paratone-N oil, and transferred to a Bruker APEX II CCD diffractometer (Mo_{Kα} radiation, λ=0.71073 Å) equipped with an Oxford Cryosystems nitrogen flow apparatus. The sample was held at 100 K during the experiment. The collection method involved 0.5° scans in ω at 28° in 2θ. Data integration down to 0.82 Å resolution was carried out using SAINT V7.46 A (Bruker diffractometer, 2009) with reflection spot size optimisation. Absorption corrections were made with the program SADABS (Bruker diffractometer, 2009). The structure was solved by the direct methods procedure and refined by least-squares methods against F₂ using SHELXS-97 and SHELXL-97 (Sheldrick, 2008). Non-hydrogen atoms were refined anisotropically, and hydrogen atoms were allowed to ride on the respective atoms. Restraints on bond lengths and constraints of the atomic displacement parameters on each pair of disorder fragments (SADI and EADP instructions of SHELXL97), as well as the restraints of the atomic displacement parameters (SIMU/DELU instructions of SHELXL97) if necessary, have been applied for the disorder refinement. Special refinement details, if applicable, are given for each compound below. Crystal data and details of data collection and refinement are given in the tables below. Graphics were produced using the CystalMaker 8.6 software program (©1994-2012 CrystalMaker Software Ltd.). Computer programs: APEX2 v2009.3.0 (Bruker-AXS, 2009), SAINT 7.46A (Bruker-AXS, 2009), SHELXS97 (Sheldrick, 2008), SHELXL97 (Sheldrick, 2008), Bruker SHELXTL

Pt(II) Methyl Silane Complex 6 (CCDC 977504).

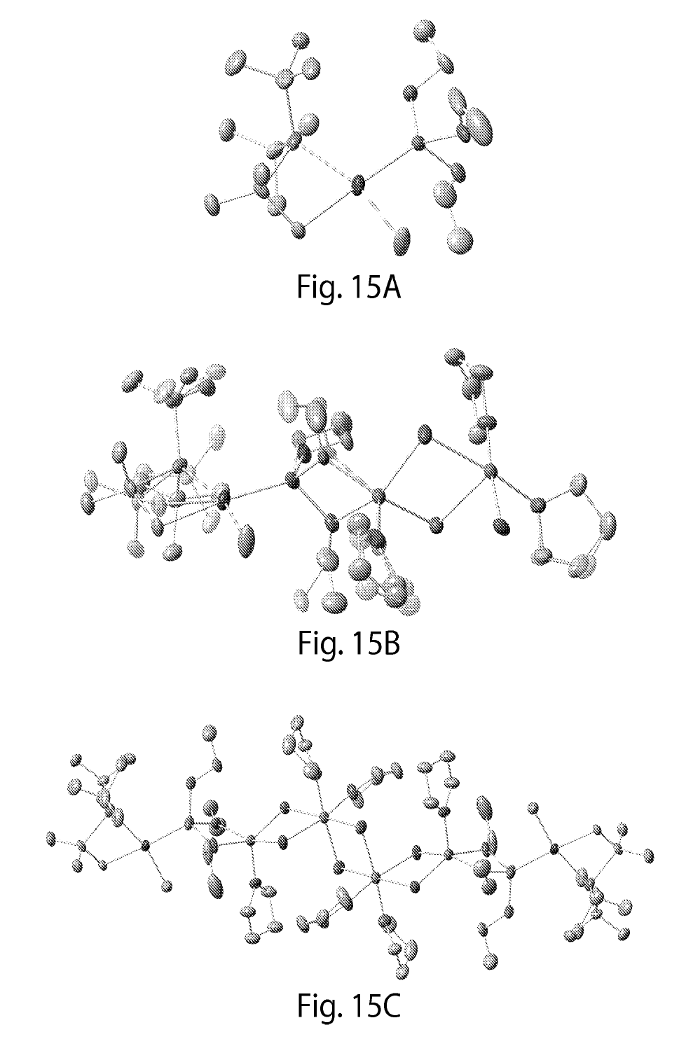

Single crystals suitable for X-ray diffraction analysis were grown in the following manner. A saturated solution of 9 in THF/hexanes was prepared by dissolving 9 (25.0 mg) in THF (0.25 mL) in a 4 mL scintillation vial, filtering the solution through a plug of glass wool, and adding hexanes (1.5 mL). Upon cooling to −35° C. for one week, colorless block-like crystals were obtained. Exemplary results are shown in FIGS. 15A-15C and Table 5.

TABLE 5
Crystal data and structure refinement for 6.
Crystal data

| Chemical formula | C₆₂H₁₃₃Cl₆Mg₄O₁₂P₂Pt₂Si₂ |
|---|---|
| Mᵣ | 1888.92 |
| Crystal system, space group | Triclinic, P⁻ 1 |
| Temperature (K) | 100 |
| a, b, c (Å) | 8.5320 (9), 15.9667 (16), 17.1115 (17) |
| α, β, γ (°) | 66.7430 (16), 86.5970 (18), 82.0320 (17) |
| V (Å³) | 2120.9 (4) |
| Z | 1 |
| Radiation type | Mo Kα |
| μ (mm⁻¹) | 3.63 |
| Crystal size (mm) | 0.40 × 0.40 × 0.30 |

Data collection

| | |
|---|---|
| Diffractometer | CCD area detector |
| | diffractometer |
| Absorption correction | Multi-scan |
| | SADABS (Sheldrick, 2009) |
| Tₘᵢₙ, Tₘₐₓ | 0.325, 0.409 |
| No. of measured, independent | 24682, 8665, 7594 |
| and | |
| observed [I > 2σ(I)] | |
| reflections | |
| Rᵢₙₜ | 0.031 |
| (sin θ/λ)ₘₐₓ (Å⁻¹) | 0.625 |

Refinement

| | |
|---|---|
| R[F² > 2σ(F²)], wR(F²), S | 0.029, 0.066, 1.03 |
| No. of reflections | 8665 |
| No. of parameters | 556 |
| No. of restraints | 278 |
| H-atom treatment | H-atom parameters constrained |
| Δρₘₐₓ, Δρₘᵢₙ (e Å⁻³) | 1.27, −0.75 |

Pt(II) Methyl Silane Complex S11 (CCDC 977503).

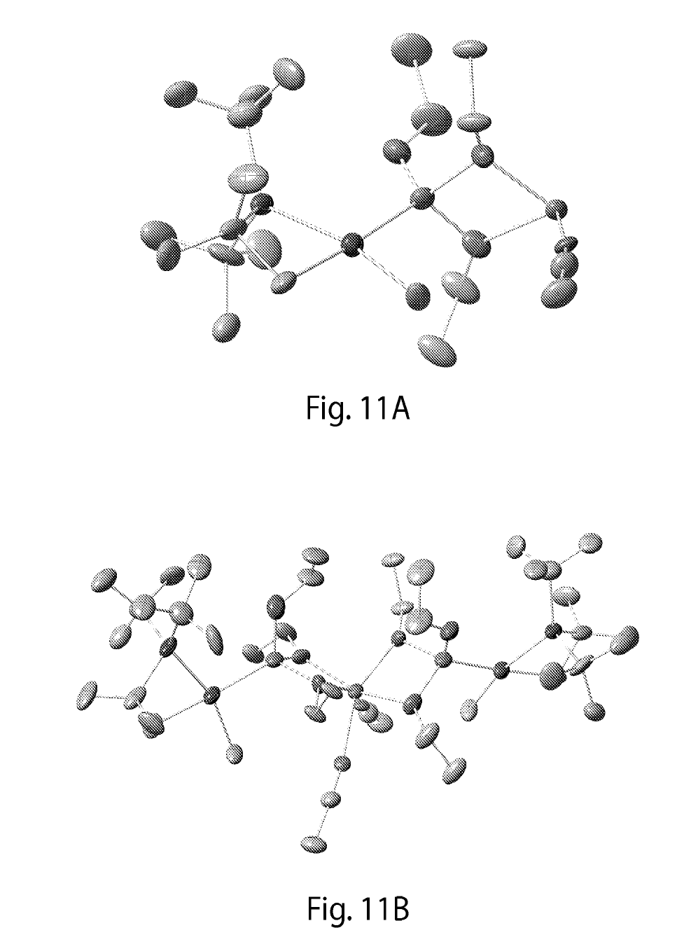

Single crystals of 6 were grown in the following manner. A saturated solution of 6 in MeCN at 23° C. was prepared by dissolving 6 (50.0 mg) in MeCN (1.0 mL) and filtering through a plug of glass wool to yield a clear yellow solution. This solution was cooled to −35° C. for 4 weeks, resulting in clear colorless crystals. Refinement special details are as follows: a solvent mask was implemented in the OLEX 2 software due to the presence of strong residual density peaks, for which a reasonable model was not refined; the strong residual peaks are due to inaccurate reflection intensities resulting from detector overflow in many frames; the low quality of the diffraction data also resulted in a higher than usual R value; and a higher quality data set was not obtained due to the difficulty of growing crystals of this complex, and the instability of the crystals. Due to these limitations on data quality, as well as the use of a solvent mask, the Pt:Mg ratio in crystals of S11 was not rigorously assigned, and the amount or identity of any solvents of crystallization was not confirmed. Exemplary results are shown in FIGS. 11A-11B and Table 6.

TABLE 6
Crystal data and structure refinement for S11.
Crystal data

| Chemical formula | C₂₁H₄₇Mg_{0.50}NO₃PPtSi |
|---|---|
| Mᵣ | 627.90 |
| Crystal system, space group | Tetragonal, P4/ncc |
| Temperature (K) | 100 |
| a, c (Å) | 31.918 (4), 12.5758 (18) |
| V (Å³) | 12812 (3) |
| Z | 16 |
| Radiation type | Mo Kα |
| μ (mm⁻¹) | 4.50 |
| Crystal size (mm) | 0.46 × 0.40 × 0.37 |

Data collection

| | |
|---|---|
| Diffractometer | CCD area detector |
| | diffractometer |
| Absorption correction | Multi-scan |
| | SADABS (Sheldrick, 2009) |
| Tₘᵢₙ, Tₘₐₓ | 0.232, 0.284 |
| No. of measured, independent | 5672, 5672, 5073 |
| and | |
| observed [I > 2σ(I)] | |
| reflections | |
| Rᵢₙₜ | 0.0000 |
| (sin θ/λ)ₘₐₓ (Å⁻¹) | 0.596 |

Refinement

| | |
|---|---|
| R[F² > 2σ(F²)], wR(F²), S | 0.110, 0.238, 1.16 |
| No. of reflections | 5672 |
| No. of parameters | 247 |
| No. of restraints | 29 |
| H-atom treatment | H-atom parameters constrained |
| | w = 1/[σ²(Fₒ²) + (0.P)² + 1029.1375P] |
| | where P = (Fₒ² + 2F_{c}²)/3 |
| Δρₘₐₓ, Δρₘᵢₙ (e Å⁻³) | 3.14, −4.38 |

X-ray diffraction data from single crystals of 6 show an interaction between magnesium and the oxygen atoms of the triethoxysilyl substituent of 6 (see, e.g., FIGS. 15A-15C and Table 5). Lewis acids are known to promote both oxidative addition¹⁴ and reductive elimination¹⁵ at transition metal complexes. It is proposed that the magnesium counterion in 6 could assist in both catalyst activation and hydrosilylation by facilitating oxidative addition of triethoxysilane to Pt(II) anions (5→A, A→B), or by promoting reductive elimination from electron-rich Pt(IV) intermediates (5→A, D→A). In the absence of added magnesium salts, catalyst degradation may out-compete activation, resulting in lower hydrosilylation yields.

A key step in the proposed mechanism shown in FIG. 12 is dissociation of the phosphine ligand prior to diene ligation (B→C). To support the existence of such a dissociation event, a platinate was synthesized, analogous to 5 and containing a 5-membered platinacycle (7). Platinate 7 was tested it in hydrosilylation of butadiene (Table 1A). Hydrosilylation using platinate 7 as a precatalyst was significantly slower than using precatalyst 5. Because there is less angle strain in a 5-membered platinacycle (7) than a 4-membered platinacycle (5), the rate of phosphine dissociation from Pt should be slower for 7 than for 5. If phosphine dissociation represents a step in the catalytic cycle prior to the turn-over limiting step, the rate of catalysis by the 5-membered platinacycle would be slower compared to the 4-membered platinacycle precatalyst, as observed in this system.

Platinum-catalyzed olefin hydrosilylation often proceeds by Pt(0/II) catalytic cycles, such as the well-established Chalk-Harrod mechanism.¹¹ A Pt(0/II) cycle for the transformation described herein would include an intermediate such as 8 (Table 1A). To probe this mechanistic possibility, anionic Pt(II) complex 8 was synthesized and tested. Because significant decomposition is observed from precatalysts 1, 5, and 6, if complex 8 were an intermediate on the catalytic cycle, then adding an amount of 8 equivalent to precatalysts 1, 5, and 6 would result in a much higher proportion of active catalyst and, therefore, a faster reaction rate. Complex 8 did not show improvement in rate or selectivity over the other tested precatalysts and decomposed to free tri-tert-butylphosphine during hydrosilylation (Table 1A). Additional experiments show that platinum complex 8 did not undergo reductive elimination in dichloromethane at 50° C. in the presence of butadiene. These data demonstrate that the mechanism of butadiene hydrosilylation from 1 does not proceed via a Chalk-Harrod-like Pt(0/II) cycle involving 8.

To investigate whether precatalyst degradation produces neutral Pt(0) complexes that act as the active species in hydrosilylation, an olefin-supported Pt(0) complex, Karstedt's catalyst^{1b,16} was tested, which is a commonly-used olefin hydrosilylation catalyst. Karstedt's catalyst was not selective for 1,2-addition (Table 1A), alone or in the presence of tri-tert-butylphosphine. If formation of Pt(0) were the critical event in catalyst activation, it would be expected to see selectivity for 1,2-addition from a Pt(0) phosphine catalyst generated by an alternate synthetic route.

Other mechanism possibilities exist, including variations on both Pt(0/II) and Pt(II/IV) cycles. However, mechanisms other than the one shown in FIG. 12 fail to explain the unprecedented selectivity for 1,2-hydrosilylation that we observe using precatalysts 1, 5, and 6. Specifically, none is expected to prevent the formation of π-allyl intermediates. It is proposed that the platinacycle, which contributes both a non-dissociable ligand and a negative charge to the complex, is a key component that induces coordinative saturation and prevents π-allyl formation. In addition, the high electron density of platinates 1, 5, and 6 allows access to the +IV oxidation state, which is not typical for platinum catalysts under the reducing conditions generated by large quantities of hydrosilane that are necessary for hydrosilylation.^{10,11}

In conclusion, the first 1,2-selective hydrosilylation reaction of conjugated 1,3-dienes, including butadiene, is described herein. It is proposed that the reaction proceeds through a Pt(II/IV) cycle and selectivity arises at a hexacoordinate Pt(IV) intermediate with a hemi-labile phosphine ligand that favors η²-diene coordination and prevents the formation of π-allyl intermediates. 1,2-Selective hydrosilylation of conjugated dienes enables the synthesis of butenylsilanes that hold promise as coupling reagents to fuse silicates with olefin polymer materials.

### REFERENCES

(1) (a) Speier, J. L.; Webster, J. A.; Barnes, C. H. J. Am. Chem. Soc. 1957, 79 , 974-979. (b) Karstedt, B. D. Ger. Offen. DE 2307085 A1, 1973. For reviews of recent progress in transition metal-catalyzed hydrosilylation, see: (c) Brook, M. A., Silicon in Organic, Organometallic, and Polymer Chemistry; Wiley-VCH Verlag: New York, 2000; Chapter 12. (d) Marciniec, B. Silicon Chem. 2002, 1, 155-175. (e) Roy, A. K. Adv. Organomet. Chem. 2008, 55, 1-59. (f) Marciniec, B.; Maciejewsky, H.; Pietraszuk, C.; Pawluć, P. in Hydrosilylation: A Comprehensive Review on Recent Advances; Marciniec, B., Ed.; Springer: Berlin, 2010; Chapter 1. (g) Troegel, D.; Stohrer, J. Coord. Chem. Rev. 2011, 255, 1440-1459.
(2) For a review of 1,3-diene hydrosilylation see: Ojima, I.; Kogure, T. Rev. Silicon, Germanium, Tin Lead Compd. 1981, 5, 7-66.
(3) (a) Shiihara, I.; Hoskyns, V. F.; Post, H. W. J. Org. Chem. 1961, 26, 4000-4002. (b) Mamedaliev, Y. G.; Mamedov, M.; Sadykh-Zade, S. I.; Akhmedov, I. M.; Salimov, M. A. Azerb. Khim. Zh., 1962, 9-13. (c) Takahashi, S.; Shibano, T.; Hagihara, N. Chem. Commun. 1969, 161. (d) Hara, M.; Ohno, K.; Tsuji, J. Chem. Commun. 1971, 247. (e) Takahashi, S.; Shibano, T.; Kojima, H.; Hagihara, N. Organomet. Chem. Synth. 1970/71, 1, 193-202. (f) Belyakova, Z. V.; Pomerantseva, M. G.; Popkov, K. K.; Efremova, L. A.; Golubtsov, S. A. Zh. Obshch. Khim. 1972, 42, 889-894. (g) Swisher, J. V.; Zullig, C. J. Org. Chem. 1973, 38, 3353-3357. (h) Tsuji, J.; Hara, M.; Ohno, K. Tetrahedron, 1974, 30, 2143-2146. (i) Wrighton, M. S.; Shroeder, M. A. J. Am. Chem. Soc. 1974, 96, 6235-6237. (j) Cornish, A. J.; Lappert, M. F.; Nile, T. A. J. Organomet. Chem. 1977, 132, 133-145. (k) Benkeser, R. A.; Merritt II, F. M.; Roche, R. T. J. Organomet. Chem., 1978, 156, 235-244. (l) Hayashi, T.; Kabeta, K. Tetrahedron Lett. 1985, 26, 3023-3026. (m) Wu, J. Y.; Stanzl, B. N.; Ritter, T. J. Am. Chem. Soc. 2010, 132, 13214-13216.
(4) (a) Arkles, B. Chemtech 1977, 7, 766-778. (b) Plueddemann, E. P., Silane Coupling Agents; Plenum Press: New York, 1991. (c) Brook, M. A., Silicon in Organic Organometallic, and Polymer Chemistry; Wiley-VCH Verlag: New York, 2000; Chapter 10. (d) Ab, R. I.; Padavettan, V. J. Nanomater 2012, 132424. (e) Cui, S.; Lin, B.; Liu, Y.; Liu, X.; Shen, X.; Han, G.; Zhou, X. Curr Nanosci. 2012, 8, 797-800.
(5) For alternate syntheses of triethoxysilyl-3-butene see: (a) Yamamoto, K.; Nakajima, M.; Shiozawa, M.; Okumura, Y.; Koyama, T. Jpn. Kokai Tokkyo Koho JP 01172391 A 19890707, 1989. (b) Brondani, D. J.; Corriu, R. J. P.; Ayoubi, S. E.; Moreau, J. J. E.; Man, M. W. C. Tetrahedron Lett. 1993, 34, 2111-2114. (c) Deschler, U.; Kleinschmit, P.; Wolff, S.; Tan, E. H. Eur. Pat. Appl. EP 350600 A2 19900117, 1990.
(6) For syntheses of hexenylsilanes, see: (a) Takeaki, S. Phosphorus, Sulfur Silicon Relat. Elem. 2008, 183, 1556-1563. (b) Tanaka, H. Jpn. Kokai Tokkyo Koho JP 2008174523 A 20080731, 2008.
(7) For 1,2-selective hydroboration, see: (a) Zaidlewicz, M.; Meller, J. Tetrahedron Lett. 1997, 38, 7279-7282. For 1,2-selective diboration, see: (b) Ishiyama, T.; Yamamoto, M.; Miyaura, N. Chem. Commun. 1997, 689-690. (c) Kliman, L. T.; Mlynarski, S. N.; Ferris, G. E.; Morken J. P. Angew. Chem., Int. Ed. 2012, 51, 521-524.
(8) (a) Andrianov, K. A.; Bagratishvili, G. D.; Kantariya, M. L.; Sidorov, V. I.; Khananashvili, L. M, Tsitsishvili, G. V. J. Organomet. Chem. 1965, 4, 440-445. (b) Nasiak, L. D.; Post, H. W. J. Organomet. Chem. 1970, 23, 91-98. (c) Fink, W. Helv. Chim. Acta 1971, 54, 1304-1310. (d) Swisher, J. V.; Zullig, C. Jr. J. Org. Chem. 1978, 38, 3353-3357.
(9) Clark, H. C.; Goel, A. B.; Goel, R. G.; Goel, S. Inorg. Chem. 1980, 19, 3220-3225.
(10) For a mechanism study of Pt(II/IV)-catalyzed hydrosilylation see: Roy, A. K.; Taylor, R. B. J. Am. Chem. Soc. 2002, 124, 9510.
(11) (a) Chalk, A. J.; Harrod, J. F. J. Am. Chem. Soc. 1965, 87, 16-21. (b) Sakaki, S.; Mizoe, N.; Sugimoto, M. Organometallics 1998, 17, 2510-2523. (c) Stein, J.; Lewis, L. N.; Gao, Y.; Scott, R. A. J. Am. Chem. Soc. 1999, 121, 3693-3703. (d) Faglioni, F.; Blanco, M.; Goddard, W. A.; Saunders, D. J. Phys. Chem. B 2002, 106, 1714-1721.
(12) Whitesides, G. M.; Hackett, M.; Brainard, R. L.; Lavalleye, J. P. P. M.; Sowinski, A. F.; Izumi, A. N.; Moore, S. S.; Brown, D. W.; Staudt, E. M. Organometallics 1985, 4, 1819-1830.
(13) Schlenk, W.; Schlenk, W., Jr. Ber. Dtsch. Chem. Ges. B 1929, 62B, 920-924.
(14) (a) Ghosh, I.; Jacobi, P. A. J. Org. Chem. 2002, 67, 9304-9309. (b) Shi, Y.; Peterson, S. M.; Haberaecker, W. W., III; Blum, S. A. J. Am. Chem. Soc. 2008, 130, 2168-2169. (c) Nakao, Y.; Idei, H.; Kanyiva, K. S.; Hiyama, T. J. Am. Chem. Soc. 2009, 131, 15996-15997. (d) Nakao, Y.; Idei, H.; Kanyiva, K. S.; Hiyama, T. J. Am. Chem. Soc. 2009, 131, 5070-5071. (e) Ohashi, M.; Shibata, M.; Saijo, H.; Kambara, T.; Ogoshi, S. Organometallics 2013, 32, 3631-3639.
(15) (a) Stahl, S. S.; Labinger, J. A.; Bercaw, J. E. J. Am. Chem. Soc. 1995, 117, 9371-9372. (b) Huang, J.; Haar, C. M.; Nolan, S. P.; Marcone, J. E.; Moloy, K. G. Organometallics 1999, 18, 297-299. (c) Williams, B. S.; Holland, A. W.; Goldberg, K. I. J. Am. Chem. Soc. 1999, 121, 252-253. (d) Nakamura, E.; Yamanaka, M.; Mori, S. J. Am. Chem. Soc. 2000, 122, 1826-1827. (e) Williams, B. S.; Goldberg, K. I. J. Am. Chem. Soc. 2001, 123, 2576-2587. (f) Yamamoto, T.; Abla, M.; Murakami, Y. Bull. Chem. Soc. Jpn. 2002, 75, 1997-2009. (g) Shen, Q. L.; Hartwig, J. F. J. Am. Chem. Soc. 2007, 129, 7734-7735. (h) Liberman-Martin, A. L.; Bergman, R. G.; Tilley, T. D. J. Am. Chem. Soc. 2013, 135, 9612-9615.
(16) Hitchcock, P. B.; Lappert, M. F.; Warhurst, N. J. W. Angew. Chem., Int. Ed. Engl. 1991, 30, 438-440.

### EQUIVALENTS AND SCOPE

In the claims articles such as “a,” “an,” and “the” may mean one or more than one unless indicated to the contrary or otherwise evident from the context. Claims or descriptions that include “or” between one or more members of a group are considered satisfied if one, more than one, or all of the group members are present in, employed in, or otherwise relevant to a given product or process unless indicated to the contrary or otherwise evident from the context. The invention includes embodiments in which exactly one member of the group is present in, employed in, or otherwise relevant to a given product or process. The invention includes embodiments in which more than one, or all of the group members are present in, employed in, or otherwise relevant to a given product or process.

Furthermore, the invention encompasses all variations, combinations, and permutations in which one or more limitations, elements, clauses, and descriptive terms from one or more of the listed claims is introduced into another claim. For example, any claim that is dependent on another claim can be modified to include one or more limitations found in any other claim that is dependent on the same base claim. Where elements are presented as lists, e.g., in Markush group format, each subgroup of the elements is also disclosed, and any element(s) can be removed from the group. It should it be understood that, in general, where the invention, or aspects of the invention, is/are referred to as comprising particular elements and/or features, certain embodiments of the invention or aspects of the invention consist, or consist essentially of, such elements and/or features. For purposes of simplicity, those embodiments have not been specifically set forth in haec verba herein. It is also noted that the terms “comprising” and “containing” are intended to be open and permits the inclusion of additional elements or steps. Where ranges are given, endpoints are included. Furthermore, unless otherwise indicated or otherwise evident from the context and understanding of one of ordinary skill in the art, values that are expressed as ranges can assume any specific value or sub-range within the stated ranges in different embodiments of the invention, to the tenth of the unit of the lower limit of the range, unless the context clearly dictates otherwise.

This application refers to various issued patents, published patent applications, journal articles, and other publications, all of which are incorporated herein by reference. If there is a conflict between any of the incorporated references and the instant specification, the specification shall control. In addition, any particular embodiment of the present invention that falls within the prior art may be explicitly excluded from any one or more of the claims. Because such embodiments are deemed to be known to one of ordinary skill in the art, they may be excluded even if the exclusion is not set forth explicitly herein. Any particular embodiment of the invention can be excluded from any claim, for any reason, whether or not related to the existence of prior art.

Those skilled in the art will recognize or be able to ascertain using no more than routine experimentation many equivalents to the specific embodiments described herein. The scope of the present embodiments described herein is not intended to be limited to the above Description, but rather is as set forth in the appended claims. Those of ordinary skill in the art will appreciate that various changes and modifications to this description may be made without departing from the spirit or scope of the present invention, as defined in the following claims.

1. A platinum complex of Formula (I): 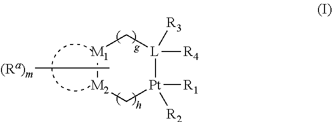
or salts thereof,
wherein: [symbol]
is absent, or a fused ring selected from the group consisting of optionally substituted aryl, optionally substituted heteroaryl, and optionally substituted heterocyclyl;
each of M₁ and M₂ is independently C or N;
L is P, N or As;
each instance of R^{a} is independently selected from the group consisting of hydrogen, halogen, optionally substituted acyl, —CN, —NO₂, —OR^{O1}, —N(R^{N1})₂, and optionally substituted alkyl;
each instance of R₁ and R₂ is independently hydrogen, optionally substituted C₁₋₆ alkyl, —Si(R^{b})₃, or halogen;
each instance of R₃ and R₄ is independently hydrogen, optionally substituted C₁₋₆ alkyl, or halogen,
each instance of R^{b} is optionally substituted C₁₋₆ alkyl or —OR^{O1};
each instance of R^{O1} is independently selected from the group consisting of hydrogen, optionally substituted acyl, optionally substituted alkyl, and an oxygen protecting group;
each instance of R^{N1} is independently selected from the group consisting of hydrogen, optionally substituted acyl, optionally substituted alkyl, and a nitrogen protecting group;
each instance of h and g is independently 0, 1, 2, or 3; and
m is independently 0, 1, 2, 3, 4, 5, 6, 7, 8, 9, 10.

2. The platinum complex of claim 1, wherein the complex is of Formula (I-a): 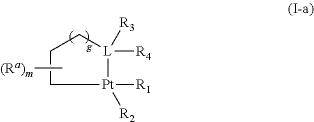
or salts thereof.

3. The platinum complex of claim 2, wherein the complex is selected from the group consisting of: 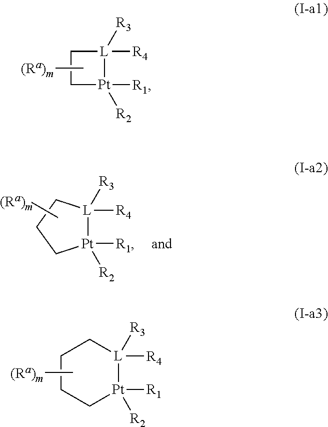
and salts thereof.

4. The platinum complex of claim 1, wherein the complex is of Formula (I-b): 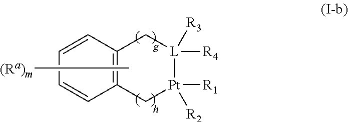
or salts thereof.

5. The platinum complex of claim 4, wherein the complex is selected from the group consisting of 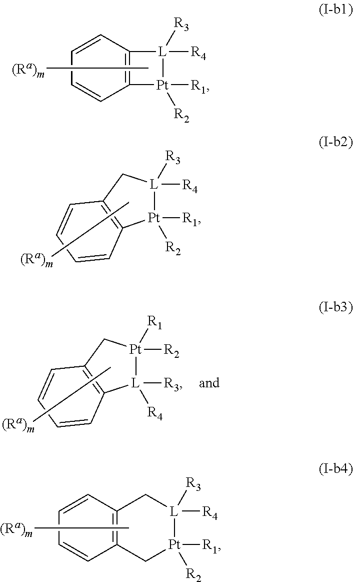
or salts thereof.

6. The platinum complex of claim 1, wherein the complex is of Formula (I-c): 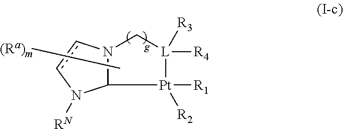
or salts thereof, wherein: [symbol]
represents a single bond or a double bond; and
R^{N} is independently selected from the group consisting of hydrogen, optionally substituted acyl, optionally substituted alkyl, and a nitrogen protecting group.

7. The platinum complex of claim 6, wherein the complex is of Formula (I-c1) or (I-c2): 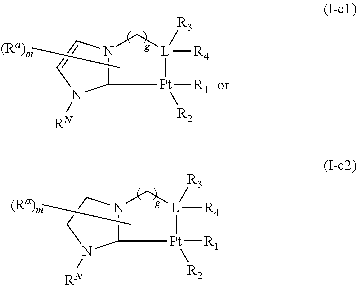
or salts thereof.

8. (canceled)

9. The platinum complex of claim 3, wherein the complex is of Formula (II): 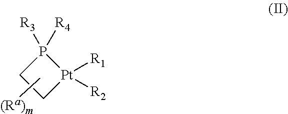
or salts thereof.

10. The platinum complex of claim 9, wherein the complex is of Formula (II-a), (II-b), (II-b1), or (II-b3): 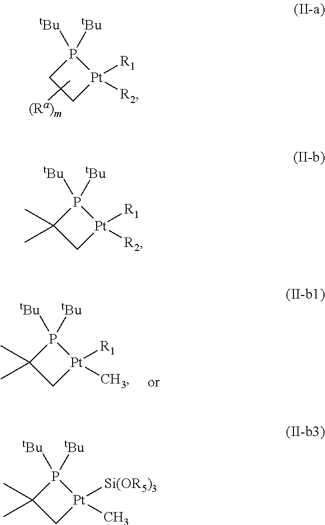
or salts thereof.

11-12. (canceled)

13. The platinum complex of claim 10, wherein the complex is of Formula (II-b2) or (II-b3-i): 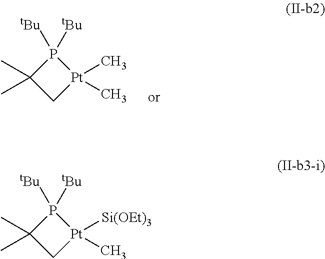
or salts thereof.

14-15. (canceled)

16. The platinum complex of claim 1, wherein the complex is of Formula (III): 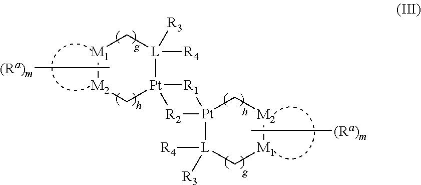
or salts thereof.

17. The platinum complex of claim 16, wherein the complex is of Formula (III-a), (III-a1), (III-a2), or (III-a2-i): 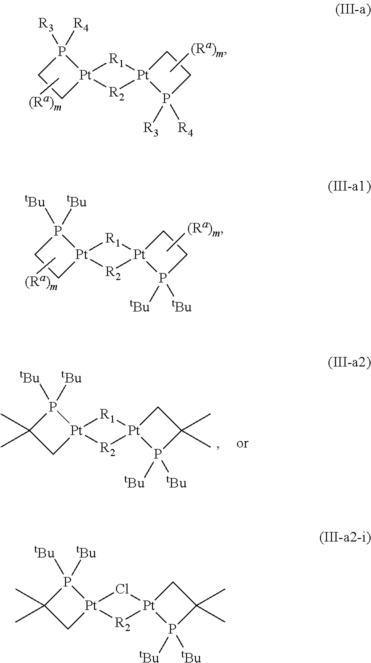
or salts thereof.

18-20. (canceled)

21. The platinum complex of claim 16, wherein the complex is of Formula (III-a2-ii) or (III-a2-iii): 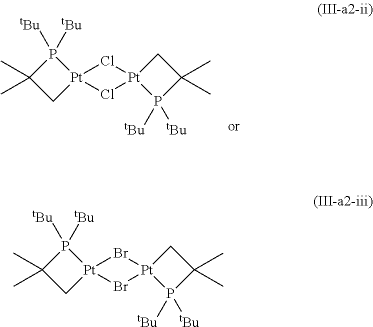
or salts thereof.

22. (canceled)

23. The platinum complex of claim 3, wherein the complex is of Formula (IV): 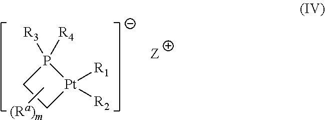
wherein Z^{⊕} is a counterion.

24. The platinum complex of claim 1, wherein the complex is of Formula (IV-a), (IV-b), (IV-b1), or (IV-b2):

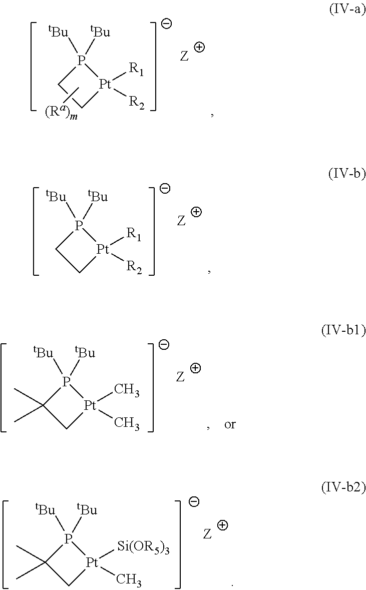

25-27. (canceled)

28. The platinum complex of claim 23, wherein Z^{⊕} is selected from the group consisting of MgCl^{⊕}, MgBr^{⊕}, Li^{⊕}, K^{⊕}, ZnCl^{⊕}, and ZnBr^{⊕}.

29. A hydrosilylation catalyst composition comprising a platinum complex of claim 1 and an organic solvent.

30. The hydrosilylation catalyst composition of claim 29, wherein the platinum complex is present in the amount of about 0.01 mol % to about 5 mol %.

31. (canceled)

36. A method of hydrosilylation of a 1,3-diene comprising the steps of:
(A) providing a platinum complex of claim 1;
(B) contacting the platinum complex with a 1,3-diene under suitable conditions to hydrosilylate the 1,3-diene.

37-48. (canceled)
